(19) United States
(12) Patent Application Publication
(10) Pub. No.: US 2022/0289311 A1
(43) Pub. Date: Sep. 15, 2022

(54) Rack releasably coupled to a cab of a vehicle

(71) Applicant: Isabrem Ltd., Oakville (CA)

(72) Inventor: Brian Layfield, Oakville (CA)

(21) Appl. No.: 17/691,525

(22) Filed: Mar. 10, 2022

Related U.S. Application Data
(60) Provisional application No. 63/159,286, filed on Mar. 10, 2021.

(51) Int. Cl. B62D 33/02

(52) U.S. Cl. CPC B62D 33/0207

(57) ABSTRACT

A rack of unitary one-piece construction is disclosed. The rack is configured for releasably coupling to a cab of a vehicle. The rack comprises a barrier defined by a plurality of barrier members. The rack is configured to co operate with the cab, such that, while the rack is releasably coupled to the cab, the barrier is disposed in opposition to the rear window of the cab, line of sight is provided from the cab, through the barrier, and the barrier prevents oversized objects from contacting the rear window.

### CROSS-REFERENCE TO RELATED APPLICATIONS

The present application is based on and claims the benefit of U.S. provisional patent application Ser. No. 63/159,286, filed Mar. 10, 2021, the content of which is hereby incorporated by reference in its entirety.

### FIELD

The present disclosure relates to cab racks, in particular, to a rack for protecting the rear window of a cab of a vehicle that is supported by said cab.

### BACKGROUND

Pickup trucks typically have a truck cab, which has the controls for operating the truck, and a rear window for the truck operator to have a rearward line of sight during operation of the truck, and a truck bed that is positioned behind the truck cab. Compared to the trunks of cars, truck beds are generally larger. Accordingly, pickup trucks may be used to transport load as the truck bed may hold loads that are heavy, long, wide, or may comprise a number of different types of articles of different weights and dimensions.

During transportation of the load, the load may move due to the acceleration or deceleration of the truck. Accordingly, the load may contact the rear window of the cab, and may damage the rear window. In addition, some loads, such as ladders or lumber, may be longer than the length of the truck bed, such that, in order to hold such a load, a portion of the load is inside the truck bed, while another portion of the load is resting on the roof of the truck cab. However, truck cabs are not configured to support a load. Accordingly, a load that is supported by the cab may damage the cab.

One way to protect the rear window is to mount a rack to the truck bed, with the rack disposed between the rear window and the load. Various such racks have been developed. Unfortunately, existing racks are heavy, as they are made of relatively heavy materials such as metal (e.g. steel or aluminum). As such, it may be difficult for one person to install or uninstall such heavy racks, and the weight of the racks may present issues during shipping and handling. Metal racks may be susceptible to rust and wear and tear from exposure to environmental conditions, which may damage the existing racks, the fasteners used with the existing racks, or the vehicles on which the existing racks are mounted. Existing racks may also comprise a number of parts that may initially be disassembled, which may increase the complexity of installing the racks. In addition, while the rack is mounted to the truck bed, or while a load is applied to the mounted rack, the rack may experience stresses that may result in mechanical failure of the rack. Moreover, in order to couple the rack to the truck bed, one or more holes may need to be cut or drilled into the truck bed, which may be cumbersome, especially if a particularly shaped or sized hole is required to be cut into the truck bed. By cutting one or more holes into the truck bed, there is a risk that the factory warranty may be voided. Further, the weight of the existing racks may reduce the fuel efficiency of the truck. Additionally, even with a rack mounted to the truck bed, the loads may still be supported on the roof of the cab, thereby risking damage to the cab.

### SUMMARY

In one aspect, there is provided a rack of unitary one-piece construction that is configured for releasably coupling to a cab of a vehicle, the cab having a rear window, the rack comprising: a barrier defined by a plurality of barrier members; wherein the rack is configured to co operate with the cab, such that, while the rack is releasably coupled to the cab: the barrier is disposed in opposition to the rear window; line of sight is provided from the cab, through the barrier; and the barrier prevents oversized objects from contacting the rear window.

In another aspect, there is provided a rack of unitary one-piece construction that is configured to be supportable by a cab of a vehicle, the cab having a rear window, the rack comprising: a barrier defined by a plurality of barrier members; wherein the rack is configured to co operate with the cab, such that, while the rack is releasably coupled to the cab: the barrier is disposed in opposition to the rear window; line of sight is provided from the cab, through the barrier; and the barrier prevents oversized objects from contacting the rear window.

In another aspect, there is provided a rack of unitary one-piece construction that is configured for releasably coupling to a cab of a vehicle, the cab having a rear window, the rack comprising: a barrier defined by a plurality of barrier members; wherein the rack is configured to co operative with the cab, such that, while the rack is releasably coupled to the cab: the barrier is disposed in opposition to the rear window; line of sight is provided from the cab, through the barrier; and the barrier prevents oversized objects from contacting the rear window. a connecting system that comprises: a cab roof connecting system for releasably coupling to a roof of the cab; a cab side connecting system for releasably coupling to a side of the cab; wherein the barrier and the connecting system are co operatively configured such that: while the cab roof connecting system is releasably coupled to the cab, the barrier is releasably coupled to the roof of the cab; while the cab side connecting system is releasably coupled to the cab, the barrier is releasably coupled to the side of the cab; and the barrier is disposed in opposition to the rear window.

In another aspect, there is provided a kit for assembling a rack system that is configured for releasably coupling to a cab of a vehicle, the cab having a rear window, the kit comprising: a rack of unitary one-piece construction that is configured for releasably coupling to the cab, the rack comprising: a barrier defined by a plurality of barrier members; wherein the rack is configured to co operate with the cab, such that, while the rack is releasably coupled to the cab: the barrier is disposed in opposition to the rear window; line of sight is provided from the cab, through the barrier; and the barrier prevents oversized objects from contacting the rear window; a connecting system for effecting the releasably coupling of the rack to the cab; wherein the rack and the connecting system are co operatively configured such that, while: (i) the connecting system is releasably coupled to the cab, and (ii) the rack is releasably coupled to the connecting system, the barrier is releasably coupled to the cab and disposed in opposition to the rear window.

In another aspect, there is provided a cab roof connector that is configured for releasably coupling to a roof of a cab of a vehicle and for releasably coupling to a load, and is co operable with the vehicle and the load, such that while the cab roof connector is releasably coupled to the roof of the cab and is releasably coupled to the load, the load hangs below, and rearward of, the roof of the cab.

In another aspect, there is provided a cab roof connecting system that is configured for releasably coupling to a roof of a cab and for releasably coupling to a load, the cab roof connecting system comprising: a slot, wherein releasable coupling of the load and the cab roof connecting system is effected by insertion of a prong of the load into the slot; and a retainer; wherein the load, the cab roof connecting system, and the retainer are co operatively configured such that the releasably coupling of the load and the cab roof connecting system is releasably retainable by the retainer.

In another aspect, there is provided a cab side connector that is configured for releasably coupling to a side of a cab of a vehicle and for releasably coupling to a load, and is co operable with the vehicle and the load, such that while the cab side connector is releasably coupled to the side of the cab and is releasably coupled to the load, the load is releasably coupled to the side of the cab.

In another aspect, there is provided a cab side connecting system that is configured for releasably coupling to a side of a cab and for releasably coupling to a load, the cab side connecting system comprising: a slot, wherein releasable coupling of the load and the cab side connecting system is effected by insertion of a prong of the load into the slot; and a retainer; wherein the load, the cab side connecting system, and the retainer are co operatively configured such that the releasable coupling of the load and the cab side connecting system is releasably retainable by the retainer.

In another aspect, there is provided a connecting system that is configured for releasably coupling to a cab of a vehicle and for releasably coupling to a load, the cab having a roof and a side, the connecting system comprising: a cab roof connector that is configured for releasably coupling to the roof of the cab and for releasably coupling to the load, and is co operable with the vehicle and the load, such that while the cab roof connector is releasably coupled to the roof of the cab and is releasably coupled to the load, the load hangs below, and rearward of, the roof of the cab; and a cab side connector, that is configured for releasably coupling to the side of the cab and for releasably coupling to the load, and is co operable with the vehicle and the load, such that while the cab side connector is releasably coupled to the side of the cab and is releasably coupled to the load, the load is releasably coupled to the side of the cab.

In another aspect, there is provided a connecting system that is configured for releasably coupling to a cab and for releasably coupling to a load, the cab having a roof and a side, the connecting system comprising: a cab roof connecting system that is configured for releasably coupling to the roof of the cab and for releasably coupling to the load, the cab roof connecting system comprising: a slot, wherein releasable coupling of the load and the cab roof connecting system is effected by insertion of a prong of the load into the slot; and a retainer; wherein the load, the cab roof connecting system, and the retainer are co operatively configured such that the releasably coupling of the load and the cab roof connecting system is releasably retainable by the retainer; and a cab side connecting system that is configured for releasably coupling to the side of the cab and for releasably coupling to the load, the cab side connecting system comprising: a slot, wherein releasable coupling of the load and the cab side connecting system is effected by insertion of a prong of the load into the slot; and a retainer; wherein the load, the cab side connecting system, and the retainer are co operatively configured such that the releasable coupling of the load and the cab side connecting system is releasably retainable by the retainer.

In another aspect, there is provided a method of producing a rack of unitary one-piece construction that is configured for releasable coupling to a cab of a vehicle, the cab having a rear window, the rack comprising a barrier defined by a plurality of barrier members, wherein the rack is configured to co operate with the cab, such that while the rack is releasably coupled to the cab, the barrier is disposed in opposition to the rear window, line of sight is provided from the cab, through the barrier, the barrier prevents oversized objects from contacting the rear window, wherein the method comprises: injection moulding the rack.

Other aspects will be apparent from the description and drawings provided herein.

### BRIEF DESCRIPTION OF DRAWINGS

In the figures, which illustrate example embodiments,

FIG. 1 is perspective view of a rack;

FIG. 2 is an exploded view of the rack of FIG. 1;

FIG. 3 is an exploded view of the rack of FIG. 1;

FIG. 4 is a perspective view of a connecting system for effecting the releasably coupling of the rack of claim 1 to a cab of a vehicle;

FIG. 5 is a perspective view of a cab roof connecting system of the connecting system of FIG. 4;

FIG. 6 is a perspective view of a cab side connecting system of the connecting system of FIG. 4;

FIG. 7 is a perspective view of a cab roof connecting structure, with a retainer in a first position;

FIG. 8 is a perspective view of the cab roof connecting structure of FIG. 7, with the retainer in a second position;

FIG. 9 is a perspective view of a cab side connecting structure, with a retainer in a first position;

FIG. 10 is a perspective view of the cab side connecting structure of FIG. 9, with the retainer in a second position;

FIG. 11 is a schematic of the rack of FIG. 1 supported by the cab of a vehicle, with a load fastened to the cab roof connector;

FIG. 12 is a schematic of the rack of FIG. 1 supported by the cab of a vehicle, with a light fixture received in the cab roof connector;

FIG. 13 is a schematic of the rack of FIG. 1 supported by the cab of a vehicle, with a load supported by the cab roof connector;

FIG. 14 is a schematic of the rack of FIG. 1 supported by the cab of a vehicle, with a load supported by the cab roof connector;

FIG. 15 is a flow chart depicting a method of releasably coupling a rack to a cab of a vehicle;

FIG. 16 is perspective view of an alternate embodiment of a rack;

FIG. 17 is an exploded view of the rack of FIG. 16;

FIG. 18 is a perspective view of a connecting system for effecting the releasably coupling the rack of claim 1 to a cab of a vehicle;

FIG. 19 is a perspective view of a cab roof connecting system of the connecting system of FIG. 17;

FIG. 20 is a perspective view of the cab roof connecting system of FIG. 19;

FIG. 21 is a schematic of the cab roof connecting system of FIG. 19, including an internal supporting structure therein;

FIG. 22 is a schematic of the rack of FIG. 16 supported by the cab of a vehicle, with a load supported by a cab roof connector;

FIG. 23 is a schematic of the cab roof connector supporting a load;

FIG. 24 is a schematic of the rack of FIG. 16 supported by the cab of a vehicle, with a load supported by the cab roof connector;

FIG. 25 is a schematic of the cab roof connector supporting a load;

FIG. 26 is a schematic of the rack of FIG. 16 supported by the cab of a vehicle, with a load supported by the cab roof connector;

FIG. 27 is a schematic of the rack of FIG. 16 supported by the cab of a vehicle, with a tool box supported by the vehicle;

FIG. 28 is a schematic of the rack of FIG. 16 supported by the cab of a vehicle, with a load fastened to the cab roof connector;

FIG. 29 is a schematic of a barrier of the rack of FIG. 1, including an internal supporting structure therein;

FIG. 30 is a schematic of the cab roof connecting system of the connecting system of FIG. 4, including an internal supporting structure therein;

FIG. 31 is a perspective view of the cab roof connecting system of the connecting system of FIG. 4, having an extended portion;

FIG. 32 is a perspective view of the cab roof connecting system of FIG. 31;

FIG. 33 is another perspective view of the cab roof connecting system of FIG. 31;

FIG. 34 is a side view of the cab roof connecting system of FIG. 31, mounted on a cab of a vehicle;

FIG. 35 is a schematic of the cab side connecting structure of FIG. 9, including an internal supporting structure therein;

FIG. 36 is another perspective view of the cab side connecting system of the connecting system of FIG. 4.

### DETAILED DESCRIPTION

A rack that is configured for releasably coupling to a cab of a vehicle is disclosed. In this regard, while the rack is releasably coupled to the cab, the rack is hung from the cab. The rack may be releasably coupled exclusively to the cab. That is, the rack may be releasably coupled to the cab without also being supported by or coupled to other parts of the vehicle, for example, a trunk, or where the vehicle is a truck, a truck bed. The rack is releasably coupled to the cab using a connecting system. The connecting system is configured to be releasably couplable to the roof and to the side of the cab. The rack and the connecting system may be made entirely of a high strength plastic, for example, injection moulded plastic, and may be manufactured by moulding, such as blow moulding or injection moulding. In some embodiments, for example, the rack and the connecting system are of unitary one-piece construction, such that, while the connecting system is releasably coupled to the cab, the rack is also releasably coupled to the cab. In other embodiments, for example, the rack and the connecting system are separate components. In such embodiments, the connecting system is first releasably coupled to the cab, and then the rack is releasably coupled to the connecting system to releasably couple the rack to the cab. The rack and the connecting system may allow for flexibility of ease of releasably coupling to the cab or releasing from the cab at leisure. In addition, while the rack and the connecting system are releasably coupled to the cab, the cab may support loads that are applied to the rack and the connecting system.

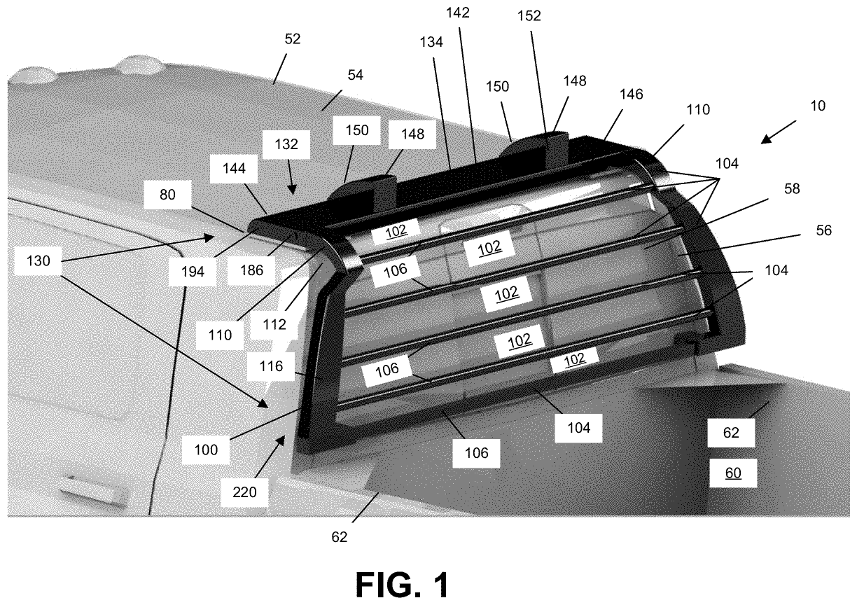

FIGS. 1-3 depict an example rack 10. The rack 10 may be of unitary one-piece construction that is configured for releasably coupling to a cab 52 of a vehicle 50, the cab having a rear window 58. In some embodiments, for example, the rack 10 comprises a barrier 100. The barrier 100 is defined by a plurality of barrier members 104. The rack 10 is configured such that, while the rack 10 is releasably coupled to the cab 52, the barrier 100 is disposed in opposition to the rear window 58, line of sight is provided from the cab 52 through the barrier 100, and the barrier 100 prevents oversized objects from contacting the rear window 58.

In some embodiments, for example, the barrier 100 includes at least one aperture 102, where each one of the apertures 102, independently, is defined between a respective plurality of merging barrier members 104. As depicted in FIG. 1 to FIG. 3, in some embodiments, for example, the barrier members 104 are straight, or curved. In some embodiments, for example, the barrier members 104 have a vertical, horizontal, or diagonal orientation. Accordingly, the barrier members 104 define apertures 102 having a four-sided or quadrilateral shape, such as a trapezoidal shape. In some embodiments, for example, the barrier members 104 are oriented such that the barrier members 104 merge to define apertures 102 having a rounded shape, a shape with two sides, or more than two sides.

In some embodiments, for example, the cross-sectional profile of the barrier member 104 is circular, oval-shaped, triangular, square, rectangular, or polygonal. In some embodiments, for example, the cross-sectional profile of the barrier members 104 are the same. In some embodiments, for example, one or more of the barrier members 104 has a cross-sectional profile that is different from other of the barrier members 104.

The rack 10 is releasably couplable to a vehicle 50 with a cab 52 that has a rear window 58. For example, where the vehicle 50 is a truck, the rack 10 is releasably couplable to the roof 54 of the cab 52, to the side 56 of the cab 52, or to both the roof 54 and the side 56 of the cab 52. While the rack 10 is releasably coupled to the cab 52, the barrier 100 is disposed between a truck bed 60 of the vehicle 50 and the rear window 58 of the cab 52. From the perspective of the cab 52, the barrier 100, while disposed between the truck bed 60 and the rear window 58 of the cab 52, provides a line of sight through the barrier 100 via the apertures 102. Accordingly, the rack 10, while releasably coupled to the vehicle 50, allows for operation of the vehicle 50. In some embodiments, the barrier 100 of the rack 10 is configured for disposition in opposition to the rear window 58 of the vehicle 50 while the rack 10 is releasably coupled to the vehicle 50, such that line of sight is provided from the cab 52, through the barrier 100, via the apertures 102, and the barrier 100 prevents oversized objects from contacting the rear window 58. In some embodiments, for example, the length of the aperture 102 is between 3″ and 66″, for example, between 12″ and 60″, for example, between 18″ and 54″. In some embodiments, for example, the length of the aperture 102 is at least 3″. In some embodiments, for example, the length of the aperture 102 is at least 12″. In some embodiments, for example, the length of the aperture 102 is at least 24″. In some embodiments, for example, the height of the aperture 102 is between 3″ and 29″, for example, between 6″ and 20″, for example, between 9″ and 18″. In some embodiments, for example, the height of the aperture 102 is at least 3″. In some embodiments, for example, the height of the aperture 102 is at least 6″.

In some embodiments, for example, while the barrier 100 is disposed in opposition to the rear window 58, the barrier 100 is disposed in alignment with the rear window 58. In some embodiments, for example, while the rack 10 is releasably coupled to the cab 52, the barrier 100 is disposed generally parallel to the rear window 58 of the cab 52. In some embodiments, for example, while the barrier 100 is disposed in opposition to the rear window 58, at least one of the barrier members 104 is disposed in opposition to the rear window 58. In some embodiments, for example, the at least one barrier member 104 that is disposed in opposition to the rear window 58 is disposed relative to the rear window 58 such that the barrier member 104 is not obscuring or blocking the lights that are connected to or mounted to the cab 52 from view.

In some embodiments, for example, disposition of the barrier 100 in opposition to the rear window 58 is such that the barrier 100 is disposed in alignment with the rear window 58. In some embodiments, for example, disposition of the barrier 100 in opposition to the rear window 58 is such that the barrier 100 is offset from the rear window 58, for example, by a distance between 1″ and 2″. In some embodiments, for example, disposition of the barrier 100 in opposition to the rear window 58 is such that the barrier 100 is offset from the rail 62, for example, by a distance of 2″.

In some embodiments, for example, the barrier members 104 defining the at least one aperture 102 is configured to prevent oversized objects from passing through the at least one aperture 102. For example, the aperture 102 is dimensioned to have a certain area, and the barrier members 104 defining the aperture 102 prevents a load having a larger cross-sectional area than the area of the aperture 102, the cross-section of the cross-sectional area being generally parallel with a plane defined by the body of the barrier 100, from passing through the aperture 102. As another example, the aperture 102 has one or more dimensions that is less than one or more dimensions of a load, and the barrier members 104 defining the aperture 102 prevents the load from passing through the aperture 102.

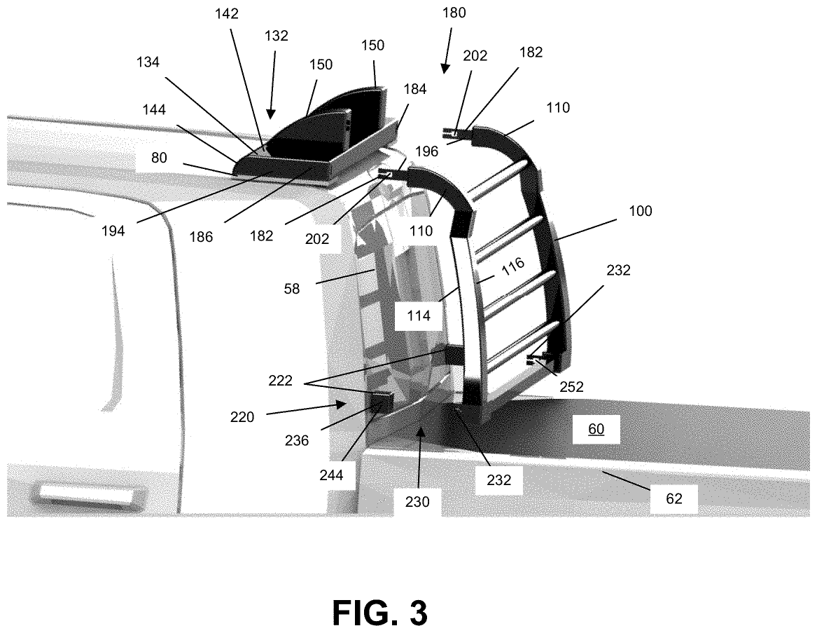

In some embodiments, for example, the barrier 100 or barrier members 104 has external surfaces 114 that are generally parallel to a plane defined by the body of the barrier 100. In some embodiments, for example, the external surfaces 114 are curved, as depicted in FIG. 1 to FIG. 3. For example, when the rack 10 is releasably coupled to the cab 52, such as depicted in FIG. 1, the external surfaces 114 on one side, for example, a front side, of the barrier 100 or barrier members 104 face the truck cab 52, and the external surfaces 114 on the other side, for example, a rear side, of the barrier 100 or barrier members 104 face the truck bed 60. As depicted in FIG. 3, a first external surface 114 is spaced apart from a second external surface 114 by a thickness of the barrier 100 or barrier member 104. As depicted in FIG. 3, a first external surface 114 opposes a second external surface 114. As depicted in FIG. 3, a first external surface 114 is parallel, or substantially parallel, to a second external surface 114. In some embodiments, for example, external surfaces 114, for example, front external surfaces, of a pair of merging barrier members 104 merge to define the external surface 114, for example, the front external surface, of the barrier 100. In some embodiments, for example, external surfaces 114, for example, rear external surfaces, of a pair of merging barrier members 104 merge to define the external surface 114, for example, the rear external surface, of the barrier 100. In some embodiments, for example, external surfaces 114, for example, front external surfaces, of two or more merging barrier members 104 merge to define the external surface 114, for example, the front external surface, of the barrier 100. In some embodiments, for example, external surfaces 114, for example, rear external surfaces, of two or more merging barrier members 104 merge to define the external surface 114, for example, the rear external surface, of the barrier 100. In some embodiments, for example, external surfaces 114, for example, front external surfaces, of merging barrier members 104 merge to define the external surface 114, for example, the front external surface, of the barrier 100. In some embodiments, for example, external surfaces 114, for example, rear external surfaces, of merging barrier members 104 merge to define the external surface 114, for example, the rear external surface, of the barrier 100.

In some embodiments, for example, the barrier 100, or the barrier members 104, are configured to define the apertures 102 based on the design of the cab 52 of the vehicle 50 upon which the rack 10 is releasably coupled. For example, some vehicle cabs 52 are configured to have three portions: a central portion, which has, for example, a rear view mirror, a hand brake, a gear shift, an audio/video system, and controls for the audio/video system; a first portion or driver portion that is adjacent the central portion, which has, for example, a steering wheel, an ignition switch, gas and brake pedals, and a seat for a driver; and a second portion or passenger portion that is adjacent the central portion on the opposite side of the central portion as the first portion, which has, for example, a glove compartment and a seat for a passenger. In such an example, the central portion of vehicle cabs 52 is not be intended to have a passenger or seat a passenger during operation of the vehicle 50.

In some embodiments, for example, the barrier 100 is configured to define the apertures 102 based on vehicle cabs 52 having such an example configuration. In such embodiments, for example, apertures 102 in portions of the barrier 100 that are be opposed or aligned with portions of the vehicle cab 52 that may have a person during operation of the vehicle 50 are configured to prevent oversized objects from passing through and contacting these portions of the cab 52 to protect a person that may be in the cab 52. In some embodiments, for example, the apertures 102 in such portions of the barrier 100 have an area that is narrower or smaller than apertures 102 disposed in the central portion of the barrier 100, such that the barrier members 104 defining the apertures 102 prevent smaller objects from passing through and contacting these portions of the rear window 58 of the cab 52. Similarly, apertures 102 in portions of the barrier 100 that are opposed or aligned with portions of the vehicle cab 52 that may not have a person during operation of the vehicle 50 are configured to provide line of sight from the cab 52, through the rear window 58 and through the barrier 100, via the apertures 102, such that a person in the cab 52 may see past the barrier 100 to operate the vehicle 50. The apertures 102 in such portions of the barrier 100 have an area that is wider or larger that the area defined by the apertures 102 in the side portions or first and second portions of the barrier 100, which provide a less obstructed or clearer or wider or longer line of sight from the cab 52, through the barrier 100, via the apertures 102.

In some embodiments, for example, the barrier 100 has a central portion, a first portion, and a second portion. In some embodiments, the barrier 100 is configured for disposition in opposition to a rear window 58 of a cab 52 having a central portion, which may not be intended to have a passenger or seat a passenger during operation of the vehicle 50, and first and second portions, which may be intended to have a passenger or seat a passenger during operation of the vehicle 50. While the barrier 100 is disposed in opposition to the rear window 58 of such a cab 52, in some embodiments, for example, the central portion of the barrier 100 is opposed to a portion of the rear window 58 corresponding to the central portion of the cab 52, the first portion of the barrier 100 is opposed to a portion of the rear window 58 corresponding to the first portion of the cab 52, and the second portion of the barrier 100 is opposed to a portion of the rear window 58 corresponding to the second portion of the cab 52. In some embodiments, for example, the central portion of the barrier 100 includes at least one central aperture 102. In some embodiments, for example, the central portion of the barrier 100 includes three central apertures 102 arranged in a column. In some embodiments, for example, the first portion of the barrier 100 includes at least one aperture 102. In some embodiments, for example, the first portion of the barrier 100 includes three apertures 102 arranged in a column. In some embodiments, for example, the second portion of the barrier 100 includes at least one aperture 102. In some embodiments, for example, the second portion of the barrier 100 includes three apertures arranged in a column. In some embodiments, for example, the central aperture 102 is wider or larger than the first aperture 102 or the second aperture 102. While the barrier members 104 that define the central aperture 102, the first aperture 102, and the second aperture 102 prevent objects from contacting the rear window 58, the barrier members 104 that define the first aperture 102 and the second aperture 102, prevent smaller objects from contacting the rear window 58 corresponding to portions of the cab 52, such as the first and second portions of the cab 52 adjacent to the central portion of the cab 52, that may be intended to have a passenger or seat a passenger during operation of the vehicle 50, compared to objects that are prevented from contacting the rear window 58 by the barrier members 104 that define the central aperture 102. While the central aperture 102 is disposed in opposition to a portion of a rear window 58 corresponding to the central portion of the cab 52, the central aperture 102 provides a clearer or wider or longer line of sight from the cab 52 through the rear window 58 and through the barrier 100 for operation of the vehicle 50.

In some embodiments, for example, the barrier 100 has a central portion, a first portion adjacent the central portion, and a second portion adjacent the central portion and opposite the first portion. In some embodiments, for example, as depicted in FIG. 1 to FIG. 3, the apertures 102 of the barrier 100 extend from one end of the barrier 100 to an opposite end of the barrier 100. That is, the apertures 102 of the barrier 100 extend from the first portion of the barrier 100, through the central portion of the barrier, to the second portion of the barrier.

In some embodiments, for example, the barrier 100 includes a central aperture 102 in the central portion to provide line of sight from the cab 52 through the central portion of the barrier 100 via the central aperture 102. The barrier members 104 that define the central aperture 102 in the central portion are configured to prevent oversized objects from contacting a portion of the rear window 58 that is aligned with the central portion of the barrier 100.

In some embodiments, the barrier 100 includes an aperture 102 in the first portion, the aperture 102 disposed adjacent the central aperture 102, wherein the barrier members 104 that define the aperture 102 in the first portion are configured to prevent oversized objects from contacting a portion of the rear window 58 that is aligned with the first portion of the barrier 100.

In some embodiments, the aperture 102 in the first portion is narrower than the central aperture 102.

In some embodiments, the barrier 100 includes an aperture 102 in the second portion, the aperture 102 positioned adjacent the central aperture 102, wherein the barrier members 104 that define the aperture 102 in the second portion are configured to prevent oversized objects from contacting a portion of the rear window 58 that is aligned with the second portion of the barrier 100.

In some embodiments, the aperture 102 in the second portion is narrower than the central aperture 102.

In some embodiments, the barrier 100 has a central portion, a first portion disposed adjacent the central portion on one side of the central portion, and a second portion disposed adjacent the central portion on a second, opposite side of the central portion, wherein the central portion includes at least one aperture 102 having a first area, and the first portion and the second portion each include at least one aperture 102 having a second area, wherein the first area is larger than the second area. In some embodiments, the area of the aperture 102 of the central portion is larger than the area of the apertures 102 of the first portion and the second portion.

In some embodiments, the central portion of the barrier 100 includes a plurality of apertures 102, and the first portion and the second portion each include a plurality of apertures 102, wherein each of the apertures 102 defined in the central portion have an area and each of the apertures 102 defined in the first portion and the second portion have an area, the area of each of the apertures 102 in the central portion being larger than the area of each of the apertures 102 in the first portion and the second portion.

In some embodiments, the plurality of apertures 102 in the central portion are disposed in a column and have a common length or a common width.

In some embodiments, the merging barrier members 104 of the barrier 100 define a first set of apertures 102 disposed in a central portion of the barrier 100, a second set of apertures 102 defined in a first portion of the barrier 100 disposed adjacent to and on a first side of the central portion, and a third set of apertures 102 defined in a second portion of the barrier 100 disposed adjacent to the central portion on a second opposite side of the central portion; wherein the first set of apertures 102 are larger than the second and third set of apertures 102.

In some embodiments, for example, the second and third set of apertures 102 each comprise a plurality of apertures of different sizes.

In some embodiments, for example, the rack 10 is a solid part that is manufactured by moulding, for example, blow moulding or injection moulding, without supporting structures (e.g. skeleton frame, trusses, foam, etc.) disposed in the barrier 100 or in contact with the barrier 100 to add structural strength to the barrier 100.

In such embodiments, for example, the barrier 100 does not include a secondary supporting structure disposed within or adjacent to the barrier 100. In some embodiments, for example, while the rack 10 is releasably coupled to the cab 52, the barrier 100 is disposed in an upright manner or position. In some embodiments, for example, the barrier 100 maintains its shape and configuration when disposed in an upright manner in the absence of a supporting structure disposed within or adjacent to the barrier 100. In some embodiments, the barrier 100 supports itself to be disposed in an upright manner. In some embodiments, the barrier members 104 provide structural strength to the barrier 100. In some embodiments, the barrier members 104 support the barrier 100 to be disposed in an upright manner.

In some embodiments, for example, the rack 10, in an absence of a supporting structure disposed within the barrier 100, is configured for disposition in opposition to the rear window 58 for providing line of sight from the cab 52, through the barrier 100, via the apertures 102, and preventing, via the barrier 100, oversized objects from contacting the rear window 58.

In other embodiments, for example, the rack 10 is manufactured by moulding, for example, blow moulding or injection moulding, and includes supporting structures (e.g. skeleton frame, trusses, foam, etc.) disposed in the barrier 100 or in contact with the barrier 100 to add structural strength to the barrier 100.

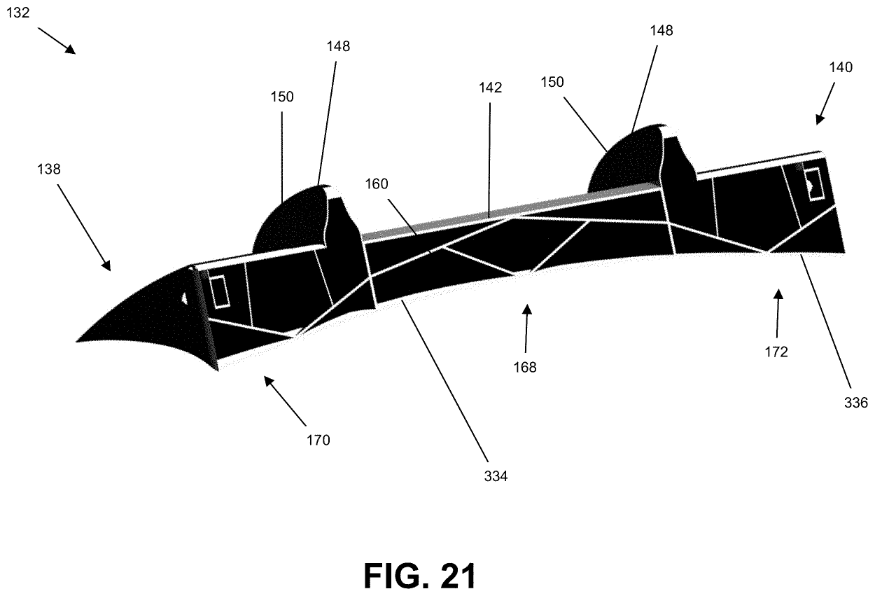

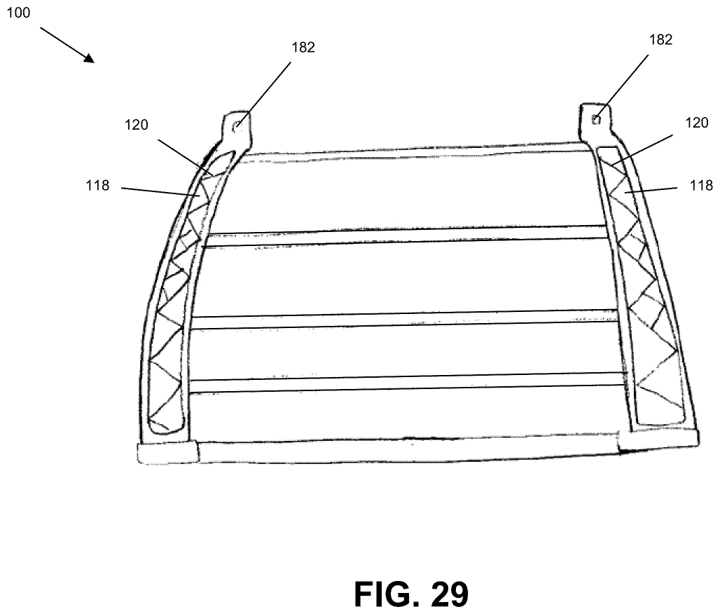

In this regard, in some embodiments, for example, as depicted in FIG. 29, an internal supporting structure 120 is disposed within the barrier 100. The internal supporting structure 120 is configured to increase the structural strength of the barrier 100 and reduce fatigue stress experienced by the barrier 100. In some embodiments, for example, the internal supporting structure 120 has a honeycomb structure, similar to the internal supporting structure 160 of the cab roof connectors 134 and 334, as depicted in FIG. 21. In some embodiments, for example, the internal supporting structure 120 includes one or more ribs extending within a cavity defined by the barrier 100. At least one of the plurality of barrier members 104 of the barrier 100 defines a cavity 118 to receive the internal supporting structure 120. In some embodiments, for example, the cavity 120 is defined by the plurality of barrier member 104 of the barrier 100. That is, in such embodiments, for example, the cavity 118 is defined by the entire barrier 100, with the cavity 118 extending through the entire barrier 100. In some embodiments, for example, the cavity 118 is defined on the first external surface 114, or the front-facing external surface, of the barrier 100 of the rack 10.

In some embodiments, for example, where a cavity 118 is defined by at least one of the plurality of barrier members 304, the rack 10 further comprises a cap that is configured cover the cavity 118 and prevent liquid, debris, or dirt from entering the cavity 118. In some embodiments, for example, the cap is configured to be received over the first external surface 114, or the front-facing external surface, of the barrier 100 to cover the cavity 118, which may prevent liquid, debris, or dirt from entering and accumulating in the cavity 118. In some embodiments, for example, the cap is configured to be received in the cavity 118 to cover the cavity 118, which may prevent liquid, debris, or dirt from entering and accumulating in the cavity 118.

In some embodiments, for example, while the rack 10 is releasably coupled to the vehicle 50 and the cap is covering the cavity, the cap is disposed in opposition to the rear window 58.

In some embodiments, for example, the cap is fastened to the barrier 100 using, for example, fasteners (e.g. nuts and bolts, eye bolt, nails, screws, pegs, pins, hook and loop fastener, adhesive, and the like). In some embodiments, for example, the cap is configured to be releasably coupled to the barrier 100 by friction fit, interference fit, snap fit, and the like.

In some embodiments, for example, a portion of the cab 52 of the vehicle 50 extends rearward beyond the rear window 58 of the cab 52 in order to reduce the amount of drag experienced by the vehicle 50 during operation of the vehicle 50. For example, the roof 54 of the cab 52 may extend rearward beyond the rear window 58 of the cab 52 in order to shift the stagnation point of the airflow that flows over the cab 52 in a rearward direction towards the truck bed 60, which may reduce the amount of drag experienced by the cab 52, and thus, the vehicle 50. In some embodiments, for example, said portion of the roof 54 that extends rearward beyond the rear window 58 has an arcuate portion, such that the arcuate portion is disposed in opposition of the rear window 58. In some embodiments, for example, said arcuate portion of the portion of the roof 54 that extends rearward beyond the rear window 58 has an aerodynamic cross-sectional profile or a cross-sectional profile having a foil shape.

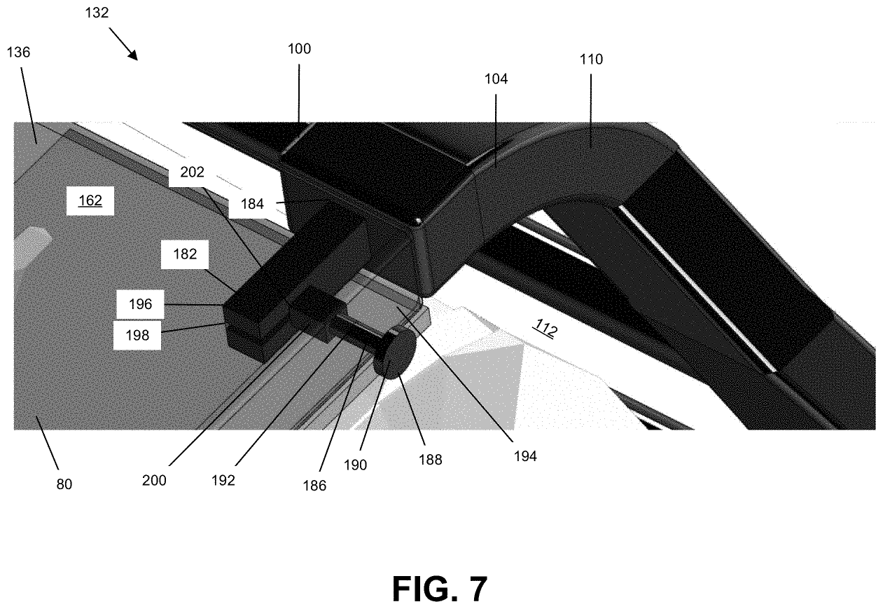

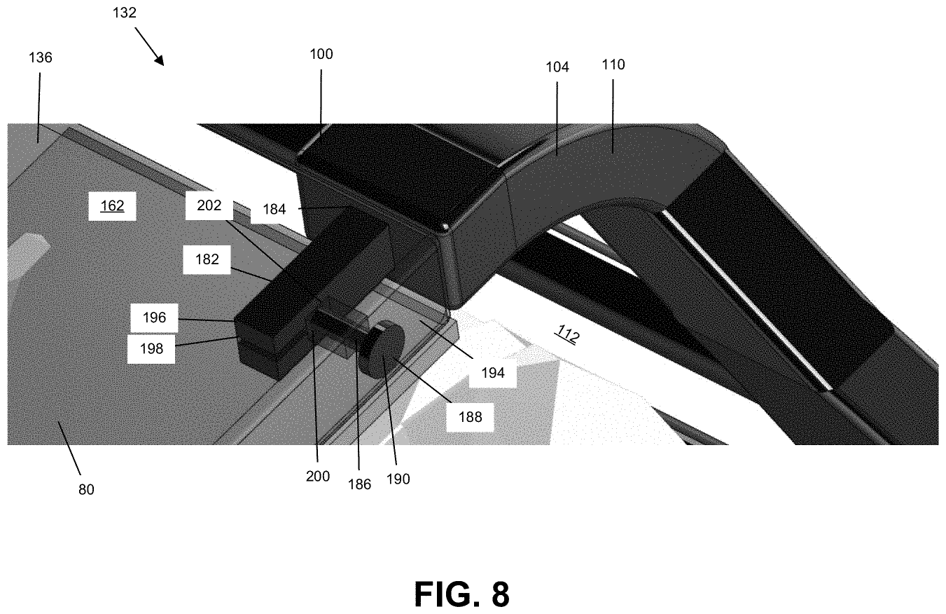

As depicted in FIG. 1, FIG. 7, and FIG. 8, in some embodiments for example, at least one of the plurality of barrier members 104 has an arcuate portion 110, such what while the barrier 100 is disposed in opposition of the rear window 58 while the rack 10 is releasably coupled to the cab 52, a space 112 is defined between the cab 52 and the arcuate portion 110. In some embodiments for example, the barrier 100 is shaped such what while the barrier 100 is disposed in opposition of the rear window 58 while the rack 10 is releasably coupled to the cab 52, the space 112 is defined between the cab 52 and the arcuate portion 110. The space 112 is configured to receive a portion of the cab 52 that extends rearward beyond the rear window 58 of the cab 52, such that said portion of the cab 52 that extends rearward beyond the rear window 58 of the cab 52 does not interfere with releasable coupling of the rack 10 to the cab 52, and does not interfere with the disposition of the barrier 100 in opposition to the rear window 58. This allows for the rack 10 to be releasably coupled to cabs 52 of different models or makes of vehicles 50. In addition, the space 112 provides clearance for the barrier 100 to displace in the direction of the rear window 58 before contacting the rear window 58. In some embodiments, for example, the minimum distance between the portion of the cab 52 that extends rearward beyond the rear window 58 and the barrier 100 is at least 1 inch. In some embodiments, for example, the distance between the portion of the cab 52 that extends rearward beyond the rear window 58 and the barrier 100 is 2 inches.

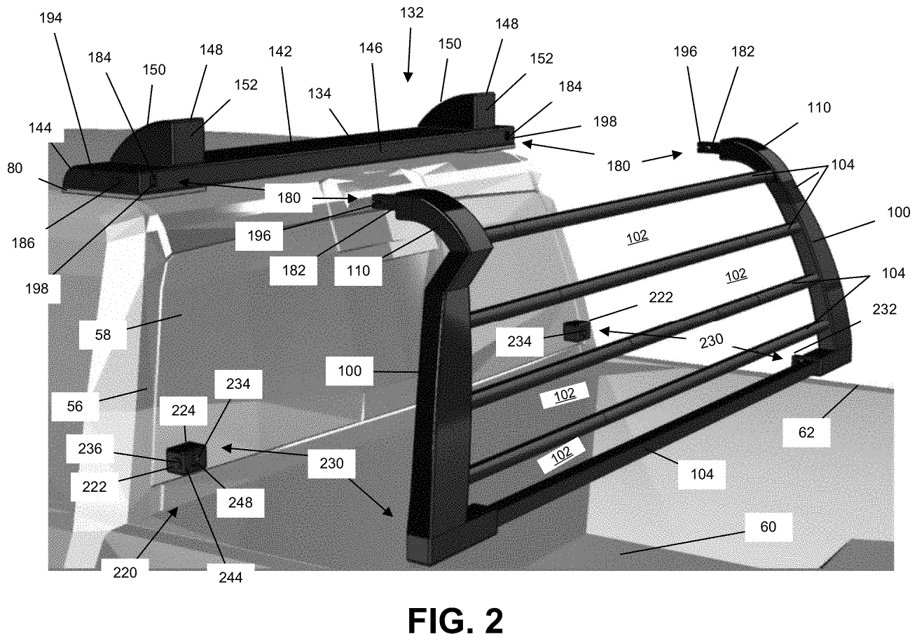

In some embodiments, for example at least one of the plurality of barrier members 104 defines a load supporting member 106 that is configured to support a load 90 applied to the barrier 100. As depicted in FIG. 1, FIG. 2, and FIG. 3, the load supporting member 106 is a generally horizontally disposed barrier member 104. A load 90, for example, lumber, a ladder, a surfboard, a tool box, crates, and the like, may be rested on or applied to the load supporting member 106 to be supported by the barrier 100, the rack 10, and the cab 52. While the rack 10 is releasably coupled to the cab 52 and the load 90 applied to the rack 10 is supported by the load supporting member 106, the load 90 is supported by the cab 52.

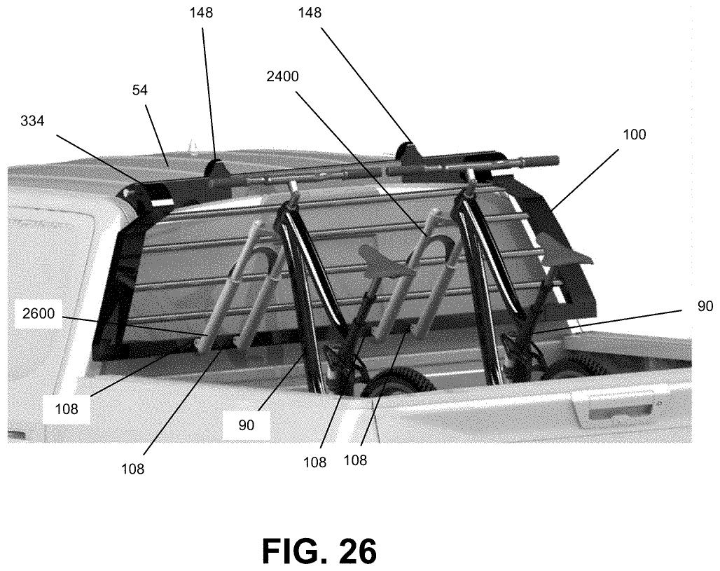

In some embodiments, for example, at least one of the barrier members 104 is configured for fastening the load 90 to the at least one of the barrier members 104. In some embodiments, for example, the barrier 100 defines one or more ports 108 that is configured to receive a fastener for fastening a load 90 to the barrier 100, or is configured to fasten the load 90 to the barrier 100 by friction fit, interference fit, snap fit, and the like. In some embodiments, for example, at least one of the barrier members 104 defines one or more ports 108 that is configured to receive a fastener for fastening a load 90 to the barrier 100, or is configured to fasten the load 90 to the barrier 100 by friction fit, interference fit, snap fit, and the like. In some embodiments, for example, said port is a ⅜″ threaded port. In some embodiments, for example, as depicted in FIG. 26, the barrier defines one or more ports 108 for connecting with one or more tubular supports 2600. As depicted in FIG. 26, while the tubular supports 2600 are connected to the barrier 100 via the ports 108, the tubular supports 2600 are configured to receive and support a frame or portion of a frame of a bicycle. In this regard, the barrier 100 is configured to support the bicycle frame via the tubular supports 2600 that are connected to the barrier 100 via the ports 108.

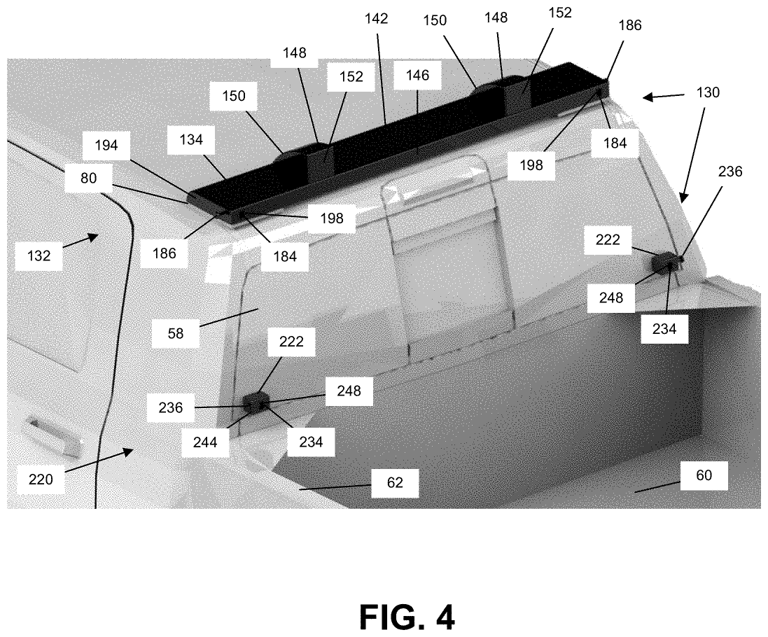

As depicted in FIG. 1, in some embodiments, for example, a connecting system 130 is configured to effect the releasably coupling of the rack 10 to the cab 52. In some embodiments, for example, the rack 10 includes a connecting system 130 for effecting the releasably coupling of the rack 10 to the cab 63. In such embodiments, the barrier 100 and the connecting system 130 are co-operatively configured such that, while the connecting system 130 is releasably coupled to the cab 52, the barrier 100 is releasably coupled to the cab 52 and disposed in opposition to the rear window 58. In some embodiments, for example, as depicted in FIG. 1 and FIG. 4, the connecting system 130 is configured to releasably couple the rack 10 to the roof 54 of the cab 52, to the side 56 of the cab 52, or to both the roof 54 and the side 56 of the cab 52.

As depicted in FIGS. 1 to 5, in some embodiments, for example, the connecting system 130 comprises a cab roof connecting system 132 for releasably coupling to a roof 54 of the cab 52. As depicted, in some embodiments, for example, the cab roof connecting system 132 includes at least one cab roof connector 134 for releasably coupling the rack 10 to a roof 54 of the cab 52. The barrier 100 and the connecting system 130 are co-operatively configured such that, while the cab roof connector 134 is releasably coupled to the roof 54 of the cab 52, the barrier 100 is releasably coupled to the roof 54 of the cab 52 and disposed in opposition to the rear window 58. In some embodiments, each one of the at least one cab roof connectors 134, independently, includes an adhesive for effecting the releasably coupling to the roof 54 of the cab 52.

In some embodiments, for example, the cab roof connector 134 has a length that spans or extends along the width of the cab 52. In some embodiments, for example, the cab roof connector 134 has a minimum length of at least 36 inches. In some embodiments, for example, the cab roof connector 134 has a length of 45 inches. In some embodiments, for example, the cab roof connector 134 has a length of 50 inches. In some embodiments, for example, the cab roof connector 134 has a length of 55 inches. In some embodiments, for example, the cab roof connector 134 has a length of 60 inches.

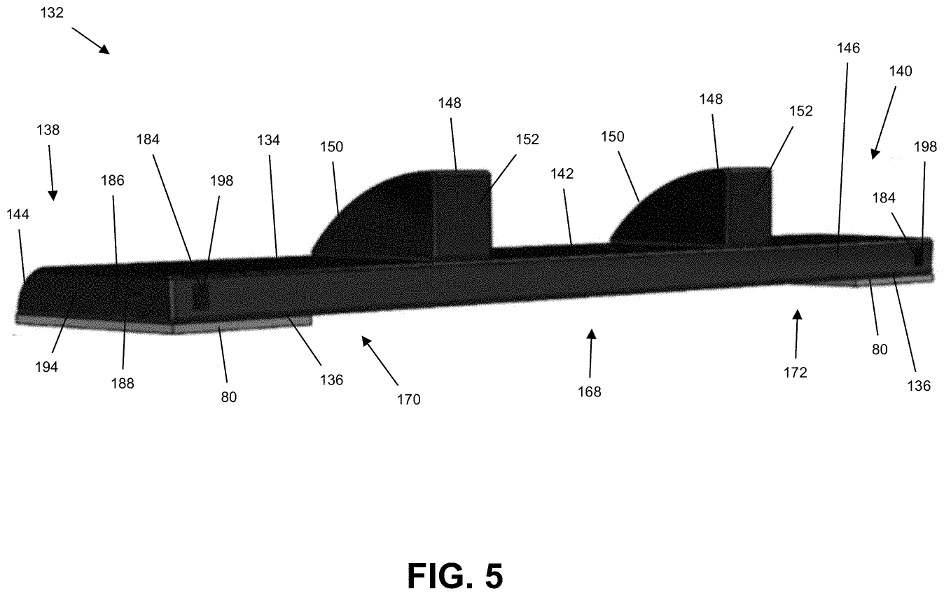

The cab roof connector 134 comprises a connecting surface 136 for releasably coupling the cab roof connector 134 to the roof 54 of the cab 52. The connecting system 130 and the cab 52 are co-operatively configured such that while the connecting surface 136 of the cab roof connector 134 is releasably coupled to the roof 54 of the cab 52, the cab roof connector 134 is releasably coupled to the roof 54 of the cab 52. As depicted in FIG. 5, in some embodiments, for example, while the rack 10 is disposed in an operative orientation, the connecting surface 136 of the cab roof connector 136 is a bottom surface, or a portion of a bottom surface, of the cab roof connector 136. In some embodiments, for example, as depicted in FIG. 5, the cab roof connector 134 has a first end 138 and a second end 140. In some embodiments, for example, the connecting surface 136 extends between the first end 138 and the second end 140 of the cab roof connector 134.

In some embodiments, for example, the cab roof connector 134 comprises a first connecting surface 136 and a second connecting surface 136 for releasably coupling the cab roof connector 134 to the roof 54 of the cab 52. The connecting system 130 and the cab 52 are co-operatively configured such that while the first connecting surface 136 and the second connecting surface 136 of the cab roof connector 134 are releasably coupled to the roof 54 of the cab 52, the cab roof connector 134 is releasably coupled to the roof 54 of the cab 52.

In some embodiments, for example, as depicted in FIG. 5, the cab roof connector 134 has the first end 138 and the second end 140, wherein the first end 138 and the second end 140 of the cab roof connector 134 are opposing ends of the cab roof connector 134. In some embodiments, for example, the first connecting surface 136 and the second connecting surface 136 of the cab roof connector 134 are disposed on opposing ends 138 and 140 of the cab roof connector 134. In some embodiments, for example, the connecting surface 136 extends between the first end 138 and the second end 140.

FIG. 1 to FIG. 4 and FIG. 14 depict the cab roof connector 134 releasably coupled to the roof 54 of the cab 52. In some embodiments, for example, while the cab roof connector 134 is releasably coupled to the roof 54 of the cab 52, the cab roof connector 134 defines a load supporting member 142 that is configured to support a load 90 applied to the rack 10. Similar to the load supporting member 106 as defined by a barrier member 104, a load 90, for example, lumber, a ladder, a surfboard, a tool box, crates, and the like, may be rested on or applied to the load supporting member 142 to be supported by the roof 54 of the cab 52. While the cab roof connector 134 is releasably coupled to the roof 54 of the cab 52 and the load 90 applied to the rack 10 is supported by the cab roof connector 134, the load 90 is supported by the cab 52.

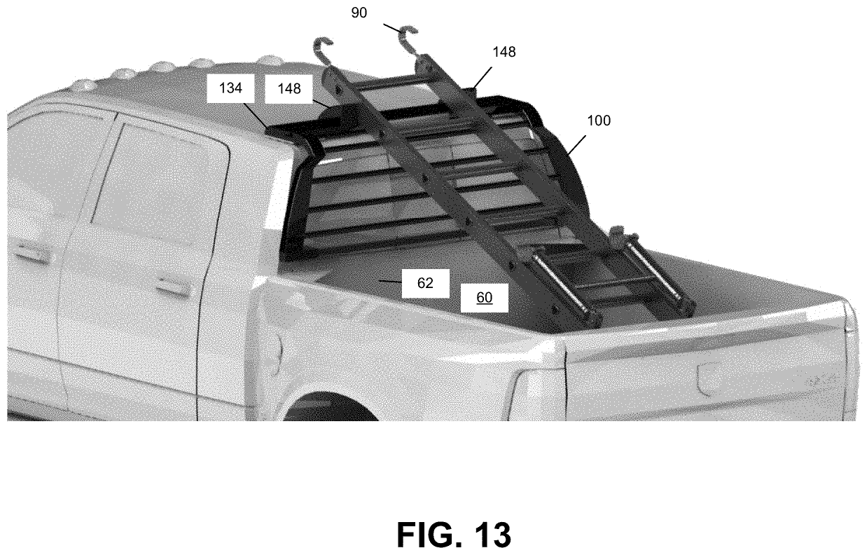

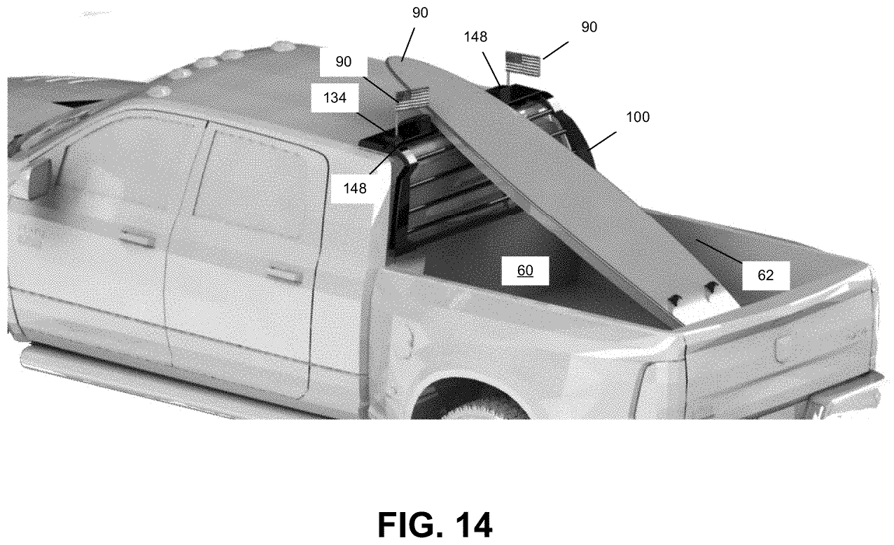

As depicted in FIG. 13 and FIG. 14, example loads 90 that may be supported by the rack 10 are relatively long loads 90 such as a ladder or a surfboard. As depicted, the ladder or surfboard is rested on or applied to the load supporting member 142 to be supported by the roof 54 of the cab 52. While the cab roof connector 134 is releasably coupled to the roof 54 of the cab 52 and the ladder or surfboard rested on the rack 10 is supported by the cab roof connector 134, the ladder or surfboard is supported by the cab 52.

In some embodiments, for example, the load supporting member 142 has a surface that is configured to resist displacement of a load 90 that is rested on or applied to the load supporting member 142. In some embodiments, for example, the surface of the supporting member 142 includes a grip pad that is configured to apply a frictional force to the load 90 that is rested on or applied to the load supporting member 142 to resist displacement of the load 90. In some embodiments, for example, the surface of the supporting member 142 is a rubberized surface that is configured to apply a frictional force to the load 90 that is rested on or applied to the load supporting member 142 to resist displacement of the load 90. In some embodiments, for example, the surface of the supporting member 142 is a textured surface that is configured to apply a frictional force to the load 90 that is rested on or applied to the load supporting member 142 to resist displacement of the load 90.

In some embodiments, for example, the load supporting member 142 is rounded or curved, to reduce wear and tear on the load supporting member 142.

As depicted in FIG. 1 to FIG. 5, the cab roof connector 134 includes a first surface 144 and a second surface 146. While the cab roof connector 134 is releasably coupled to the roof 54 of the cab 52, at least a portion of the first surface 144 is facing a front end of the cab 52, and at least a portion of the second surface 146 is facing a rear end of the cab 52, towards the truck bed 60. In some embodiments, for example, the first surface 144 is a leading surface.

In some embodiments, for example, as depicted in FIG. 1 to FIG. 5, the at least a portion of the first surface 144 or the leading surface of the cab roof connector 134 has an aerodynamic cross-sectional profile or a cross-sectional profile having a foil shape, such that, during operation of the vehicle 50, while the cab roof connector 134 is releasably coupled to the roof 54 of the cab 52, the drag and the noise due to the fluid flowing over the cab roof connector 134 may be reduced. Accordingly, since the cab roof connector 134 is releasably coupled to the roof 54 of the cab 52, the amount of drag experienced by the cab 52, and thus the vehicle 50, may also be reduced, which may improve the operational efficiency of the vehicle 50.

The cab roof connector 134 may comprise one or more protrusions 148. As depicted in FIG. 1 to FIG. 5, the cab roof connector 134 has two protrusions 148. The protrusions 148 may extend from a surface of the cab roof connector 134. While the cab roof connector 134 is releasably coupled to the roof 54 of the vehicle 50, in some embodiments, for example, the protrusions 148 are pointing in a generally upward direction, as depicted in FIG. 1 to FIG. 5. While the cab roof connector 134 is releasably coupled to the roof 54 of the vehicle 50, the protrusions 148 prevent, resist, or reduce lateral movement of load resting on cab roof connector 134. For example, when a load 90, for example, lumber, a ladder, a surfboard, a tool box, crates, and the like, is resting on the cab roof connector 134 between the protrusions 148, lateral movement of the load 90 may be prevented, resisted, or reduced by the protrusions 148, such that the load 90 does not fall, slip, or slide off the cab roof connector 134, and the cab roof connector 134 maintains support of the load 90.

As depicted in FIG. 1 to FIG. 5, the protrusion 148 includes a first surface 150 and a second surface 152. While the cab roof connector 134 is releasably coupled to the roof 54 of the cab 52, at least a portion of the first surface 150 is facing a front end of the cab 52, and at least a portion of the second surface 152 is facing a rear end of the cab 52, towards the truck bed 60. In some embodiments, for example, the first surface 150 is a leading surface.

In some embodiments, for example, as depicted in FIG. 1 to FIG. 5, the at least a portion of the first surface 150 or the leading surface of the protrusion 148 has an aerodynamic cross-sectional profile or a cross-sectional profile having a foil shape, such that, during operation of the vehicle 50, while the cab roof connector 134 is releasably coupled to the roof 54 of the cab 52, the drag and the noise due to the fluid flowing over the protrusion 148 may be reduced. Accordingly, since the cab roof connector 134 is releasably coupled to the roof 54 of the cab 52, the amount of drag experienced by the cab 52, and thus the vehicle 50, may also be reduced, which may improve the operational efficiency of the vehicle 50.

As depicted in FIG. 13 and FIG. 14, example loads 90 that are supportable by the rack 10 is a ladder or a surfboard. As depicted, the ladder or surfboard is rested on or applied to the load supporting member 142 and between the protrusions 148. While the cab roof connector 134 is releasably coupled to the roof 54 of the cab 52 and the ladder or surfboard rested on the rack 10 is supported by the cab roof connector 134, during operation of the vehicle 50, lateral movement of the ladder or surfboard is resisted by the protrusions 148, such that the cab roof connector 134 resists or interferes with lateral displacement of the ladder or surfboard to prevent or mitigate the ladder or surfboard from falling out of the truck bed 60.

In some embodiments, for example, the cab roof connector 134 defines a channel 154 that extends between the first surface 144 and the second surface 146 of the cab roof connector 134. The channel 134 is configured to reduce the amount of drag experienced by the cab roof connector 134. During operation of the vehicle 50, fluid surrounding the vehicle 50 will flow over the cab roof connector 134. While the cab roof connector 134 is releasably coupled to the roof 54 of the cab 52, the channel 154 is configured to receive therethrough at least a portion of the fluid that would otherwise have flown over the cab roof connector 134, such that the drag force experienced by the cab roof connector 134 may be reduced. Accordingly, since the cab roof connector 134 is releasably coupled to the roof 54 of the cab 52, the amount of drag experienced by the cab 52, and thus the vehicle 50, may also be reduced, which may improve the operational efficiency of the vehicle 50.

In some embodiments, for example, the first surface 144 of the cab roof connector 134 defines a first notch 156, and the second surface 146 of the cab roof connector 134 defines a second notch 156, wherein the cab 52 and the cab roof connector 134 are co-operatively configured such that, while the cab roof connector 134 is releasably coupled to the roof 54 of the cab 52, the channel 154 is defined by the first notch 156, the second notch 156, and the roof 54 of the cab 52. While the cab roof connector 134 is releasably coupled to the roof 54 of the cab 52, the channel 154 is configured to receive therethrough at least a portion of the fluid that would otherwise have flown over the cab roof connector 134, such that the drag force experienced by the cab roof connector 134 may be reduced.

In some embodiments, for example, the cab 52 includes one or more ridges that extend lengthwise along the cab 52. Said ridges may have an aesthetic function, or may function to reduce the amount of drag experienced by the cab 52. In some embodiments, for example, the cab 52 and the cab roof connector 134 are co-operatively configured such that, while the cab roof connector 134 is releasably coupled to the roof 54 of the cab 52, the notch 156 defined on the first surface 144 of the cab roof connector 134 and the notch 156 defined on the second surface 146 of the cab roof connector 134 are configured to receive the one or more ridges of the cab 52, such that said ridges of the cab 52 do not interfere with releasable coupling of the cab roof connector 134 and the roof 54 of the cab 52.

In some embodiments, for example, where the cab 52 includes one or more of said lengthwise-extending ridges, while the cab roof connector 134 is releasably coupled to the roof 54 of the cab 52, the cab roof connector 134, or portions of the cab roof connector 134 that engage with the ridges, is resiliently deformed. In this regard, the cab roof connector 134 is constructed of a material that is resiliently deformable, such that the cab roof connector 134 is deformable while being releasably coupled to the roof 54 of the cab 52, such that said ridges of the cab 52 do not interfere with releasable coupling of the cab roof connector 134 and the roof 54 of the cab 52.

In some embodiments, for example, the cab 52 includes an antenna 64 extending from the roof 54 of the cab 52. In such embodiments, for example, the cab roof connector 134 defines a recess 158 that is configured to receive the antenna 64, such that while the cab roof connector 134 is releasably coupled to the roof 54 of the cab 52, the antenna 64 is received in the recess 158, and that the antenna 64 does not interfere with releasable coupling of the cab roof connector 134 and the roof 54 of the cab 52.

In some embodiments, for example, the cab roof connector 134 is a solid component. In other embodiments, for example, the cab roof connector 134 is a shell that defines a cavity within the cab roof connector 134.

In some embodiments, for example, the cab roof connector 134 is a solid part that is manufactured by moulding, for example, blow moulding or injection moulding, without supporting structures (e.g. skeleton frame, trusses, foam, etc.) disposed in the cab roof connector 134 or in contact with the cab roof connector 134 to add structural strength to the cab roof connector 134.

In such embodiments, for example, the cab roof connector 134 does not include a secondary supporting structure disposed within or adjacent to the cab roof connector 134. In some embodiments, for example, while the cab roof connector 134 is releasably coupled to the roof 54 of the cab 52, the cab roof connector 134 maintains its shape and configuration in the absence of a supporting structure disposed within or adjacent to the cab roof connector 134. In some embodiments, the cab roof connector 134 supports itself while the cab roof connector 134 is releasably coupled to the roof 54 of the cab 52.

In some embodiments, for example, the cab roof connector 134, in an absence of a supporting structure disposed within the cab roof connector 134, is configured to be releasably coupled to the roof 54 of the cab 52.

In other embodiments, for example, the cab roof connector 134 is manufactured by moulding, for example, blow moulding or injection moulding, and includes supporting structures (e.g. skeleton frame, trusses, foam, etc.) disposed in the cab roof connector 134 or in contact with the cab roof connector 134 to add structural strength to the cab roof connector 134.

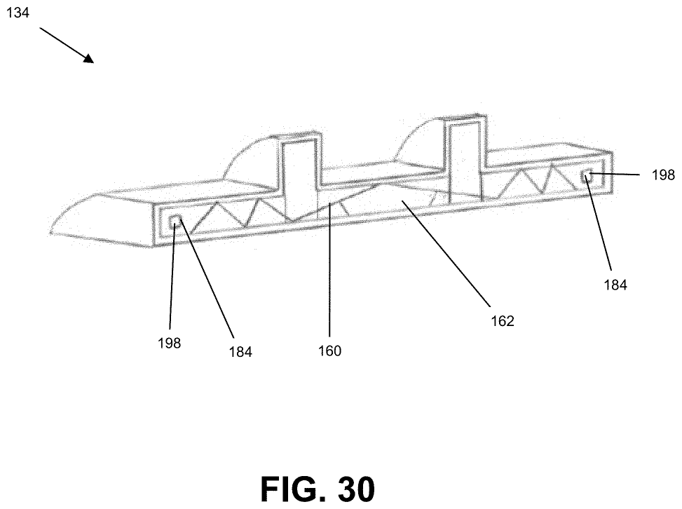

In this regard, in some embodiments, for example, as depicted in FIG. 30, an internal supporting structure 160 is disposed within the cab roof connector 134. The internal supporting structure 160 is configured to increase the structural strength of the cab roof connector 134 and reduce fatigue stress experienced by the cab roof connector 134. In some embodiments, for example, the internal supporting structure 160 has a honeycomb structure, similar to the internal supporting structure 160 of the cab roof connector 334, as depicted in FIG. 21. In some embodiments, for example, the internal supporting structure 160 includes one or more ribs extending within a cavity defined by the cab roof connector 134. In some embodiments, for example, the internal supporting structure 160 is a foam support. The cab roof connector 134 defines a cavity 162 to receive the internal supporting structure 160. In some embodiments, for example, the cavity 162 is defined by the entire cab roof connector 134, with the cavity 160 extending through the entire cab roof connector 134. In some embodiments, for example, the cavity 160 is defined on a bottom surface of the cab roof connector 134. In some embodiments, for example, the cavity 160 is defined on the connecting surface 136 of the cab roof connector 134.

In some embodiments, for example, the cab roof connector 134 is releasably coupled to the roof 54 of the cab 52 using a fastener (e.g. nuts and bolts, eye bolt, nails, screws, pegs, pins, hook and loop fastener, adhesive, and the like), welding, chemical bonding, and the like. In some embodiments, for example, the cab roof connector 134 is releasably coupled to the roof 54 of the cab 52 using double-sided tape. In some embodiments, for example, the double-sided tape is configured to adhere, on the first side, to the material of the roof 504 of the cab 54, for example, metal or glass, and on the second side, to the material of the cab roof connector 134. In some embodiments, for example, the cab roof connector 134 is releasably coupled to the roof 54 of the cab 52 using 3M® adhesive pads or 3M Velcro®. In some embodiments, for example, where the fastener is double-sided tape, one side of the tape is connected to the roof 54, and the other side of the tape is connected to the connecting surface 136 of the cab roof connector 134, as depicted in FIG. 5. As depicted, in some embodiments, for example, the cab roof connector 134 is connected to the roof 54 using more than one piece of double-sided tape, for example, two pieces of double-sided tape. In some embodiments, for example, the minimum length of the double-sided tape is at least 2 inches. In some embodiments, for example, the length of the double-sided tape is 8.75 inches. In some embodiments, for example, the minimum width of the double-sided tape is at least 2 inches. In some embodiments, for example, the width of the double-sided tape is 7.25 inches. In some embodiments, for example, the minimum thickness of the double-sided tape is at least 0.125 inches. In some embodiments, for example, the thickness of the double-sided tape is 0.25 inches.

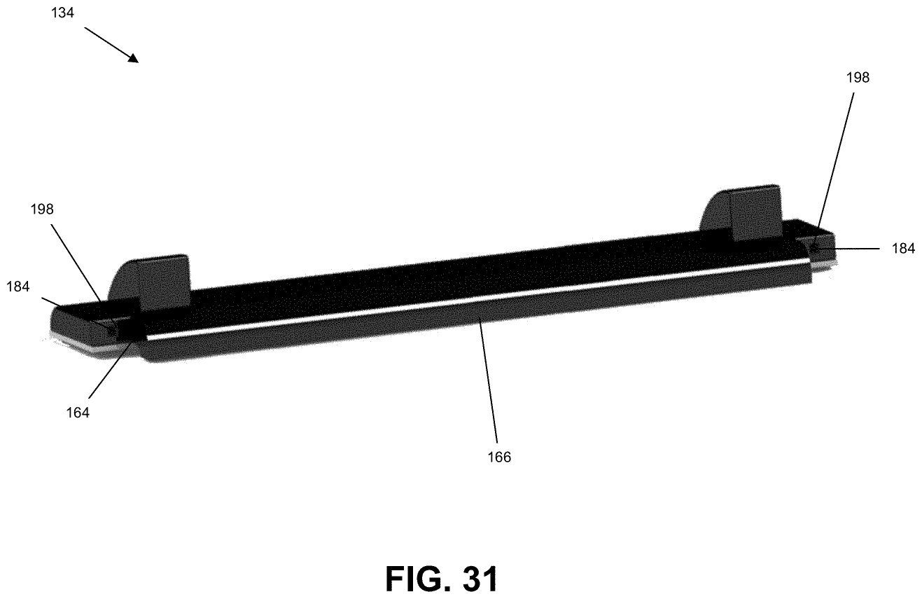

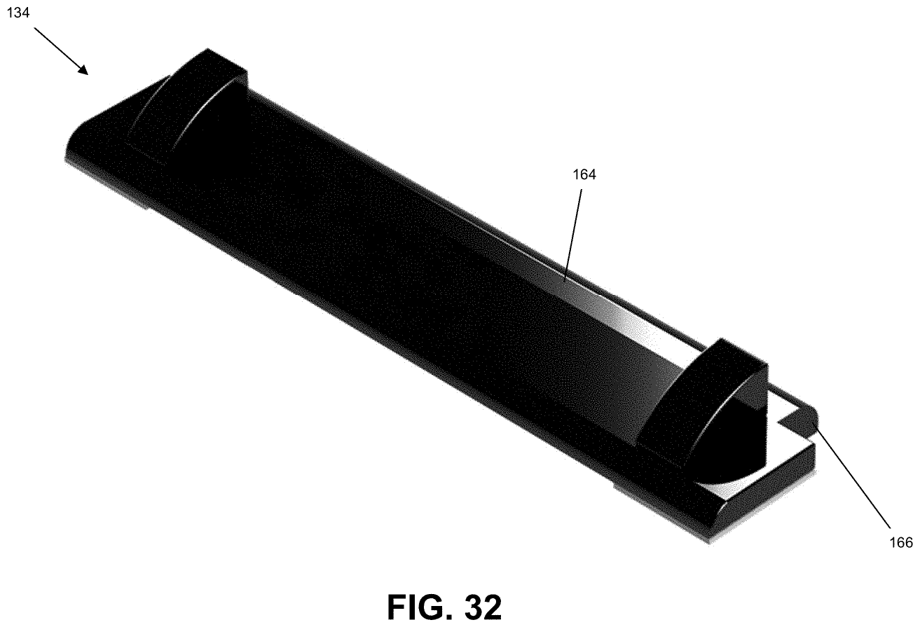

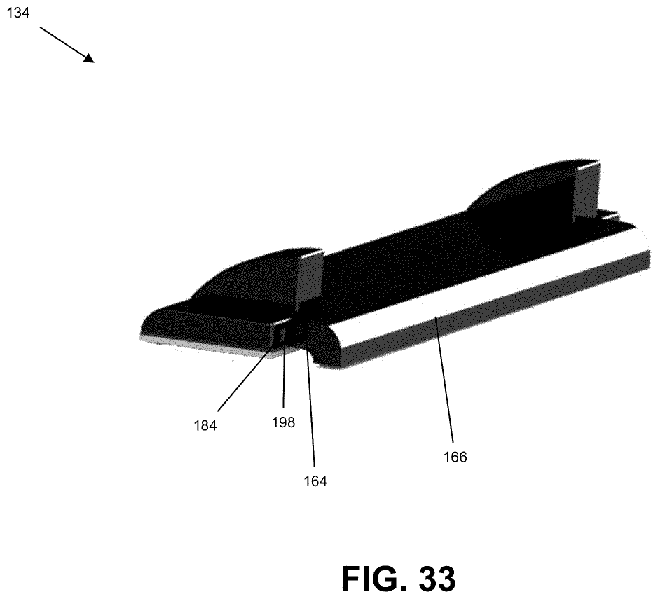

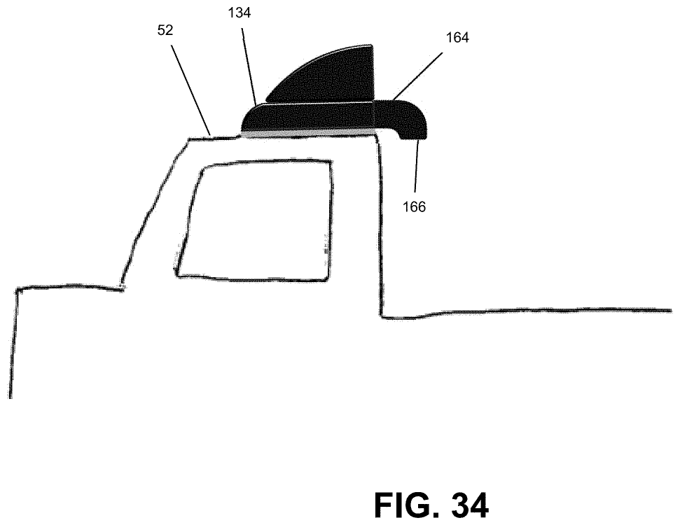

In some embodiments, for example, as depicted in FIG. 31 to FIG. 34, the cab roof connector 134 includes a portion 164 wherein, while the cab roof connector 134 is releasably coupled to the roof 54 of the cab 52, the portion 164 of the cab roof connector 134 extends rearward beyond the rear window 58 of the cab 52 in order to reduce the amount of drag experienced by the vehicle 50 during operation of the vehicle 50. For example, said extended portion 164 of the cab roof connector 134 extend rearward beyond the rear window 58 of the cab 52 in order to shift the stagnation point of the airflow that flows over the cab 52 and the cab roof connector 134 in a rearward direction towards the truck bed 60, which reduces the amount of drag experienced by the cab 52, and thus, the vehicle 50. In some embodiments, for example, said rearward extended portion 164 has an arcuate portion 166, such that while the cab roof connector 134 is releasably coupled to the roof 54 of the cab 52, the arcuate portion 166 is disposed in opposition of the rear window 58. In some embodiments, for example, said arcuate portion 166 of the extended portion 164 that extends rearward beyond the rear window 58 has an aerodynamic cross-sectional profile or a cross-sectional profile having a foil shape. In some embodiments, for example, the minimum distance that the portion 164 of the cab roof connector 134 extends rearward beyond the rear window 58 is at least 1 inch. In some embodiments, for example, the portion 164 extends rearward beyond the rear window 58 by 2 inches.

In some embodiments, for example, the cab roof connector 134 has a central portion 168, a first portion 170 disposed adjacent the central portion 168 on one side of the central portion 168, and a second portion 172 disposed adjacent the central portion 168 on a second side of the central portion 168 that is opposite the first side, as depicted in FIG. 5. In some embodiments, for example, the extended portion 164 of the cab roof connector 134 extends from at least one of the central portion 168, the first portion 170, and the second portion 172 of the cab roof connector 134. In some embodiments, for example, the extended portion 164 of the cab roof connector 134 extends from the first portion 170 and the second portion 172 of the cab roof connector 134, while not extending from the central portion 168. In some embodiments, for example, the extended portion 164 of the cab roof connector 134 extends from the central portion 168, the first portion 170, and the second portion 172.

In some embodiments, for example, while the cab roof connector 134 is releasably coupled to the roof 54 of the cab 52, and the extended portion 164 of the cab roof connector 134 is extending beyond the rear window 58 of the cab 52, the cab roof connector 134 prevents or mitigates the collection of dirt, debris, rain, and the like, on the rear window 58.

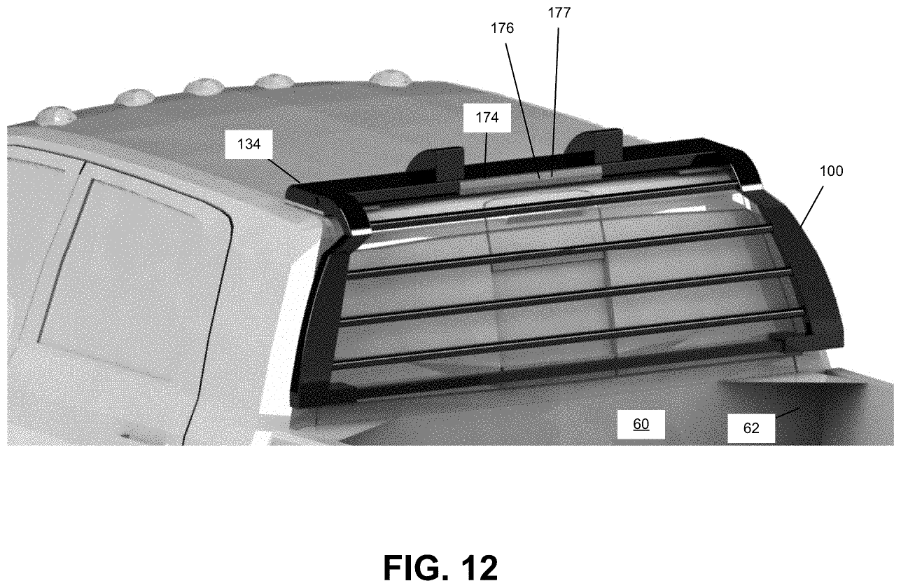

As depicted in FIG. 12, in some embodiments, for example, it is desirable to operate a light fixture 177, such as a signaling light, or a break light, from within the cab 52 during operation of the vehicle 50. In such embodiments, for example, the cab roof connector 134 defines a recess 174 that is configured to receive a light fixture 177 that is configured to be operable during operation of the vehicle 50, and an opening 176 for viewing the light fixture 177 that is received in the recess 174. As depicted in FIG. 12, the light fixture 177 that is received in the recess 174 is viewable from a perspective that is behind the vehicle 50.

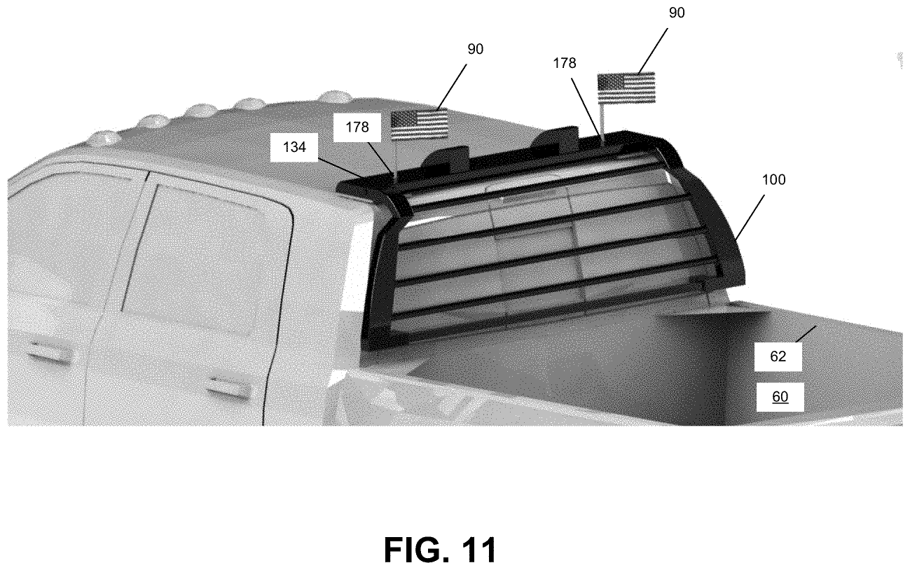

As depicted in FIG. 11 and FIG. 14, in some embodiments, for example, it is desirable to fasten a load 90 to the cab roof connector 134. In such embodiments, for example, the cab roof connector 134 defines one or more ports 178 that is configured to receive a fastener for fastening a load 90 to the cab roof connector 134, or is configured to fasten the load 90 to the cab roof connector 134 by friction fit, interference fit, snap fit, and the like. In some embodiments, for example, the port 178 is threaded. In some embodiments, for example, the load 90 is a light fixture, and in such embodiments, the port 178 functions as a light fixture attachment point. As depicted in FIG. 11, the load 90 is a flag, and the flag pole is received in the port 178 to fasten the load 90 to the cab roof connector. In some embodiments, for example, the port 178 is a ⅜″ threaded port.

In some embodiments, for example, the cab roof connecting system 132 includes a first cab roof connector 134 and a second cab roof connector 134 for releasably coupling the rack 10 to a roof 54 of the cab 52. The barrier 100 and the connecting system 130 are co-operatively configured such that, while the first and second cab roof connectors 134 are releasably coupled to the roof 54 of the cab 52, the barrier 100 is releasably coupled to the roof 54 of the cab 52 and disposed in opposition to the rear window 58. In some embodiments, each one of the first and second cab roof connectors 134, independently, includes an adhesive for effecting the releasably coupling to the roof 54 of the cab 52.

As depicted in FIGS. 1 to 4, FIG. 6, and FIG. 36 in some embodiments, for example, the connecting system 130 comprises a cab side connecting system 220 for releasably coupling to a side 56 of the cab 52. As depicted, in some embodiments, for example, the cab side connecting system 222 includes at least one cab side connector 222 for releasably coupling to a side 56 of the cab 52. The barrier 100 and the connecting system 130 are co-operatively configured such that, while the cab side connector 222 is releasably coupled to the cab 52, the barrier 100 is releasably coupled to the side 56 of the cab 52 and disposed in opposition to the rear window 58. In some embodiments, for example, each one of the at least one cab side connectors 222, independently, includes an adhesive for effecting the releasably coupling to the side 56 of the cab 52.

In some embodiments, for example, the cab side connector 222 has a minimum length of at least 2 inches. In some embodiments, for example, the length of the cab side connector 222 is 3 inches. In some embodiments, for example, the cab side connector 222 has a minimum width of at least 1 inch. In some embodiments, for example, the cab side connector 222 has a width of 2 inches. In some embodiments, for example, the cab side connector 222 has a minimum height of at least 1 inch. In some embodiments, for example, the cab side connector 222 has a height of 2 inches.

The cab side connector 222 comprises a connecting surface 224 for releasably coupling the cab side connector 222 to the side 56 of the cab 52. The connecting system 130 and the cab 52 are co-operatively configured such that while the connecting surface 224 of the cab side connector 222 is releasably coupled to the side 56 of the cab 52, the cab side connector 222 is releasably coupled to the side 56 of the cab 52. As depicted in FIGS. 2, 3, 4, 6, and 36, in some embodiments, for example, while the rack 10 is disposed in an operative orientation, the connecting surface 224 of the cab side connector 222 is a surface that faces towards the front of the cab 52, or a portion of said surface.

In some embodiments, for example, the cab side connector 222 is a solid component. In other embodiments, for example, the cab side connector 222 is a shell that defines a cavity within the cab side connector 222.

In some embodiments, for example, the cab side connector 222 is a solid part that is manufactured by moulding, for example, blow moulding or injection moulding, without supporting structures (e.g. skeleton frame, trusses, foam, etc.) disposed in the cab side connector 222 or in contact with the cab side connector 222 to add structural strength to the cab side connector 222.

In such embodiments, for example, the cab side connector 222 does not include a secondary supporting structure disposed within or adjacent to the cab side connector 222. In some embodiments, for example, while the cab side connector 222 is releasably coupled to the side 56 of the cab 52, the cab side connector 222 maintains its shape and configuration in the absence of a supporting structure disposed within or adjacent to the cab side connector 222. In some embodiments, the cab side connector 222 supports itself while the cab side connector 222 is releasably coupled to the side 56 of the cab 52.

In some embodiments, for example, the cab side connector 222, in an absence of a supporting structure disposed within the cab side connector 222, is configured to be releasably coupled to the side 56 of the cab 52.

In other embodiments, for example, the cab side connector 222 is manufactured by moulding, for example, blow moulding or injection moulding, and includes supporting structures (e.g. skeleton frame, trusses, foam, etc.) disposed in the cab side connector 222 or in contact with the cab side connector 222 to add structural strength to the cab side connector 222.

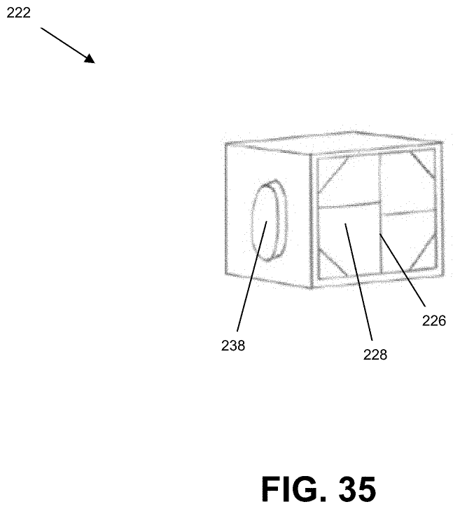

In this regard, in some embodiments, for example, as depicted in FIG. 35, an internal supporting structure 226 is disposed within the cab side connector 222. The internal supporting structure 226 is configured to increase the structural strength of the cab side connector 222 and reduce fatigue stress experienced by the cab side connector 222. In some embodiments, for example, the internal supporting structure 226 has a honeycomb structure, similar to the internal supporting structure 160 of the cab roof connectors 134 and 334, as depicted in FIG. 21. In some embodiments, for example, the internal supporting structure 226 includes one or more ribs extending within a cavity defined by the cab side connector 222. In some embodiments, for example, the internal supporting structure 226 is a foam support. The cab side connector 222 defines a cavity 228 to receive the internal supporting structure 226. In some embodiments, for example, the cavity 228 is defined by the entire cab side connector 222, with the cavity 228 extending through the entire cab side connector 222. In some embodiments, for example, the cavity 228 is defined on a bottom surface of the cab side connector 222. In some embodiments, for example, the cavity 228 is defined on the connecting surface 224 of the cab side connector 222.

In some embodiments, for example, the cab side connector 222 is releasably coupled to the side 56 of the cab 52 using a fastener (e.g. nuts and bolts, eye bolt, nails, screws, pegs, pins, hook and loop fastener, adhesive, and the like), welding, chemical bonding, and the like. In some embodiments, for example, the cab side connector 222 is releasably coupled to the side 56 of the cab 52 using double-sided tape. In some embodiments, for example, the double-sided tape is configured to adhere, on the first side, to the material of the side 56 of the cab 54, for example, metal or glass, and on the second side, to the material of the cab side connector 222. In some embodiments, for example, the cab side connector 222 is releasably coupled to the side 56 of the cab 52 using 3M® pads or 3M Velcro®. In some embodiments, for example, where the fastener is double-sided tape, one side of the tape is connected to the side 56, and the other side of the tape is connected to the connecting surface 224 of the cab side connector 222. In some embodiments, for example, the minimum length of the double-sided tape is at least 1 inch. In some embodiments, for example, the length of the double-sided tape is 3 inches. In some embodiments, for example, the minimum width of the double-sided tape is at least 1 inches. In some embodiments, for example, the width of the double-sided tape is 2 inches. In some embodiments, for example, the minimum thickness of the double-sided tape is at least 0.125 inches. In some embodiments, for example, the thickness of the double-sided tape is 0.25 inches.

As depicted in FIG. 1, the rack 10 is configured such that, while the rack 10 is disposed in an operative orientation, the cab roof connecting system 132 is disposed above the cab side connecting system 220. As depicted in FIG. 1, the rack 10 is configured such that, while the rack 10 is disposed in an operative orientation, the cab roof connector 134 is disposed above the cab side connector 222. In some embodiments, for example, the rack 10 is configured such that, while the rack 10 is disposed in the operative orientation, the cab roof connector 134 is releasably couplable to the roof 54 of the cab 52, and the cab side connector 222 is releasably couplable to the cab 52 below the roof 54, such as to the side 56 of the cab 52.

The cab side connector 222 is configured to be releasably couplable with the sheet metal surface of the cab 52. In some embodiments, for example, the side 56 of the cab 52 that is releasably couplable with the cab side connector 222 is a rear side 56 of the cab 52, as depicted in FIG. 1. In some embodiments, for example, the side 56 of the cab 52 that is releasably couplable with the cab side connector 222 is a first end side 56 or a second end side 56 of the cab 52, the first and second end sides 56 being the sides of the cab 52 through which a user of the vehicle enters or exits the cab 52. In some embodiments, for example, the cab side connector 222 is releasably couplable with the rear window 58 of the cab 52.

As depicted in FIGS. 1 to 4, 6 and 36, in some embodiments, for example, the cab side connecting system 220 comprises a first cab side connector 222 and a second cab side connector 222 for releasably coupling to the side 56 of the cab 52. The barrier 100 and the connecting system 130 are co-operatively configured such that, while the first cab side connector 222 and the second cab side connector 222 are releasably coupled to the cab 52, the barrier 100 is releasably coupled to the side 56 of the cab 52 and disposed in opposition to the rear window 58. In some embodiments, for example, each one of the first and second cab side connectors 222, independently, includes an adhesive for effecting the releasably coupling to the side 56 of the cab 52.

The first and second cab side connectors 222 each comprise a connecting surface 224 for releasably coupling the first and second cab side connectors 222 to the side 56 of the cab 52. The connecting system 130 and the cab 52 are co-operatively configured such that while the connecting surfaces 224 of the first and second cab side connectors 222 are releasably coupled to the side 56 of the cab 52, the first and second cab side connectors 222 are releasably coupled to the side 56 of the cab 52. As depicted in FIGS. 2, 3, 4, 6, and 36, in some embodiments, for example, while the rack 10 is disposed in the operative orientation, the connecting surface 224 of the cab side connectors 222 are a surface that faces towards the front of the cab 52, or a portion of said surface.

In some embodiments, for example, the rack 10 is configured to be supportable by the cab 52. In such embodiments, for example, the rack 10 is a rack 10 of unitary one-piece construction that is supportable by a cab 52 of a vehicle 50, the cab 52 having a rear window 58. The rack 10 comprises a barrier 100 defined by a plurality of barrier members 104, wherein the rack 10 is configured to co-operate with the cab, such that, while the rack 10 is releasably coupled to the cab 52, the barrier 100 is disposed in opposition to the rear window 58, line of sight is provided from the cab 52, through the barrier 100, and the barrier 100 prevents oversized objects from contacting the rear window 58.

In some embodiments, for example, the rack 10 is supportable exclusively by the cab 52. In some embodiments, for example, while the rack 10 is supported by the cab 52, the rack 10 is hung from the cab 52.

In some embodiments, for example, the rack 10 is a rack 10 of unitary one-piece construction that is releasably couplable to a cab 52 of a vehicle 50, the cab 52 having a rear window 58. The rack 10 comprises a barrier 100 defined by a plurality of barrier members 104, wherein the rack 10 is configured to co-operate with the cab, such that, while the rack 10 is releasably coupled to the cab 52, the barrier 100 is disposed in opposition to the rear window 58, line of sight is provided from the cab 52, through the barrier 100, and the barrier 100 prevents oversized objects from contacting the rear window 58. The rack 10 further comprises a connecting system 130 that comprises a cab roof connecting system 132 for releasably coupling to a roof 54 of the cab 52, and a cab side connecting system 220 for releasably coupling to a side 56 of the cab 52. The barrier 100 and the connecting system 130 are co-operatively configured such that: (a) while the cab roof connecting system 132 is releasably coupled to the cab 52, the barrier 100 is releasably coupled to the roof 54 of the cab 52, (b) while the cab side connecting system 220 is releasably coupled to the cab 52, the barrier 100 is releasably coupled to the side 56 of the cab 52, and (c) the barrier 100 is disposed in opposition to the rear window 58. In some embodiments, for example, the cab roof connecting system 132 comprises a cab roof connector 134 that includes an adhesive for effecting the releasably coupling to the roof 54 of the cab 52. In some embodiments, for example, the cab side connecting system 220 comprises a first cab side connector 222 and a second cab side connector 222 that each, independently, includes an adhesive for effecting the releasably coupling to the side of the cab. In some embodiments, for example, the cab roof connector 134 comprises a connecting surface 136 for releasably coupling the cab roof connector 134 to the roof 54 of the cab 52. Similarly, the first and second cab side connectors 222 each comprise a connecting surface 224 for releasably coupling the first and second cab side connectors 222 to the cab 52. The connecting system 130 and the cab 52 are co-operatively configured such that, while the connecting surface 136 of the cab roof connector 134 is releasably coupled to the roof 54 of the cab 52, the cab roof connector 134 is releasably coupled to the roof 54 of the cab 52, and while the connecting surfaces 224 of the first and second cab side connectors 222 are releasably coupled to the side 56 of the cab 52, the first and second cab side connectors 222 are releasably coupled to the side 56 of the cab 52.

In some embodiments, for example, the connecting system 130 and the barrier 100 are of unitary one piece construction. In such embodiments, for example, the cab roof connecting system 132, which includes the cab roof connector 134, and the barrier 100 are of unitary one piece construction. In some embodiments, for example, the cab side connecting system 220, which includes the one or more cab side connectors 222, and the barrier 100 are of unitary one piece construction. In some embodiments, for example, the cab roof connecting system 132 and the cab side connecting system 220, which includes the cab roof connector 134 and the one or more cab side connectors 222, and the barrier 100 are of unitary one piece construction.

In other embodiments, for example, the connecting system 130, such as the cab roof connecting system 132 and the cab side connecting system 220, and the rack 10 are separate components that are releasably couplable together. In this regard, in some embodiments, for example, the rack 10 and the connecting system 130 are included in a kit for assembling a rack system that is configured for releasably coupling to a cab 52 of a vehicle 50, or are parts for assembling a rack system that is configured for releasably coupling to a cab 52 of a vehicle 50.

FIGS. 1 to 3 depict a kit for a rack system that is releasably couplable to a cab 52 of a vehicle 50, the cab 52 having a rear window 58. The kit comprises the rack 10 and the connecting system 130 that are releasably couplable together. The rack 10 of the kit is the rack 10 of unitary one-piece construction that is releasably couplable to the cab 52, the rack 10 comprising a barrier 100 defined by a plurality of barrier members 104, wherein the rack 10 is configured to co-operate with the cab, such that, while the rack 10 is releasably coupled to the cab 52, the barrier 100 is disposed in opposition to the rear window 58, line of sight is provided from the cab 52, through the barrier 100, and the barrier 100 prevents oversized objects from contacting the rear window 58. The connecting system 130 of the kit is configured for effecting the releasably coupling of the rack 10 to the cab 52 of the vehicle 50. The rack 10 and the connecting system 130 are co-operatively configured such that: (i) while the connecting system 130 is releasably coupled to the cab 52, and the rack 10 is releasably coupled to the connecting system 130, the barrier 100 is releasably coupled to the cab 52 and disposed in opposition to the rear window 58.

The connecting system 130 of the kit comprises a cab roof connecting system 132 for releasably coupling to a roof of the cab. The cab roof connecting system 132 includes at least one cab roof connector 134 for releasably coupling to a roof 54 of the cab 52 and for releasably coupling to the rack 10. In some embodiments, for example, each of the at least one cab roof connectors 134, independently, includes an adhesive for effecting the releasably coupling to the cab 52. The rack 10 and the connecting system 130 are co-operatively configured such that, while the cab roof connector 134 is releasably coupled to the roof 54 of the cab 52 and is releasably coupled to the rack 10, the barrier 100 is releasably coupled to the roof 54 of the cab 52 and disposed in opposition to the rear window 58.

The rack 10 is releasably couplable to the cab roof connector 134 by a cab roof connecting structure 180, as depicted in FIG. 2 and FIG. 3. The rack 10 includes a first counterpart 182 of the cab roof connecting structure 180, and the cab roof connector 134 includes a second counterpart 184 of the cab roof connecting structure 180. The releasable coupling of the rack 10 and the cab roof connector 134 is effected by an interaction between the first counterpart 182 of the cab roof connecting structure 180 and the second counterpart 184 of the cab roof connecting structure 180. In some embodiments, for example, the retention of the releasable coupling of the rack 10 and the cab roof connector 134 is effected in response to the interaction between the first counterpart 182 of the cab roof connecting structure 180 and the second counterpart 184 of the cab roof connecting structure 180. In some embodiments, for example, the rack 10 and the first counterpart 182 of the cab roof connecting structure 180 are of unitary one piece construction. In this regard, the rack 10 and the first counterpart 182 of the cab roof connecting structure 180 are manufactured, for example, by blow moulding or injection moulding, as a unitary one piece construction. In some embodiments, for example, the cab roof connector 134 and the second counterpart 184 of the cab roof connecting structure 180 are of unitary one piece construction. In this regard, the cab roof connector 134 and the second counterpart 184 of the cab roof connecting structure 180 are manufactured, for example, by blow moulding or injection moulding, as a unitary one piece construction.

The cab roof connecting structure 180 includes a retainer 186, as depicted in FIG. 1 to FIG. 5. In some embodiments, for example, the retainer 186 is a retainer pin. As depicted, the retainer 186 is a component of the cab roof connector 134. In some embodiments, for example, the retainer 186 is a component of the rack 10. In some embodiments, for example, the retainer 186 is a separate component from the cab roof connector 134 or the rack 10, and are assembled together after being separately manufactured, for example, after the cab roof connector 134, the retainer 186, and the retainer end 200 are separately manufactured, for example, by blow moulding or injection moulding.

In some embodiments, for example, the rack 10, the cab roof connector 134, the cab roof connecting structure 180, and the retainer 186 are co-operatively configured such that the releasable coupling of the rack 10 and the cab roof connector 134 is releasably retainable by the retainer 186.

The retainer 186 is displaceable between a first position, as depicted in FIG. 7, and a second position, as depicted in FIG. 8. While the retainer 186 is in the first position, retention of the releasable coupling of the rack 10 and the cab roof connector 134 by the retainer 186 is absent. While the retainer 186 is in the second position, the retainer 186 is configured to releasably retain the releasable coupling of the rack 10 and the cab roof connector 134. In this regard, while the retainer 186 is in the second position, the retainer 186 is configured to lock together the rack 10 and the cab roof connector 134.

The cab roof connecting structure 180 and the retainer 186 are co-operatively configured such that while the releasable coupling of the rack 10 and the cab roof connector 134 is effected by the interaction between the first counterpart 182 of the cab roof connecting structure 180 and the second counterpart 184 of the cab roof connecting structure 180, and while the releasable coupling of the rack 10 and the cab roof connector 134 is releasably retained by the retainer 186, release of the releasable coupling of the rack 10 and the cab roof connector 134 is resisted.

As depicted in FIG. 7 and FIG. 8, the retainer 186 is actuatable between the first position and the second position. In this regard, while the retainer 186 is in the first position, as depicted in FIG. 7, in response to actuation of the retainer 186, the retainer 186 changes from the first position to the second position, as depicted in FIG. 8. Similarly, while the retainer 186 is in the second position, as depicted in FIG. 8, in response to actuation of the retainer 186, the retainer 186 changes from the second position to the first position, as depicted in FIG. 7. In some embodiments, for example, actuation of the retainer 186 is by application of a force or pressure to the retainer 186. In some embodiments, for example, actuation of the retainer 186 is by turning or twisting the retainer 186.

In some embodiments, for example, the retainer 186 includes a quick-engage or quick-release feature for actuation of the retainer 186. In some embodiments, for example, the cab roof connecting structure 180 includes a retainer that is configured to releasably retain the releasable coupling of the rack 10 and the cab roof connector 134 via rotation of the retainer, for example, by a quarter turn. In some embodiments, for example, the actuation of said retainer is via rotation of the retainer. In some embodiments, for example, the retainer is threaded, such that the retainer is configured to releasably retain the releasable coupling of the rack 10 and the cab roof connector 134 via the threading of the retainer. In some embodiments, for example, the retainer includes a latch and pin for retaining the releasable coupling of the rack 10 and the cab roof connector 134. In some embodiments, for example, the retention of the releasable coupling of the rack 10 and the cab roof connector 134 is effected, for example, automatically, in response to the interaction between the first counterpart 182 of the cab roof connecting structure 180 and the second counterpart 184 of the cab roof connecting structure 180. In some embodiments, for example, the release of retention of the releasable coupling of the rack 10 and the cab roof connector 134 is effected in response to actuation of the cab roof connecting structure 180, for example, an application of a force on the cab roof connecting structure 180. In some embodiments, for example, the release of retention of the releasable coupling of the rack 10 and the cab roof connector 134 is effected in response to pulling the rack 10 away from the cab roof connector 134. In some embodiments, for example, the release of retention of the releasable coupling of the rack 10 and the cab roof connector 134 is effected in response to rotating or twisting the rack 10 relative to the cab roof connector 134.

In some embodiments, for example, the retainer 186 is biased to the first position. In such embodiments, such biasing of the retainer 186 in the first position provides visual indication that the retainer 186 is not releasably retaining the releasable coupling of the cab roof connector 134 and the rack 10, which may cause an operator of the vehicle 50 to direct their attention to releasably retaining the releasable coupling of the rack 10 and the cab roof connector 134.

In some embodiments, for example, the retainer 186 includes a retainer head 188, as depicted in FIG. 5, FIG. 7, and FIG. 8. The retainer head 188 defines an actuation surface 190, wherein the retainer 186 is actuatable between the first position and the second position in response to an interaction with the actuation surface 190, such as in response to a force or pressure applied to the actuation surface 190.

In some embodiments, for example, as depicted in FIGS. 1 to 5, 7, and 8, the retainer 186 is received in the cab roof connector 134. In such embodiments, for example, the cab roof connector 134 includes a surface 194, as depicted in FIGS. 2 to 5, 7, and 8, that defines a retainer aperture 192. The retainer 186 is receivable in the retainer aperture 192.

In some embodiments, for example, while the retainer 186 is in the second position, the actuation surface 190 is co-planar with the surface 194 that defines the retainer aperture 192. This may provide a visually pleasing aesthetic, wherein the actuation surface 190 is flush with the surface 194. In some embodiments, for example, as depicted in FIG. 8, while the retainer 186 is in the second position, the actuation surface 190 is offset from the surface 194 by the thickness of the retainer head 188. In some embodiments, for example, as depicted in FIG. 8, while the retainer 186 is in the second position, the retainer head 188 abuts against the surface 194 of the cab roof connector 134.

In some embodiments, for example, while the retainer 186 is in the first position, the actuation surface 190 is offset from the surface 194 by a distance greater than the thickness of the retainer head 188 to provide a visual indication that the retainer 186 is not disposed to releasably retain the releasable coupling of the rack 10 and the cab roof connector 134.

In some embodiments, for example, the surface 194 of the cab roof connector 134 is an outer side surface of the cab roof connector 134, as depicted in FIGS. 2 to 5, 7, and 8.

In some embodiments, for example, the surface 194 is a top surface of the cab roof connector 134.

In some embodiments, for example, the cab roof connecting structure 180 and the retainer 186 are co-operatively configured such that the releasable coupling of the rack 10 and the cab roof connector 134 is releasably retained upon the interaction between the first counterpart 182 of the cab roof connecting structure 180 and the second counterpart 184 of the cab roof connecting structure 180. In such embodiments, for example, the first counterpart 182 of the cab roof connecting structure 180 and the second counterpart 184 of the cab roof connecting structure 180 have a friction fit, interference fit, or snap fit relationship, and the like. In some embodiments, for example, the interaction of the first counterpart 182 of the cab roof connecting structure 180 and the second counterpart 184 of the cab roof connecting structure 180 is indicated by a click noise that is generated upon the interaction.

In some embodiments, for example, the retainer 186 is spring-loaded.

In some embodiments, for example, the retainer 186 is bearing-loaded.

In some embodiments, for example, as depicted in FIGS. 1 to 5, 7, and 8, the connecting system 130 includes the retainer 186.

In some embodiments, for example, one of the first counterpart 182 of the cab roof connecting structure 180 and the second counterpart 184 of the cab roof connecting structure 180 is a prong, and the other of the first counterpart 182 of the cab roof connecting structure 180 and the second counterpart 184 of the cab roof connecting structure 180 is a slot. As depicted in FIGS. 2, 3, 7, and 8, in some embodiments, for example, the first counterpart 182 of the cab roof connecting structure 180 includes a prong 196. As depicted in FIGS. 2, 4, 5, 7 and 8, the second counterpart 184 of the cab roof connecting structure 180 includes a slot 198. In such embodiments, for example, the releasable coupling of the rack 10 and the cab roof connector 134 is effected by insertion of the prong 196 of the first counterpart 182 of the cab roof connecting structure 180 into the slot 198 of the second counterpart 184 of the cab roof connecting structure 180. In some embodiments, for example, the releasable coupling of the rack 10 and the cab roof connector 134 is effected by rotation or twisting of one of the rack 10 and the cab roof connector 134 relative to the other of the rack 10 and the cab roof connector 134.

In some embodiments, for example, the prong 196 and the slot 198 are co-operatively configured such that, while the prong 196 is inserted into the slot 198, the slot 198 resists removal of the prong 196 from the slot 198. In some embodiments, for example, the prong 196 and the slot 198 are co-operatively configured such that, while the prong 196 is inserted into the slot 198, a surface of the prong 196, for example, the bottom surface of the prong 196, abuts against an edge of the slot 198, for example, the bottom edge of the slot 198. In such embodiments, for example, the abutting surface of the prong 196 and the edge of the slot 198 are in a gripping relationship, such that removal of the prong 196 from the slot 198 is resisted. In this regard, the releasable coupling of the rack 10 and the cab roof connector 134 is resisted by the gripping relationship of the abutting surface of the prong 196 and the edge of the slot 198.

In some embodiments, for example, the slot 198 is dimensioned relative to the prong 196 such that, while the prong 196 is inserted into the slot 198, the slot 198 resists lateral movement (e.g. movement in the left or right direction) and vertical movement (e.g. movement in the up or down direction) of the prong 196. In such embodiments, for example, the shape of the slot 198 is substantially similar to the longitudinal cross-sectional profile of the prong 196.

As depicted in FIG. 7 and FIG. 8, in some embodiments, for example, the retainer 186 includes a retainer end 200 that is disposed on an end of the retainer 186 that is opposite to the retainer head 186. In some embodiments, for example, to assemble the retainer 186 with the cab roof connector 134, the retainer 186 is first received in the retainer aperture 192, and then the retainer end 200 is connected to the end of the retainer 186 to secure the retainer 186 in the retainer aperture 192. In some embodiments, for example, as depicted in FIG. 3, FIG. 7, and FIG. 8, the prong 196 of the first counterpart 182 of the cab roof connecting structure 180 defines an aperture 202. In some embodiments, for example the aperture 202 is a passage that extends through the prong 196, the aperture 202 extending perpendicular to the longitudinal axis of the prong 196. In some embodiments, for example, the aperture 202 extends laterally through the prong 196. In some embodiments, for example, the aperture 202 extends vertically through the prong 196. In such embodiments, for example, the cab roof connecting structure 180 and the retainer 186 are co-operatively configured such that while the prong 196 of the first counterpart 182 of the cab roof connecting structure 180 is inserted into the slot 198 of the second counterpart 184 of the cab roof connecting structure 180 such that the releasable coupling of the rack 10 and the cab roof connector 134 is effected, and the retainer 186 is in the first position, as depicted in FIG. 7, upon displacement of the retainer 186 from the first position to the second position, as depicted in FIG. 8, the retainer end 200 is received in the aperture 202 of the prong 196 to releasably retain the releasable coupling of the rack 10 and the cab roof connector 134, such that release of the releasable coupling of the rack 10 and the cab roof connector 134 is resisted.

The aperture 202 is configured such that the retainer end 200 is receivable in the aperture 202 while the rack 10 and the cab roof connector 134 are releasably coupled, for example, while the prong 196 of the first counterpart 182 of the cab roof connecting structure 180 is inserted into the slot 198 of the second counterpart 184 of the cab roof connecting structure 180. While the rack 10 and the cab roof connector 134 are releasably coupled, and while the retainer end 200 is received in the aperture 202 defined by the prong 196, the retainer end 200 and the aperture 202 are co-operatively configured to resist the release of the releasable coupling of the rack 10 and the cab roof connector 134. In this regard, while a force is applied, for example, to the rack 10, to release the releasable coupling of the rack 10 and the cab roof connector 134, the prong 196 abuts against the retainer end 200 to resist the release of the releasable coupling of the rack 10 and the cab roof connector 134.

In some embodiments, for example, the rack 10, the cab roof connector 134, the cab roof connecting structure 180, and the retainer 186 are co-operatively configured such that upon alignment of the retainer aperture 192 and the aperture 202 of the prong 196, the releasable coupling of the rack 10 and the cab roof connector 134 is releasably retainable by the retainer 186. In some embodiments, for example, while the rack 10 and the cab roof connector 134 are releasably coupled, and upon alignment of the retainer aperture 192 and the aperture 202 of the prong 196, the retainer 186 is insertable into the aperture 202 of the prong 196 such that the releasable coupling of the rack 10 and the cab roof connector 134 is releasably retained, or that release of the releasable coupling of the rack 10 and the cab roof connector 134 is resisted.

In some embodiments, for example, the rack 10, the cab roof connector 134, the cab roof connecting structure 180, and the retainer 186 are co-operatively configured such that upon alignment of the retainer 186, for example, the retainer end 188, and the aperture 202 of the prong 196, the releasable coupling of the rack 10 and the cab roof connector 134 is releasably retainable by the retainer 186. In some embodiments, for example, while the rack 10 and the cab roof connector 134 are releasably coupled, and upon alignment of the retainer 186, for example, the retainer end 188, and the aperture 202 of the prong 196, the retainer 186 is insertable into the aperture 202 of the prong 196 such that the releasable coupling of the rack 10 and the cab roof connector 134 is releasably retained, or that release of the releasable coupling of the rack 10 and the cab roof connector 134 is resisted.

In some embodiments, for example, the cab roof connector 134 defines a passage through which the retainer 186 displaces. In some embodiments, for example, the passage is configured for receiving the retainer 186, and the retainer 186 is configured to be receivable in the passage. In some embodiments, for example, the passage guides or directs the displacement of the retainer 186, such that the retainer 186 displaces along the longitudinal axis of the passage. In some embodiments, for example, the rack 10, the cab roof connector 134, the cab roof connecting structure 180, and the retainer 186 are co-operatively configured such that upon alignment of said passage defined by the cab roof connector 134 and the aperture 202 of the prong 196, the releasable coupling of the rack 10 and the cab roof connector 134 is releasably retainable by the retainer 186. In some embodiments, for example, while the rack 10 and the cab roof connector 134 are releasably coupled, and upon alignment of said passage defined by the cab roof connector 134 and the aperture 202 of the prong 196, the retainer 186 is insertable into the aperture 202 of the prong 196 such that the releasable coupling of the rack 10 and the cab roof connector 134 is releasably retained, or that release of the releasable coupling of the rack 10 and the cab roof connector 134 is resisted.

As depicted in FIGS. 1 to 5, in some embodiments, for example, the rack 10 is releasably couplable to the cab roof connector 134 by a first cab roof connecting structure 180 and a second cab roof connecting structure 180. As depicted in FIGS. 2 and 3, the rack 10 includes a first counterpart 182 of the first cab roof connecting structure 180 and a first counterpart 182 of the second cab roof connecting structure 180. As depicted, in some embodiments, for example, while the rack 10 is in the operative orientation, the first counterpart 182 of the first cab roof connecting structure 180 and the first counterpart 182 of the second cab roof connecting structure 180 are disposed in the upper left and upper right sections of the rack 10. As depicted, in some embodiments, for example, while the rack 10 is in the operative orientation, the first counterpart 182 of the first cab roof connecting structure 180 and the first counterpart 182 of the second cab roof connecting structure 180 are facing in a forward direction, towards the front of the cab 52.

As depicted in FIGS. 2 to 5, the cab roof connector 134 includes a second counterpart 184 of the first cab roof connecting structure 180, and a second counterpart 184 of the second cab roof connecting structure 180. As depicted, the second counterpart 184 of the first cab roof connecting structure 180, and the second counterpart 184 of the second cab roof connecting structure 180 are disposed on opposite ends 138 and 140 of the cab roof connector 134. As depicted, while the cab roof connector 134 is releasably coupled to the roof 54 of the cab 52, the second counterpart 184 of the first cab roof connecting structure 180 and a second counterpart 184 of the second cab roof connecting structure 180 are facing in a rearward direction, towards the truck bed 60.

In such embodiments, for example, the releasable coupling of the rack 10 and the cab roof connector 134 is effected by an interaction between the first counterpart 182 of the first cab roof connecting structure 180 and the second counterpart 184 of the first cab roof connecting structure 180, and an interaction between the first counterpart 182 of the second cab roof connecting structure 180 and the second counterpart 184 of the second cab roof connecting structure 180.

In some embodiments, for example, one of the first counterpart 182 of the first cab roof connecting structure 180 and the second counterpart 184 of the first cab roof connecting structure 180 is a prong, and the other of the first counterpart 182 of the first cab roof connecting structure 180 and the second counterpart 184 of the first cab roof connecting structure 180 is a slot. In some embodiments, for example, one of the first counterpart 182 of the second cab roof connecting structure 180 and the second counterpart 184 of the second cab roof connecting structure 180 is a prong, and the other of the first counterpart 182 of the second cab roof connecting structure 180 and the second counterpart 184 of the second cab roof connecting structure 180 is a slot. As depicted in FIGS. 2, 3, 7, and 8, in some embodiments, for example, the first counterpart 182 of the first cab roof connecting structure 180 includes a prong 196, and the first counterpart 182 of the second cab roof connecting structure 180 includes a prong 196. As depicted in FIGS. 2, 4, 5, 7 and 8, the second counterpart 184 of the first cab roof connecting structure 180 includes a slot 198, and the second counterpart 184 of the second cab roof connecting structure 180 includes a slot 198. In such embodiments, for example, the releasable coupling of the rack 10 and the cab roof connector 134 is effected by: (1) insertion of the prong 196 of the first counterpart 182 of the first cab roof connecting structure 180 into the slot 198 of the second counterpart 184 of the first cab roof connecting structure 180, and (2) insertion of the prong 196 of the first counterpart 182 of the second cab roof connecting structure 180 into the slot 198 of the second counterpart 184 of the second cab roof connecting structure 180.

In some embodiments, for example, the first cab roof connecting structure 180 includes a first retainer 186, and the second cab roof connecting structure 180 includes a second retainer 186, as depicted in FIG. 1 to FIG. 5. In some embodiments, for example, the first and second retainers 186 are retainer pins. As depicted, the first and second retainers 186 are a component of the cab roof connector 134. In some embodiments, for example, the first and second retainers 186 are a component of the rack 10. In some embodiments, for example, the first and second retainers 186 are separate components from the cab roof connector 134 or the rack 10, and are assembled together after being separately manufactured, for example, after the cab roof connector 134, the first and second retainers 186, and the retainer ends 200 are separately manufactured, for example, by blow moulding or injection moulding.

In some embodiments, for example, the rack 10, the cab roof connector 134, the cab roof connecting structure 180, the first retainer 186, and the second retainer 186 are co-operatively configured such that the releasable coupling of the rack 10 and the cab roof connector 134 is releasably retainable by the first retainer 186 and the second retainer 186.

In some embodiments, for example, the cab roof connecting system 132 of the kit includes a first cab roof connector 134 and a second cab roof connector 134 for releasably coupling the rack 10 to a roof 54 of the cab 52 and for releasably coupling to the rack 10. The barrier 100 and the connecting system 130 are co-operatively configured such that, while the first and second cab roof connectors 134 are releasably coupled to the roof 54 of the cab 52 and are releasably coupled to the rack 10, the barrier 100 is releasably coupled to the roof 54 of the cab 52 and disposed in opposition to the rear window 58. In some embodiments, each one of the first and second cab roof connectors 134, independently, includes an adhesive for effecting the releasably coupling to the roof 54 of the cab 52.

In some embodiments, for example, the connecting system 130 of the kit comprises a cab side connecting system 220, and the cab side connecting system 220 includes at least one cab side connector 222 for releasably coupling to a side 56 of the cab 52 and for releasably coupling to the rack 10. In some embodiments, for example, each of the at least one cab side connectors 222, independently, includes an adhesive for effecting the releasably coupling to the cab 52. The rack 10 and the connecting system 130 are co-operatively configured such that, while the cab side connector 222 is releasably coupled to the side 56 of the cab 52 and is releasably coupled to the rack 10, the barrier 100 is releasably coupled to the side 56 of the cab 52 and disposed in opposition to the rear window 58.

The rack 10 is releasably couplable to the cab side connector 222 by a cab side connecting structure 230, as depicted in FIG. 2 and FIG. 3. The rack 10 includes a first counterpart 232 of the cab side connecting structure 230, and the cab side connector 222 includes a second counterpart 234 of the cab side connecting structure 230. The releasable coupling of the rack 10 and the cab side connector 222 is effected by an interaction between the first counterpart 232 of the cab side connecting structure 230 and the second counterpart 234 of the cab side connecting structure 230. In some embodiments, for example, the rack 10 and the first counterpart 232 of the cab side connecting structure 230 are of unitary one piece construction. In this regard, the rack 10 and the first counterpart 232 of the cab side connecting structure 230 are manufactured, for example, by blow moulding or injection moulding, as a unitary one piece construction. In some embodiments, for example, the cab side connector 222 and the second counterpart 234 of the cab side connecting structure 230 are of unitary one piece construction. In this regard, the cab side connector 222 and the second counterpart 234 of the cab side connecting structure 230 are manufactured, for example, by blow moulding or injection moulding, as a unitary one piece construction.

The cab side connecting structure 230 includes a retainer 236, as depicted in FIG. 1 to FIG. 4 and FIG. 6. In some embodiments, for example, the retainer 236 is a retainer pin. As depicted, the retainer 236 is a component of the cab side connector 222. In some embodiments, for example, the retainer 236 is a component of the rack 10. In some embodiments, for example, the retainer 236 is a separate component from the cab side connector 222 or the rack 10, and are assembled together after being separately manufactured, for example, after the cab side connector 222, the retainer 236, and the retainer end 250 are separately manufactured, for example, by blow moulding or injection moulding.

In some embodiments, for example, the rack 10, the cab side connector 222, the cab side connecting structure 230, and the retainer 236 are co-operatively configured such that the releasable coupling of the rack 10 and the cab side connector 222 is releasably retainable by the retainer 236.

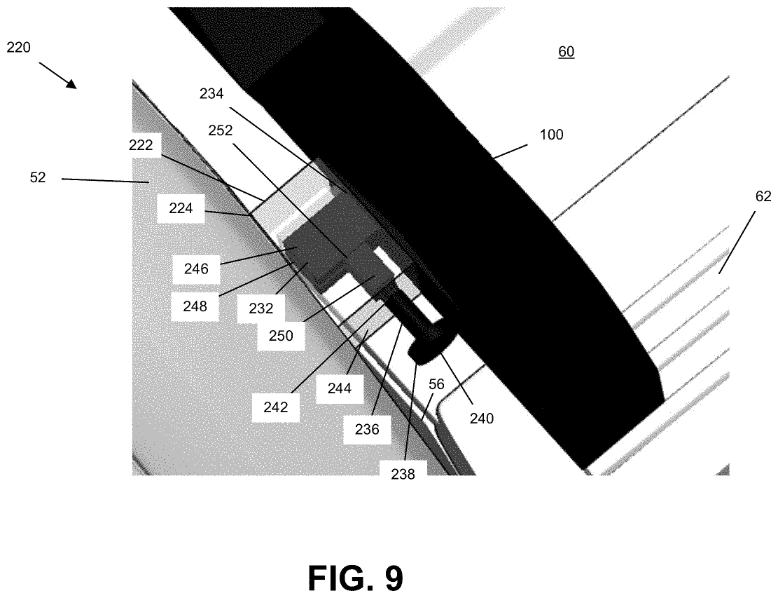

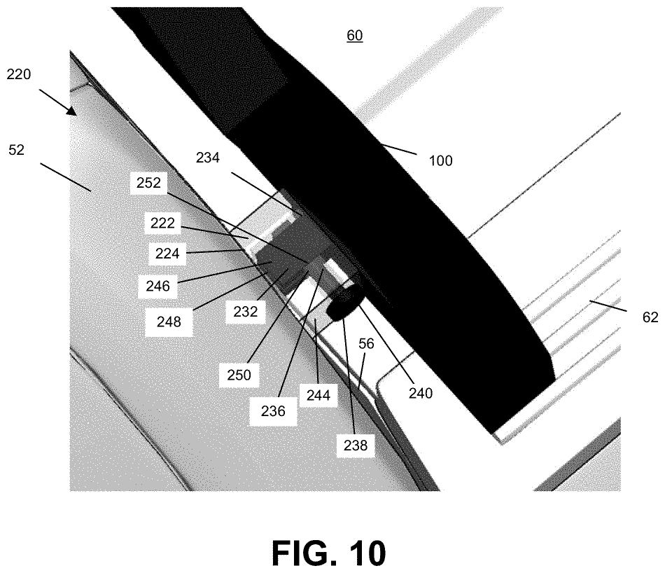

The retainer 236 is displaceable between a first position, as depicted in FIG. 9, and a second position, as depicted in FIG. 10. While the retainer 236 is in the first position, retention of the releasable coupling of the rack 10 and the cab side connector 222 by the retainer 236 is absent. While the retainer 236 is in the second position, the retainer 236 is configured to releasably retain the releasable coupling of the rack 10 and the cab side connector 222. In this regard, while the retainer 236 is in the second position, the retainer 236 is configured to lock together the rack 10 and the cab side connector 222.

The cab side connecting structure 230 and the retainer 236 are co-operatively configured such that while the releasable coupling of the rack 10 and the cab side connector 222 is effected by the interaction between the first counterpart 232 of the cab side connecting structure 230 and the second counterpart 234 of the cab roof connecting structure 230, and while the releasable coupling of the rack 10 and the cab side connector 222 is releasably retained by the retainer 236, release of the releasable coupling of the rack 10 and the cab side connector 222 is resisted.

As depicted in FIG. 9 and FIG. 10, the retainer 236 is actuatable between the first position and the second position. In this regard, while the retainer 236 is in the first position, as depicted in FIG. 9, in response to actuation of the retainer 236, the retainer 236 changes from the first position to the second position, as depicted in FIG. 10. Similarly, while the retainer 236 is in the second position, as depicted in FIG. 10, in response to actuation of the retainer 236, the retainer 236 changes from the second position to the first position, as depicted in FIG. 9. In some embodiments, for example, actuation of the retainer 236 is by application of a force or pressure to the retainer 236. In some embodiments, for example, actuation of the retainer 236 is by turning or twisting the retainer 236.

In some embodiments, for example, the retainer 236 includes a quick-engage or quick-release feature for actuation of the retainer 236. In some embodiments, for example, the cab side connecting structure 230 includes a retainer that is configured to releasably retain the releasable coupling of the rack 10 and the cab side connector 222 via rotation of the retainer, for example, by a quarter turn. In some embodiments, for example, the actuation of said retainer is via rotation of the retainer. In some embodiments, for example, the retainer is threaded, such that the retainer is configured to releasably retain the releasable coupling of the rack 10 and the cab side connector 222 via the threading of the retainer. In some embodiments, for example, the retainer includes a latch and pin for releasably retaining the releasable coupling of the rack 10 and the cab side connector 222. In some embodiments, for example, the retention of the releasable coupling of the rack 10 and cab side connector 222 is effected, for example, automatically, in response to the interaction between the first counterpart 232 of the cab side connecting structure 230 the second counterpart 234 of the cab side connecting structure 230. In some embodiments, for example, the release of retention of the releasable coupling of the rack 10 and the cab side connector 222 is effected in response to actuation of the cab side connecting structure 230, for example, an application of a force on the cab side connecting structure 230. In some embodiments, for example, the release of retention of the releasable coupling of the rack 10 and the cab side connector 222 is effected in response to pulling the rack 10 away from the cab side connector 222. In some embodiments, for example, the release of retention of the releasable coupling of the rack 10 and the cab side connector 222 is effected in response to rotating or twisting the rack 10 relative to the cab side connector 222.

In some embodiments, for example, the retainer 236 is biased to the first position. In such embodiments, such biasing of the retainer 236 in the first position provides visual indication that the retainer 236 is not releasably retaining the releasable coupling of the cab side connector 222 and the rack 10, which may cause an operator of the vehicle 50 to direct their attention to releasably retaining the releasable coupling of the rack 10 and the cab side connector 222.

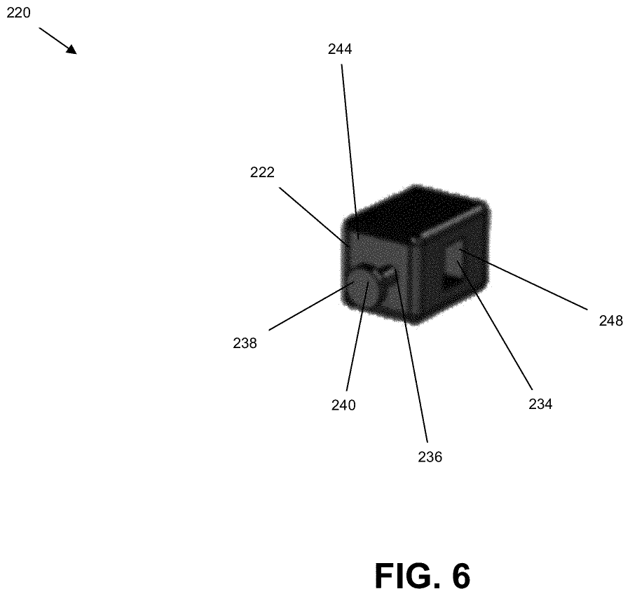

In some embodiments, for example, the retainer 236 includes a retainer head 238, as depicted in FIG. 6, FIG. 9, and FIG. 10. The retainer head 238 defines an actuation surface 240, wherein the retainer 236 is actuatable between the first position and the second position in response to an interaction with the actuation surface 240, such as in response to a force or pressure applied to the actuation surface 240.

In some embodiments, for example, as depicted in FIGS. 1 to 4, 6, 9, 10, and 36, the retainer 236 is received in the cab side connector 222. In such embodiments, for example, the cab side connector 222 includes a surface 244, as depicted in FIGS. 2 to 4, 6, 9, 10, and 36 that defines a retainer aperture 242. The retainer 236 is receivable in the retainer aperture 242.

In some embodiments, for example, while the retainer 236 is in the second position, the actuation surface 240 is co-planar with the surface 244 that defines the retainer aperture 242. This may provide a visually pleasing aesthetic, wherein the actuation surface 240 is flush with the surface 244. In some embodiments, for example, as depicted in FIG. 10, while the retainer 236 is in the second position, the actuation surface 240 is offset from the surface 244 by the thickness of the retainer head 238. In some embodiments, for example, as depicted in FIG. 10, while the retainer 236 is in the second position, the retainer head 238 abuts against the surface 244 of the cab side connector 222.

In some embodiments, for example, while the retainer 238 is in the first position, the actuation surface 240 is offset from the surface 244 by a distance greater than the thickness of the retainer head 238 to provide a visual indication that the retainer 236 is not disposed to releasably retain the releasable coupling of the rack 10 and the cab side connector 222.

In some embodiments, for example, the surface 244 of the cab side connector 222 is an outer side surface of the cab side connector 222, as depicted in FIGS. 2 to 4, 6, 9, and 10.

In some embodiments, for example, the surface 244 is a top surface of the cab side connector 222.

In some embodiments, for example, the surface 244 is a bottom surface of the cab side connector 222.

In some embodiments, for example, the cab side connecting structure 230 and the retainer 236 are co-operatively configured such that the releasable coupling of the rack 10 and the cab side connector 222 is releasably retained upon the interaction between the first counterpart 232 of the cab side connecting structure 230 and the second counterpart 234 of the cab side connecting structure 230. In such embodiments, for example, the first counterpart 232 of the cab side connecting structure 230 and the second counterpart 234 of the cab side connecting structure 230 have a friction fit, interference fit, or snap fit relationship, and the like. In some embodiments, for example, the interaction of the first counterpart 232 of the cab side connecting structure 230 and the second counterpart 234 of the cab side connecting structure 230 is indicated by a click noise that is generated upon the interaction.

In some embodiments, for example, the retainer 236 is spring-loaded.

In some embodiments, for example, the retainer 236 is bearing-loaded.

In some embodiments, for example, as depicted in FIGS. 1 to 4, 6, 9, and 10, the connecting system 130 includes the retainer 236.

In some embodiments, for example, one of the first counterpart 232 of the cab side connecting structure 230 and the second counterpart 234 of the cab side connecting structure 230 is a prong, and the other of the first counterpart 232 of the cab roof connecting structure 230 and the second counterpart 234 of the cab roof connecting structure 230 is a slot. As depicted in FIGS. 2, 3, 9, and 10, in some embodiments, for example, the first counterpart 232 of the cab side connecting structure 230 includes a prong 246. As depicted in FIGS. 2, 4, 6, 9 and 10, the second counterpart 234 of the cab side connecting structure 230 includes a slot 248. In such embodiments, for example, the releasable coupling of the rack 10 and the cab side connector 222 is effected by insertion of the prong 246 of the first counterpart 232 of the cab side connecting structure 230 into the slot 248 of the second counterpart 234 of the cab side connecting structure 230. In some embodiments, for example, the releasable coupling of the rack 10 and the cab side connector 222 is effected by rotation or twisting of one of the rack 10 and the cab side connector 222 relative to the other of the rack 10 and the cab side connector 222.

In some embodiments, for example, the prong 246 and the slot 248 are co-operatively configured such that, while the prong 246 is inserted into the slot 248, the slot 248 resists removal of the prong 246 from the slot 248. In some embodiments, for example, the prong 246 and the slot 248 are co-operatively configured such that, while the prong 246 is inserted into the slot 248, a surface of the prong 246, for example, the bottom surface of the prong 246, abuts against an edge of the slot 248, for example, the bottom edge of the slot 248. In such embodiments, for example, the abutting surface of the prong 246 and the edge of the slot 248 are in a gripping relationship, such that removal of the prong 246 from the slot 248 is resisted. In this regard, the releasable coupling of the rack 10 and the cab side connector 222 is resisted by the gripping relationship of the abutting surface of the prong 246 and the edge of the slot 248.

In some embodiments, for example, the slot 248 is dimensioned relative to the prong 246 such that, while the prong 246 is inserted into the slot 248, the slot 248 resists lateral movement (e.g. movement in the left or right direction) and vertical movement (e.g. movement in the up or down direction) of the prong 246. In such embodiments, for example, the shape of the slot 248 is substantially similar to the longitudinal cross-sectional profile of the prong 246.

As depicted in FIG. 9 and FIG. 10, in some embodiments, for example, the retainer 236 includes a retainer end 250 that is disposed on an end of the retainer 236 that is opposite to the retainer head 238. In some embodiments, for example, to assemble the retainer 236 with the cab side connector 222, the retainer 236 is first received in the retainer aperture 242, and then the retainer end 250 is connected to the end of the retainer 236 to secure the retainer 236 in the retainer aperture 242. In some embodiments, for example, as depicted in FIG. 3, FIG. 9, and FIG. 10, the prong 246 of the first counterpart 232 of the cab side connecting structure 230 defines an aperture 252. In some embodiments, for example the aperture 252 is a passage that extends through the prong 246, the aperture 252 extending perpendicular to the longitudinal axis of the prong 246. In some embodiments, for example, the aperture 252 extends laterally through the prong 246. In some embodiments, for example, the aperture 252 extends vertically through the prong 246. In such embodiments, for example, the cab side connecting structure 230 and the retainer 236 are co-operatively configured such that while the prong 246 of the first counterpart 232 of the cab side connecting structure 230 is inserted into the slot 248 of the second counterpart 234 of the cab side connecting structure 230 such that the releasable coupling of the rack 10 and the cab side connector 222 is effected, and the retainer 236 is in the first position, upon displacement of the retainer 236 from the first position to the second position, as depicted in FIG. 9, and FIG. 10, the retainer end 250 is received in the aperture 252 of the prong 246 to releasably retain the releasable coupling of the rack 10 and the cab side connector 222, such that release of the releasable coupling of the rack 10 and the cab side connector 222 is resisted.

The aperture 252 is configured such that the retainer end 250 is receivable in the aperture 252 while the rack 10 and the cab side connector 222 are releasably coupled, for example, while the prong 246 of the first counterpart 232 of the cab side connecting structure 230 is inserted into the slot 248 of the second counterpart 234 of the cab side connecting structure 230. While the rack 10 and the cab side connector 222 are releasably coupled, and while the retainer end 250 is received in the aperture 252 defined by the prong 246, the retainer end 250 and the aperture 252 are co-operatively configured to resist the release of the releasable coupling of the rack 10 and the cab side connector 222. In this regard, while a force is applied, for example, to the rack 10, to release the releasable coupling of the rack 10 and the cab side connector 222, the prong 246 abuts against the retainer end 250 to resist the release of the releasable coupling of the rack 10 and the cab side connector 222.

In some embodiments, for example, the rack 10, the cab side connector 222, the cab side connecting structure 230, and the retainer 236 are co-operatively configured such that upon alignment of the retainer aperture 242 and the aperture 252 of the prong 246, the releasable coupling of the rack 10 and the cab side connector 222 is releasably retainable by the retainer 236. In some embodiments, for example, while the rack 10 and the cab side connector 222 are releasably coupled, and upon alignment of the retainer aperture 242 and the aperture 252 of the prong 246, the retainer 236 is insertable into the aperture 252 of the prong 246 such that the releasable coupling of the rack 10 and the cab side connector 222 is releasably retained, or that release of the releasable coupling of the rack 10 and the cab side connector 222 is resisted.

In some embodiments, for example, the rack 10, the cab side connector 222, the cab side connecting structure 230, and the retainer 236 are co-operatively configured such that upon alignment of the retainer 236, for example, the retainer end 250, and the aperture 252 of the prong 246, the releasable coupling of the rack 10 and the cab side connector 222 is releasably retainable by the retainer 236. In some embodiments, for example, while the rack 10 and the cab side connector 222 are releasably coupled, and upon alignment of the retainer 236, for example, the retainer end 250, and the aperture 252 of the prong 246, the retainer 236 is insertable into the aperture 252 of the prong 246 such that the releasable coupling of the rack 10 and the cab side connector 222 is releasably retained, or that release of the releasable coupling of the rack 10 and the cab side connector 222 is resisted.

In some embodiments, for example, the cab side connector 222 defines a passage through which the retainer 236 displaces. In some embodiments, for example, the passage is configured for receiving the retainer 236, and the retainer 236 is configured to be receivable in the passage. In some embodiments, for example, the passage guides or directs the displacement of the retainer 236, such that the retainer 236 displaces along the longitudinal axis of the passage. In some embodiments, for example, the rack 10, the cab side connector 222, the cab side connecting structure 230, and the retainer 236 are co-operatively configured such that upon alignment of said passage defined by the cab side connector 222 and the aperture 252 of the prong 246, the releasable coupling of the rack 10 and the cab side connector 222 is releasably retainable by the retainer 236. In some embodiments, for example, while the rack 10 and the cab side connector 222 are releasably coupled, and upon alignment of said passage defined by the cab side connector 222 and the aperture 252 of the prong 246, the retainer 236 is insertable into the aperture 252 of the prong 246 such that the releasable coupling of the rack 10 and the cab side connector 222 is releasably retained, or that release of the releasable coupling of the rack 10 and the cab side connector 222 is resisted.

As depicted in FIGS. 1 to 4 and 6, in some embodiments, for example, the cab side connecting system 220 includes a first cab side connector 222 and a second cab side connector 222 for releasably coupling the rack 10 to the side 56 of the cab 52. In this regard, the rack 10 is releasably couplable to the first cab side connector 222 by a first cab side connecting structure 230, and the rack 10 is releasably couplable to the second cab side connector 222 by a second cab side connecting structure 230. As depicted in FIGS. 2 and 3, the rack 10 includes a first counterpart 232 of the first cab side connecting structure 230 and a first counterpart 232 of the second cab side connecting structure 230. As depicted, in some embodiments, for example, while the rack 10 is in the operative orientation, the first counterpart 232 of the first cab side connecting structure 230 and the first counterpart 232 of the second cab side connecting structure 230 are disposed in the bottom left and bottom right sections of the rack 10. As depicted, in some embodiments, for example, while the rack 10 is in the operative orientation, the first counterpart 232 of the first cab side connecting structure 230 and the first counterpart 232 of the second cab side connecting structure 230 are facing in a forward direction, towards the front of the cab 52.

As depicted in FIGS. 2 to 4 and 6, the first cab side connector 222 includes a second counterpart 234 of the first cab side connecting structure 230, and the second cab side connector 222 includes a second counterpart 234 of the second cab side connecting structure 230. As depicted, the first cab side connector 222 and the second cab side connector 222 are releasably coupled to the bottom left and the bottom right sections of the side 56 of the cab 52. As depicted, while the first and second cab side connectors 222 are releasably coupled to the side 56 of the cab 52, the second counterpart 234 of the first cab side connecting structure 230 and the second counterpart 234 of the second cab side connecting structure 230 are facing in a rearward direction, towards the truck bed 60.

In such embodiments, for example, the releasable coupling of the rack 10 and the first cab side connector 222 and the second cab side connector 222 is effected by an interaction between the first counterpart 232 of the first cab side connecting structure 230 and the second counterpart 234 of the first cab side connecting structure 230, and an interaction between the first counterpart 232 of the second cab side connecting structure 230 and the second counterpart 234 of the second cab side connecting structure 230.

In some embodiments, for example, one of the first counterpart 232 of the first cab side connecting structure 230 and the second counterpart 234 of the first cab side connecting structure 230 is a prong, and the other of the first counterpart 232 of the first cab side connecting structure 230 and the second counterpart 234 of the first cab side connecting structure 230 is a slot. In some embodiments, for example, one of the first counterpart 232 of the second cab side connecting structure 230 and the second counterpart 234 of the second cab side connecting structure 230 is a prong, and the other of the first counterpart 232 of the second cab side connecting structure 230 and the second counterpart 234 of the second cab side connecting structure 230 is a slot. As depicted in FIGS. 2, 3, 7, and 8, in some embodiments, for example, the first counterpart 232 of the first cab side connecting structure 230 includes a prong 246, and the first counterpart 232 of the second cab side connecting structure 230 includes a prong 246. As depicted in FIGS. 2, 4, 5, 7 and 8, the second counterpart 234 of the first cab side connecting structure 230 includes a slot 248, and the second counterpart 234 of the second cab side connecting structure 230 includes a slot 248. In such embodiments, for example, the releasable coupling of the rack 10 and the cab side connectors 222 is effected by: (1) insertion of the prong 246 of the first counterpart 232 of the first cab side connecting structure 230 into the slot 248 of the second counterpart 234 of the first cab side connecting structure 230, and (2) insertion of the prong 246 of the first counterpart 232 of the second cab side connecting structure 230 into the slot 248 of the second counterpart 234 of the second cab side connecting structure 230.

In some embodiments, for example, the first cab side connecting structure 230 includes a first retainer 236, and the second cab side connecting structure 230 includes a second retainer 236, as depicted in FIG. 1 to FIG. 4. In some embodiments, for example, the first and second retainers 236 are retainer pins. As depicted, the first and second retainers 236 are a component of the cab side connectors 222. In some embodiments, for example, the first and second retainers 236 are a component of the rack 10. In some embodiments, for example, the first and second retainers 236 are separate components from the cab side connectors 222 or the rack 10, and are assembled together after being separately manufactured, for example, after the cab side connectors 222, the first and second retainers 236, and the retainer ends 250 are separately manufactured, for example, by blow moulding or injection moulding.

In some embodiments, for example, the rack 10, the cab side connectors 222, the cab side connecting structures 230, the first retainer 236, and the second retainer 236 are co-operatively configured such that the releasable coupling of the rack 10 and the cab side connectors 222 are releasably retainable by the first retainer 236 and the second retainer 236.

In some embodiments, for example, FIG. 5 depicts a cab roof connector 134 that is configured for releasably coupling to a roof 54 of a cab 52 of a vehicle 50 and for releasably coupling to a load 90. The cab roof connector 134 is co-operable with the vehicle 50 and the load 90, such that while the cab roof connector 134 is releasably coupled to the roof 54 of the cab 52 and is releasably coupled to the load 90, the load 90 hangs below, and rearward of, the roof 54 of the cab 52. In some embodiments, for example, the cab roof connector 134 comprises an adhesive for effecting the releasably coupling to the roof 54 of the cab 52. In some embodiments, for example, the cab roof connector 134 spans or extends along the width of the cab 52. In some embodiments, for example, the load 90 is the rack 10, or other example loads 90 as described herein.

In some embodiments, for example, FIG. 5 depicts an embodiment of a cab roof connecting system 132 that is configured for releasably coupling to a roof 54 of a cab 52 and for releasably coupling to a load 90. The cab roof connecting system 132 comprises a slot 198, wherein releasable coupling of the load 90 and the cab roof connecting system 132 is effected by insertion of a prong of the load 90 into the slot 198. The cab roof connecting system 132 further comprises a retainer 186, wherein the load, the cab roof connecting system 132, and the retainer 186 are co-operatively configured such that the releasably coupling of the load and the cab roof connecting system 186 is releasably retainable by the retainer 186. In some embodiments, for example, the cab roof connecting system 132 comprises an adhesive for effecting the releasably coupling to the roof 54 of the cab 52. In some embodiments, for example, the cab roof connecting system 132 spans or extends along the width of the cab 52. In some embodiments, for example, the load 90 is the rack 10, or other example loads 90 as described herein.

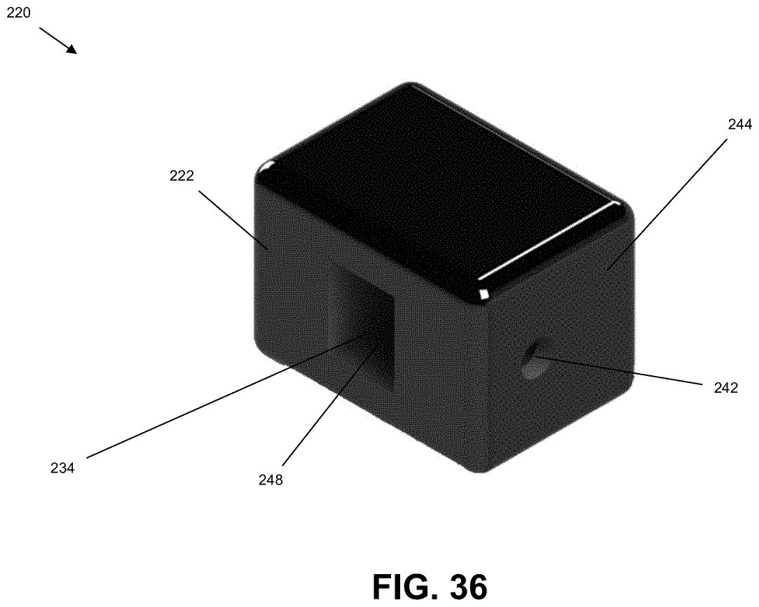

In some embodiments, for example, FIG. 6 and FIG. 36 depict a cab side connector 222 that is configured for releasably coupling to a side 56 of a cab 52 of a vehicle 50 and for releasably coupling to a load 90, and is co-operable with the vehicle 50 and the load 90, such that while the cab side connector 222 is releasably coupled to the side 56 of the cab 52 and is releasably coupled to the load 90, the load 90 is releasably coupled to the side 56 of the cab 52. In some embodiments, for example, the cab side connector 222 comprises an adhesive for effecting the releasably coupling to the side 56 of the cab 52. In some embodiments, for example, the load 90 is the rack 10, or other example loads 90 as described herein.

In some embodiments, for example, FIG. 6 and FIG. 36 depict a cab side connecting system 220 that is configured for releasably coupling to a side 56 of a cab 52 and for releasably coupling to a load 90. The cab side connecting system 220 comprises a slot 248, wherein releasable coupling of the load 90 and the cab side connecting system 220 is effected by insertion of a prong of the load 90 into the slot 248. The cab side connecting system 220, further comprises a retainer 236, wherein the load, the cab side connecting system 220, and the retainer 236 are co-operatively configured such that the releasable coupling of the load and the cab side connecting system 220 is releasably retainable by the retainer 236. In some embodiments, for example, the cab side connecting system 220 comprises an adhesive for effecting the releasably coupling to the side 56 of the cab 52. In some embodiments, for example, the load 90 is the rack 10, or other example loads 90 as described herein.

In some embodiments, for example, FIG. 4 depicts a connecting system 130 that is configured for releasably coupling to a cab 52 of a vehicle 50 and for releasably coupling to a load 90, the cab 52 having a roof 54 and a side 56. The connecting system 130 comprises a cab roof connector 134 that is configured for releasably coupling to the roof 54 of the cab 52 and for releasably coupling to the load 90, and is co-operable with the vehicle 50 and the load 90, such that while the cab roof connector 134 is releasably coupled to the roof 54 of the cab 52 and is releasably coupled to the load 90, the load 90 hangs below, and rearward of, the roof 54 of the cab 52. The connecting system 130 further comprises a cab side connector 222, that is configured for releasably coupling to the side 56 of the cab 52 and for releasably coupling to the load 90, and is co-operable with the vehicle 50 and the load 90, such that while the cab side connector 222 is releasably coupled to the side 56 of the cab 52 and is releasably coupled to the load 90, the load 90 is releasably coupled to the side 56 of the cab 90. In some embodiments, for example, the cab roof connector 134 comprises an adhesive for effecting the releasably coupling to the roof 54 of the cab 52. In some embodiments, for example, the cab roof connector 134 spans or extends along the width of the cab 52. In some embodiments, for example, the cab side connector 222 comprises an adhesive for effecting the releasably coupling to the side 56 of the cab 52. In some embodiments, for example, the load 90 is the rack 10, or other example loads 90 as described herein.

In some embodiments, for example, FIG. 4 depicts a connecting system 130 that is configured for releasably coupling to a cab 52 and is for releasably coupling to a load 90, the cab 52 having a roof 54 and a side 56. The connecting system 130 comprises a cab roof connecting system 132 and a cab side connecting system 220. The cab roof connecting system 132 is configured for releasably coupling to the roof 54 of the cab 52 and for releasably coupling to the load 90. The cab roof connecting system 132 comprises a slot 198, wherein releasable coupling of the load 90 and the cab roof connecting system 132 is effected by insertion of a prong of the load 90 into the slot 198. The cab roof connecting system 132 further comprises a retainer 186, wherein the load, the cab roof connecting system 132, and the retainer 186 are co-operatively configured such that the releasably coupling of the load and the cab roof connecting system 186 is releasably retainable by the retainer 186. The cab side connecting system 220 is configured for releasably coupling to the side 56 of the cab 52 and for releasably coupling to the load 90. The cab side connecting system 220 comprises a slot 248, wherein releasable coupling of the load 90 and the cab side connecting system 220 is effected by insertion of a prong of the load 90 into the slot 248. The cab side connecting system 220 further comprises a retainer 236, wherein the load, the cab side connecting system 220, and the retainer 236 are co-operatively configured such that the releasable coupling of the load and the cab side connecting system 220 is releasably retainable by the retainer 236. In some embodiments, for example, the cab roof connecting system 132 comprises an adhesive for effecting the releasably coupling to the roof 54 of the cab 52. In some embodiments, for example, the cab roof connecting system 132 spans or extends along the width of the cab 52. In some embodiments, for example, the cab side connecting system 220 comprises an adhesive for effecting the releasably coupling to the side 56 of the cab 52. In some embodiments, for example, the load 90 is the rack 10, or other example loads 90 as described herein.

In some embodiments, for example, a method of producing a rack 10 of unitary one-piece construction is disclosed. The rack 10 is configured for releasably coupling to a cab 52 of a vehicle 50, the cab 52 having a rear window 58, the rack 10 comprising a barrier 100 defined by a plurality of barrier members 104, wherein the rack 10 is configured to co-operate with the cab, such that, while the rack 10 is releasably coupled to the cab 52, the barrier 100 is disposed in opposition to the rear window 58, line of sight is provided from the cab 52, through the barrier 100, the barrier 100 prevents oversized objects from contacting the rear window 58. The method comprises injection moulding the rack 10.

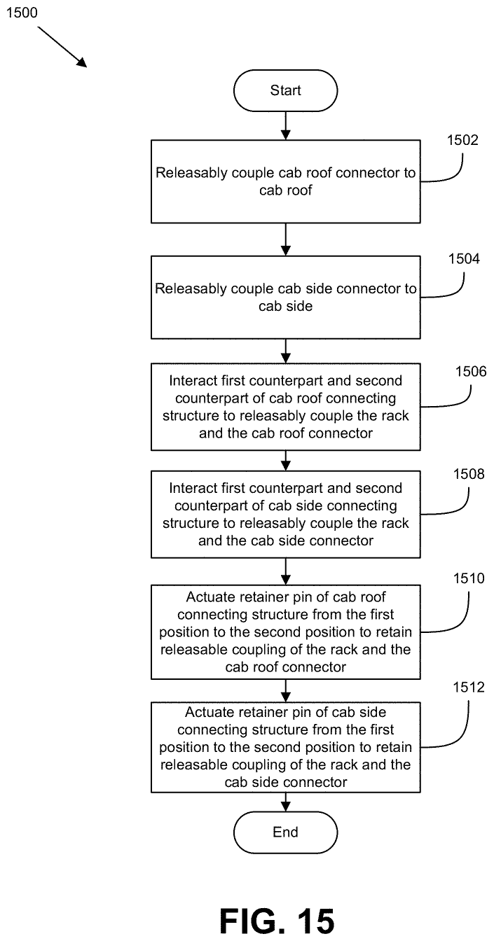

FIG. 15 is a flow chart depicting a method 1500 of releasably coupling the rack 10 to a cab 52 of a vehicle 50, such as a truck.

At 1502, a cab roof connector 134 is releasably coupled to a roof 54 of a cab 52 of a vehicle 50. In some embodiments, for example, the cab roof connector 134 is releasably coupled to the roof 54 of the cab 52 using double-sided tape or adhesive pads. The disposition of the cab roof connector 134 on the roof 54 of the cab 52 is based, in part, on the configuration and dimensions of the roof 54 of the cab 52, and on the configuration and dimensions of the rack 10.

At 1504, a cab side connector 222 is releasably coupled to a side 56 of the cab 52. In some embodiments, for example, the cab side connector 222 is releasably coupled to the side 56 of the cab 52 using double-sided tape or adhesive pads. The disposition of the cab side connector 222 on the side 56 of the cab 52 is based, in part, on the configuration and dimensions of the side 56 of the cab 52, and on the configuration and dimensions of the rack 10. At this point, in some embodiments, for example, where the barrier 100 and the connecting system 130 are of unitary one piece construction, the rack 10 is releasably coupled to the cab 52, such that the barrier 100 is disposed in opposition to the rear window 58, line of sight is provided from the cab 52, through the barrier 100, and the barrier 100 prevents oversized objects from contacting the rear window 58.

At 1506, in some embodiments, for example, where the barrier 100 and the connecting system 130 are separate components and are parts of a kit for assembling a rack system, the first counterpart 182 and the second counterpart 184 of the cab roof connecting structure 180 are interacted to releasably couple the rack 10 and the cab roof connector 134. In some embodiments, for example, where there is more than one cab roof connecting structure 180, for example, two cab roof connecting structures 180, the first counterpart 182 and the second counterpart 184 of the first cab roof connecting structure 180 are interacted, and the first counterpart 182 and the second counterpart 184 of the second cab roof connecting structure 180 are interacted, to releasably couple the rack 10 and the cab roof connector 134. In some embodiments, where the first counterpart 182 of the cab roof connecting structure 180 is a prong 196, and the second counterpart 184 of the cab roof connecting structure 180 is a slot 198, the prong 196 is inserted into the slot 198 to releasably couple the rack 10 and the cab roof connector 134.

At 1508, the first counterpart 232 and the second counterpart 234 of the cab side connecting structure 230 are interacted to releasably couple the rack 10 and the cab side connector 222. In some embodiments, for example, where there is more than one cab side connector 222, for example, two cab side connectors 222, the first counterpart 232 and the second counterpart 234 of the first cab side connecting structure 230, and the first counterpart 232 and the second counterpart 234 of the second cab side connecting structure 230, are interacted to releasably couple the rack 10 and the first and second cab side connectors 222. In some embodiments, where the first counterpart 232 of the cab side connecting structure 230 is a prong 246, and the second counterpart 234 of the cab side connecting structure 230 is a slot 248, the prong 246 is inserted into the slot 248 to releasably couple the rack 10 and the one or more cab side connectors 222.

At 1510, while the rack 10 is releasably coupled to the cab roof connector 134, the releasably coupling of the rack 10 and the cab roof connector 134 is releasably retainable by the retainer 186. In some embodiments, for example, the retainer 186 of the cab roof connecting structure 180 is actuated from the first position to the second position, as depicted in FIG. 7 and FIG. 8, to releasably retain the releasable coupling of the rack 10 and the cab roof connector 134. In some embodiments, for example, where there is more than one cab roof connecting structure 180, for example, two cab roof connecting structures 180, the releasably coupling of the rack 10 and the cab roof connector 134 is releasably retainable by the first and second retainers 186. In some embodiments, for example, each of the retainers 186 of the cab roof connecting structures 180 is actuated from the first position to the second position to releasably retain the releasable coupling of the rack 10 and the cab roof connector 134.

At 1512, while the rack 10 is releasably coupled to the cab side connector 222, the releasably coupling of the rack 10 and the cab side connector 222 is releasably retainable by the retainer 236. In some embodiments, for example, the retainer 236 of the cab side connecting structure 230 is actuated from the first position to the second position, as depicted in FIG. 9 and FIG. 10, to releasably retain the releasable coupling of the rack 10 and the cab side connector 222. In some embodiments, for example, where there is more than one cab side connector 222, for example, two cab side connectors 222, the releasably coupling of the rack 10 and the first and second cab side connectors 222 are releasably retainable by the first and second retainers 236. In some embodiments, for example, each of the retainers 236 of the cab side connecting structures 230 is actuated from the first position to the second position to releasably retain the releasable coupling of the rack 10 and the cab side connectors 222. At this point, the rack 10 is releasably coupled to the cab 52, such that the barrier 100 is disposed in opposition to the rear window 58, line of sight is provided from the cab 52, through the barrier 100, and the barrier 100 prevents oversized objects from contacting the rear window 58.

To release the rack 10 from the cab roof connector 134, the retainer 186 of the cab roof connecting structure 180 is actuated from the second position to the first position, as depicted in FIG. 8 and FIG. 7, such that the retention of the releasable coupling of the rack 10 and the cab roof connector 134 is absent. In some embodiments, for example, where there is more than one cab roof connecting structure 180, for example, two cab roof connecting structures 180, each of the retainers 186 of the cab roof connecting structures 180 is actuated from the second position to the first position such that the retention of the releasable coupling of the rack 10 and the cab roof connector 134 is absent.

To release the rack 10 from the cab side connector 222, the retainer 236 of the cab side connecting structure 230 is actuated from the second position to the first position, as depicted in FIG. 10 and FIG. 9, such that the retention of the releasable coupling of the rack 10 and the cab side connector 222 is absent. In some embodiments, for example, where there is more than one cab side connector 222, for example, two cab side connectors 222, each of the retainers 236 of the cab side connecting structures 230 is actuated from the second position to the first position such that the retention of the releasable coupling of the rack 10 and the cab side connectors 222 is absent.

While the retention of the releasable coupling of the rack 10 and the cab roof connector 134 is absent, and the retention of the releasable coupling of the rack 10 and the cab side connector 222 is absent, the rack 10 may be released from the releasable coupling with the cab roof connector 134 and the cab side connector 222. The cab roof connector 134 and the cab side connector 222 may remain releasably coupled to the cab 52, such that, when desired, the rack 10 may be releasably coupled to the cab 52 via the cab roof connector 134 and the cab side connector 222 as described herein, without having to first releasably couple the cab roof connector 134 and the cab side connector 222 to the cab.

In some embodiments, for example, the material of construction of the rack 10 and the connecting system 130 is plastic. In some embodiments, for example, the material of construction of the barrier 100 and the connecting system 130 is high impact co-polymer, nylon, polypropylene, or thermoplastic. In some embodiments, for example, the material of construction of the rack 10 and the connecting system 130 is polypropylene with 30% glass fiber filler.

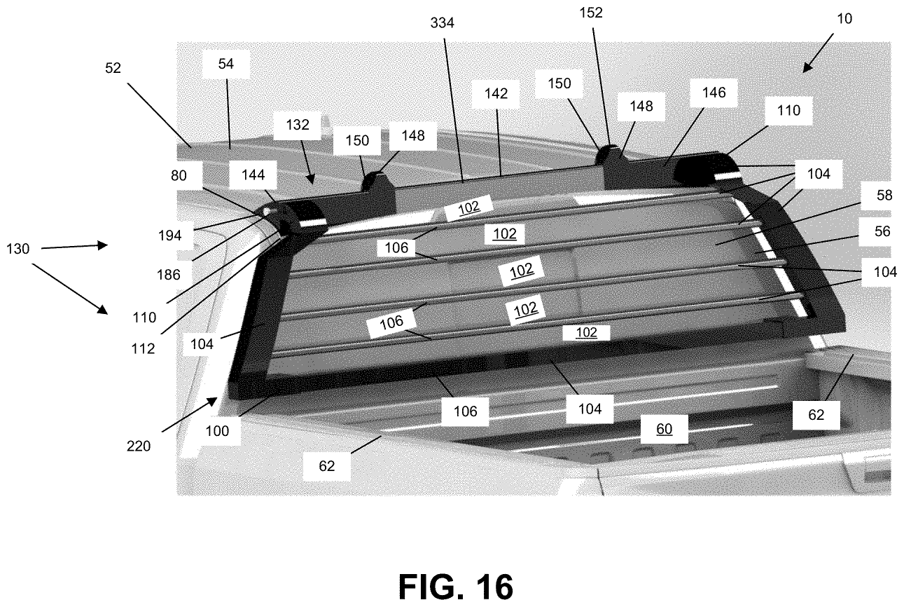

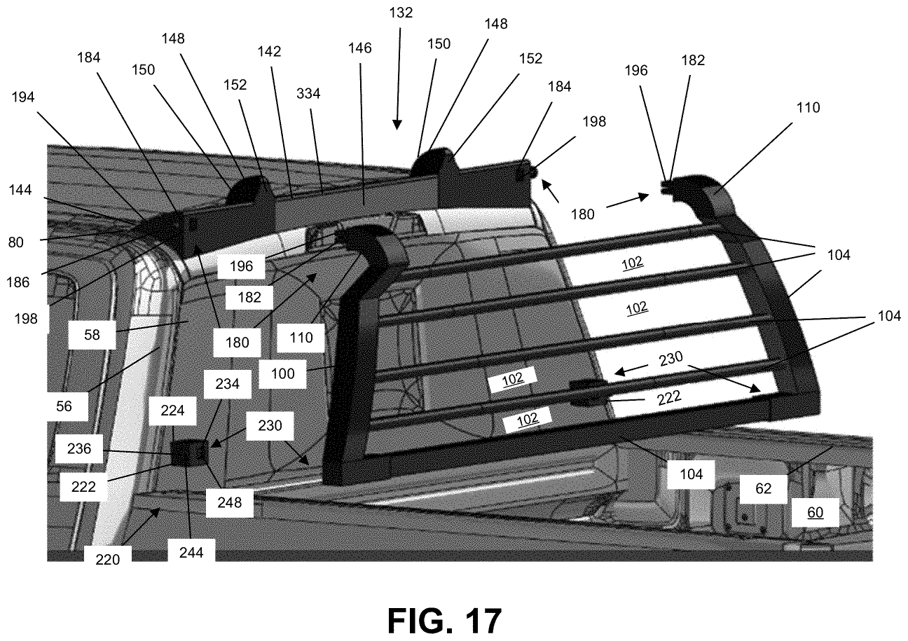

FIGS. 16 to 28 depict an example rack 30. As depicted, the rack 30 is substantially similar to the rack 10, and includes the connecting system 130, which includes the cab roof connecting system 132 and the cab side connecting system 220, the cab roof connecting structure 180, and the cab side connecting structure 230, as described herein, except the cab roof connecting system 132 of the rack 30 includes at least one cab roof connector 334. In some embodiments, for example, each one of the at least one cab roof connectors 334, independently, includes an adhesive for effecting the releasably coupling to the roof 54 of the cab 52. The barrier 100 and the connecting system 130 are co-operatively configured such that, while the cab roof connector 334 is releasably coupled to the roof 54 of the cab 52, the barrier 100 is releasably coupled to the roof 54 of the cab 52 and disposed in opposition to the rear window 58.

In some embodiments, for example, the barrier 100 and the cab roof connector 334 are of unitary one piece construction, as described herein. In some embodiments, for example, the barrier 100 and the cab roof connector 334 are included in a kit or parts as separate components for assembling a rack system that is configured for releasably coupling to a cab of a vehicle that are releasably couplable together, as described herein.

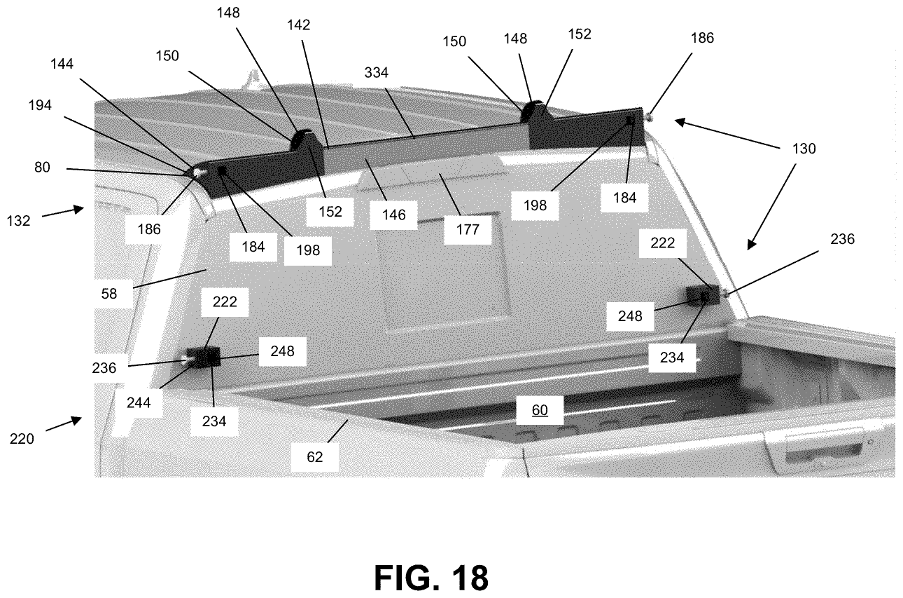

As depicted in FIGS. 16-21, the cab roof connector 334 is substantially similar to the cab roof connector 134, except the cab roof connector 334 includes a connecting surface 336. In some embodiments, for example, the connecting surface 336 is configured to conform to the cab 52 for disposition of the cab roof connector 334 on the cab 52. In some embodiments, for example, the connecting surface 336 is configured to conform to the geometry and curvature of the cab 52 for disposition of the cab roof connector 334 on the cab 52. For example, as depicted in FIGS. 16 to 28, the connecting surface 336 includes a curved or arcuate configuration, such that the connecting surface 336 is conformable to the corner of the cab 52, or portion of the corner of the cab 52, that extends between the cab roof 54 and the cab side 56. In such embodiments, for example, as depicted in FIG. 18, the cab roof connector 334 is releasably couplable to the cab roof 54 and the corner of the cab 52 that extends between the cab roof 54 and the cab side 56.

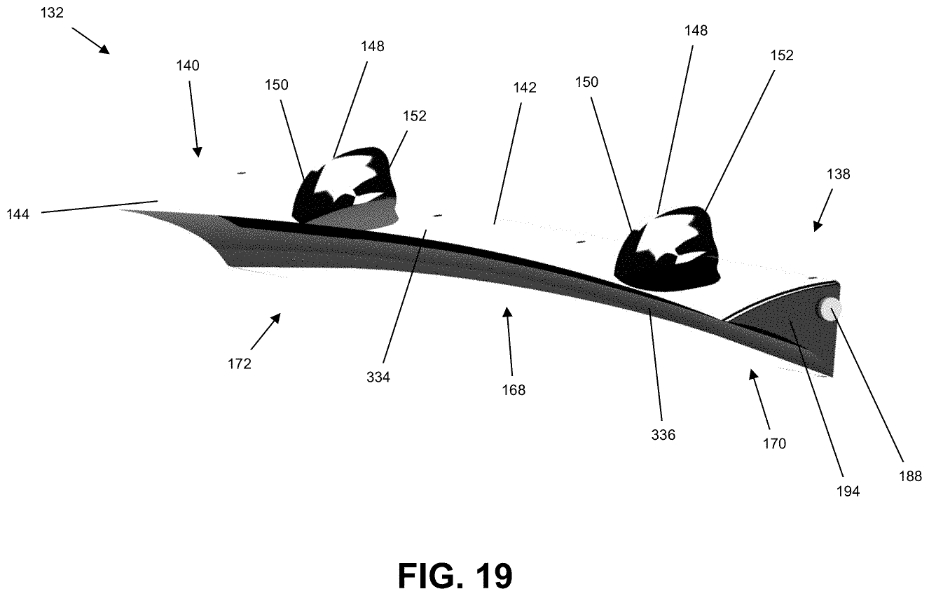

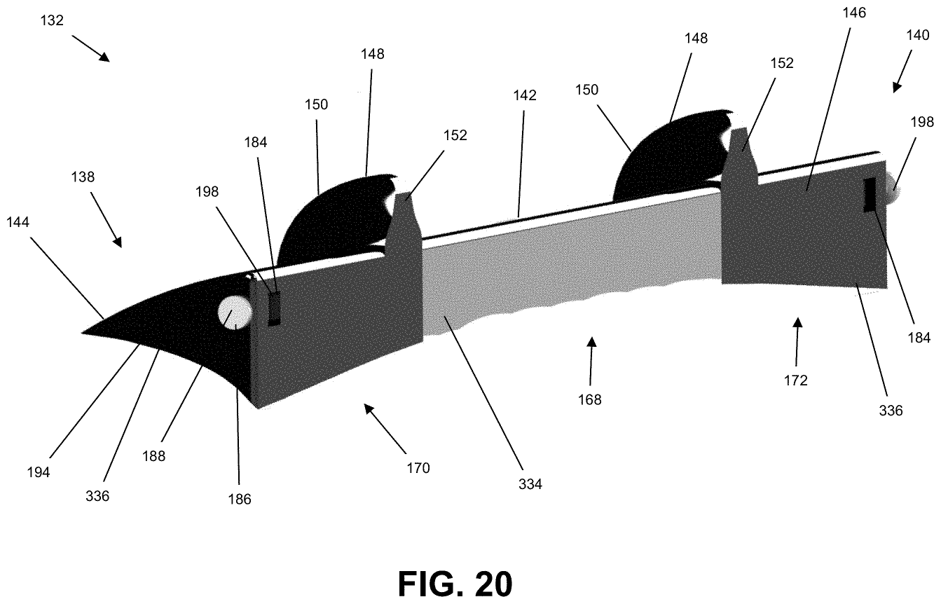

The connecting surface 336 is configured for releasably coupling the cab roof connector 334 to the roof 54 of the cab 52. The connecting system 130 and the cab 52 are co-operatively configured such that while the connecting surface 336 of the cab roof connector 334 is releasably coupled to the roof 54 of the cab 52, the cab roof connector 334 is releasably coupled to the roof 54 of the cab 52. As depicted in FIG. 19 and FIG. 20, in some embodiments, for example, while the rack 10 is disposed in the operative orientation, the connecting surface 336 of the cab roof connector 336 is a bottom surface, or a portion of a bottom surface, of the cab roof connector 336. In some embodiments, for example, as depicted in FIG. 19 and FIG. 20, the cab roof connector 334 has a first end 138 and a second end 140. In some embodiments, for example, the connecting surface 336 extends between the first end 138 and the second end 140 of the cab roof connector 134.

In some embodiments, for example, the cab roof connector 334 comprises a first connecting surface 336 and a second connecting surface 336 for releasably coupling the cab roof connector 334 to the roof 54 of the cab 52. The connecting system 130 and the cab 52 are co-operatively configured such that while the first connecting surface 336 and the second connecting surface 336 of the cab roof connector 334 are releasably coupled to the roof 54 of the cab 52, the cab roof connector 334 is releasably coupled to the roof 54 of the cab 52.

In some embodiments, for example, as depicted in FIG. 19 and FIG. 20, the cab roof connector 334 has the first end 138 and the second end 140, wherein the first end 138 and the second end 140 of the cab roof connector 334 are opposing ends of the cab roof connector 334. In some embodiments, for example, the first connecting surface 336 and the second connecting surface 336 of the cab roof connector 134 are disposed on opposing ends 138 and 140 of the cab roof connector 334. In some embodiments, for example, the connecting surface 336 extends between the first end 138 and the second end 140.

In some embodiments, for example, while the cab roof connector 334 is releasably coupled to the cab roof 54, the cab roof connector 334 is disposed relative to the cab roof 54 such that no light fixtures 177 of the vehicle 50 are obscured or blocked by the cab roof connector 334, as depicted in FIG. 18.

In some embodiments, for example, as depicted in FIGS. 19 to 21, the leading surface of the cab roof connector 334 has an aerodynamic cross-sectional profile or a cross-sectional profile having a foil shape, such that, during operation of the vehicle 50, while the cab roof connector 334 is releasably coupled to the roof 54 of the cab 52, the drag and the noise due to the fluid flowing over the cab roof connector 334 may be reduced. Accordingly, since the cab roof connector 334 is releasably coupled to the roof 54 of the cab 52, the amount of drag experienced by the cab 52, and thus the vehicle 50, may also be reduced, which may improve the operational efficiency of the vehicle 50.

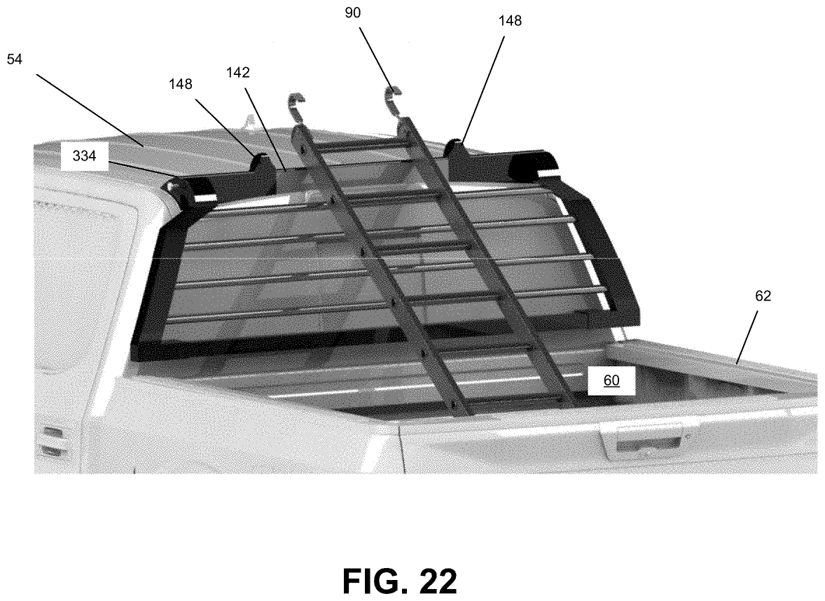

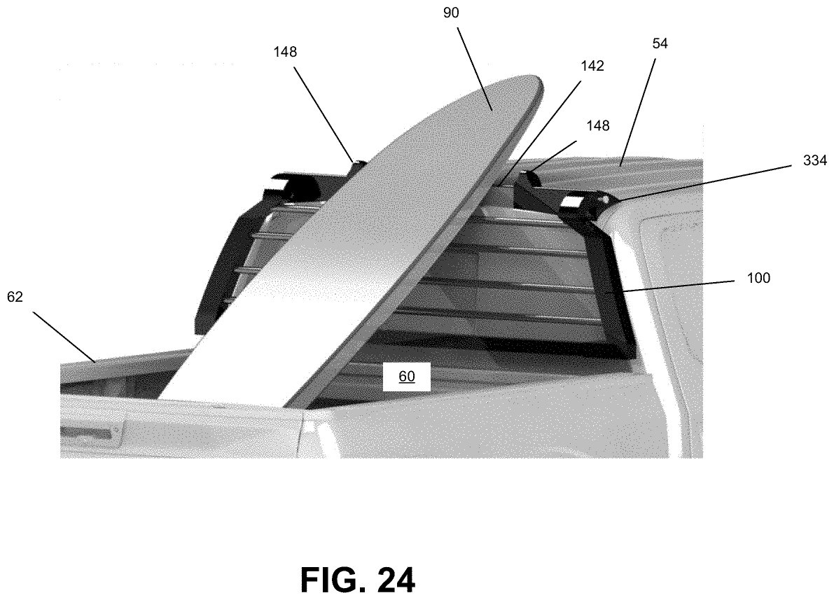

As depicted in FIG. 22 and FIG. 24, example loads 90 that may be supported by the rack 30 are relatively long loads 90, such as a ladder or a surfboard. As depicted, the ladder or surfboard is rested on or applied to the load supporting member 142 of the cab roof connector 334 to be supported by the roof 54 of the cab 52. While the cab roof connector 334 is releasably coupled to the roof 54 of the cab 52 and the ladder or surfboard rested on the rack 10 is supported by the cab roof connector 134, the ladder or surfboard is supported by the cab 52.

As depicted in FIG. 22 and FIG. 24, the ladder or surfboard is rested on or applied to the load supporting member 142 and between the protrusions 148. While the cab roof connector 334 is releasably coupled to the roof 54 of the cab 52 and the ladder or surfboard rested on the rack 10 is supported by the cab roof connector 334, during operation of the vehicle 50, lateral movement of the ladder or surfboard is resisted by the protrusions 148, such that the cab roof connector 334 resists or interferes with lateral displacement of the ladder or surfboard to prevent or mitigate the ladder or surfboard from falling out of the truck bed 60.

In some embodiments, one or more supports are connectable to the rack 30, for example, the barrier 100, such that a load 90 is supportable by the cab 52 via the rack 30 and the one or more supports connected to the rack 30. In some embodiments, for example, as depicted in FIG. 26, one or more supports 2600 are configured to be connectable to the rack 30, for example, the barrier 100. As depicted in FIG. 26, while the supports 2600 are connected to the rack 10, the supports 2600 are configured to receive, clamp, or otherwise support a frame or portion of a frame of a bicycle, such as the fork of the bicycle frame. In this regard, the rack 30 is configured to support the bicycle frame via the supports 2600 that are connected to the rack 30.

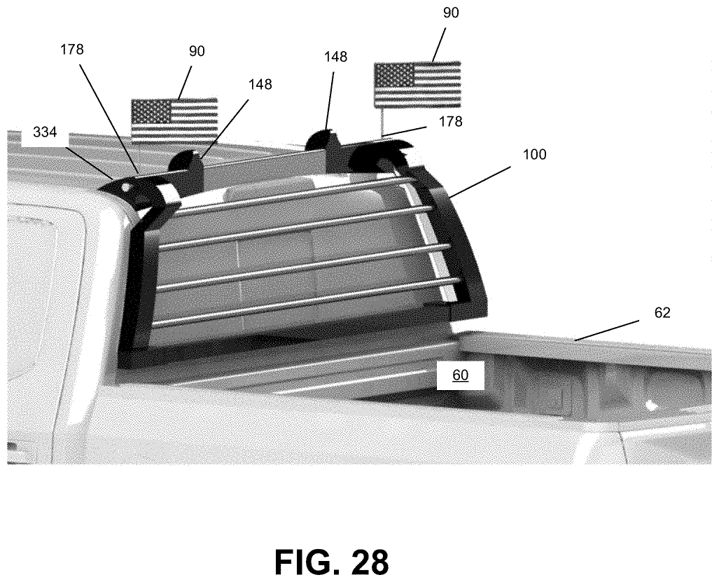

As depicted in FIG. 28, in some embodiments, for example, it is desirable to fasten a load 90 to the cab roof connector 334. In such embodiments, for example, the cab roof connector 334 defines the one or more ports 178, similar to the ports 178 as depicted in FIG. 11. In some embodiments, for example, the load 90 is a light fixture, and in such embodiments, the port 178 functions as a light fixture attachment point. As depicted in FIG. 28, the load 90 is a flag, and the flag pole is received in the port 178 to fasten the load 90 to the cab roof connector 334. In some embodiments, for example, the port 178 is a ⅜″ threaded port.

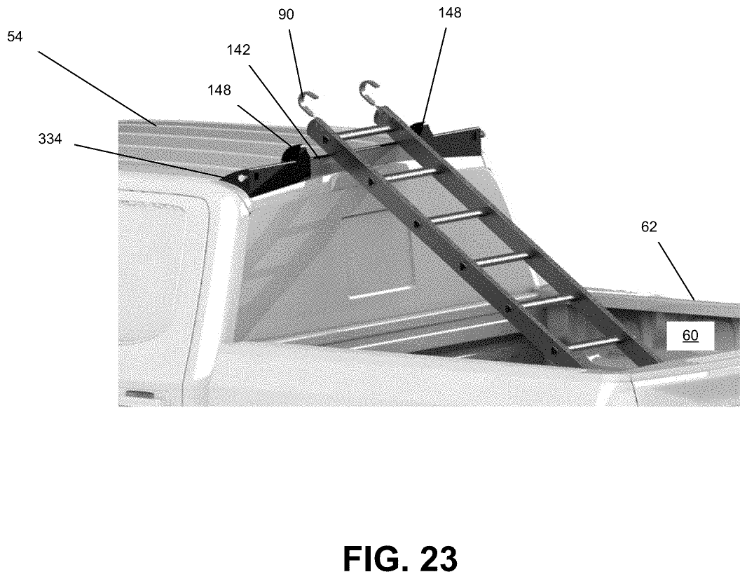

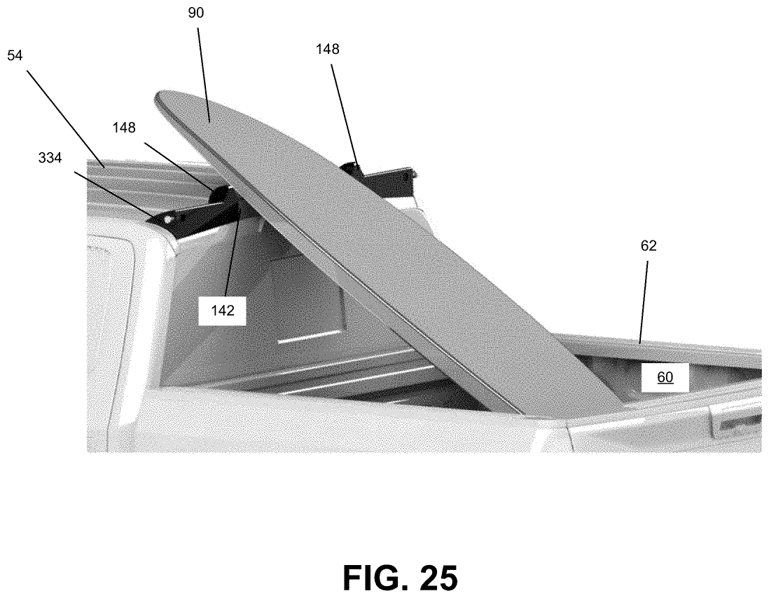

In some embodiments, for example, the loads 90 supported by the rack 30 may be supported without the barrier 100 connected to the cab roof connector 334. As depicted in FIG. 23 and FIG. 25, the loads 90 are rested on or applied to the load supporting member 142 of the cab roof connector 334 to be supported by the roof 54 of the cab 52. While the cab roof connector 334 is releasably coupled to the roof 54 of the cab 52 and the ladder or surfboard rested on the rack 10 is supported by the cab roof connector 134, the ladder or surfboard is supported by the cab 52. As depicted in FIG. 23 and FIG. 25, the cab roof connector 334, on its own, is releasably couplable to the roof 54 of the cab 52 for supporting a load 90.

In some embodiments, for example, while the rack 10 or rack 30 is releasably coupled to the cab 52, the rack 10 or the rack 30 is hung from the cab 52.

In some embodiments, for example, the rack 10 or rack 30 is releasably couplable exclusively to the cab 52.

In some embodiments, for example, disposition of the barrier 100 in opposition to the rear window 58 is such that the barrier 100 is disposed in alignment with the rear window 58.

In some embodiments, for example, disposition of the barrier 100 in opposition to the rear window 58 is such that the barrier 100 is offset from the rear window 58.

In some embodiments, for example, the vehicle 50 having the cab 52 that is releasably coupled to the rack 10 or the rack 30 is a truck.

In some embodiments, for example, while the barrier 100 is releasably coupled to the cab 52 and disposed in opposition to the rear window 58, the rack 10 is disposed above a truck bed 60 or a rail 62 of the truck bed 60. In such embodiments, the lowermost barrier member 104 is disposed above the truck bed 60 or the rail 62 of the truck bed 60. In some embodiments, for example, the minimum distance between the rack 10 and the truck bed 60 is at least 12 inches. In some embodiments, for example, the distance between the rack 10 and the truck bed 60 is 23 inches. In some embodiments, for example, the minimum distance between the rack 10 and the rail 62 of the truck bed 60 is at least 1 inch. In some embodiments, for example, the distance between the rack 10 and the rail 62 of the truck bed 60 is 3 inches.

In some embodiments, for example, the rack 10 or the rack 30 is manufactured via high strength injection moulding, such that the rack 10 or the rack 30 is impact resistant and resistant to ultraviolet radiation.

In some embodiments, for example, the rack 10 or the rack 30 is releasably couplable to the cab 52 without a drill.

In some embodiments, for example, the rack 10 or the rack 30 is water resistant, such that the vehicle 50, with the rack 10 or the rack 30 releasably coupled to the vehicle 50, may be washed, for example, at a car wash.

In some embodiments, for example, while the rack 10 or the rack 30 is releasably coupled to the cab 52, the overall height of the vehicle is increased by less than 12″, for example, by less than 9″, for example, by less than 6″, for example, by less than 3″. In some embodiments, for example, while the rack 10 or the rack 30 is releasably coupled to the cab 52, the vehicle 50 may be operated in areas where there may be a vehicle height restriction, for example, underground parking lots.

In some embodiments, for example, as depicted in FIG. 23 and FIG. 25, the cab roof connector 134 or 334 is releasably couplable to the roof 54 of the cab 52 for supporting a load 90, without also releasably coupling the barrier 100 to the cab roof connector 134 or 334.

In some embodiments, for example, where the rack 10 or 30 includes the barrier 100, the cab roof connector 134 or 334 with first and second cab roof connecting structures 180, and two cab side connectors 222, the barrier 100 is releasably couplable to the connecting system 130 at four points, namely, the first and second cab roof connecting structures 180 of the cab roof connector 134 or 334, and the cab side connecting structure 230 of each of the first and second cab side connectors 222.

In some embodiments, for example, the cab 52 of the vehicle 50 is structurally stronger than other components of the vehicle 50, such as the truck bed 60. In this regard, the rack 10, while releasably coupled to the cab 52, promotes the supporting of a load 90 by the cab 52. With the cab 52 configured to support a load 90 via the releasably coupled rack 10, a heavier load 90 may be supported.

When the rack 10 is releasably coupled to the cab 52 of the truck 50, in some embodiments, for example, the rack 10 protects the rear window 58 from an unsecured load in the truck bed 60. The unsecured cargo load may move and may contact the rear window 58 based on acceleration or deceleration of the truck 50.

In some embodiments, for example, the rack 10 and the cab roof connector 134 provide a support to rest and secure loads with a long length (e.g. ladders, lumber, surfboards, PVC pipes, etc.) and protect the top or roof 54 of the truck cab 52 from being contacted by such loads that would not fit in the truck bed 60. In some embodiments, for example, the rack 10 and the cab roof connector 134 is configured to protect the truck cab 52, which may have a height of 5.5 feet, 6 feet, 8 feet, such as the truck cabs 52 of a Ford F150®, Ford F250®, and Ford F350®, for example, or that may have a height of less than 5 feet or a height of greater than 8 feet.

In some embodiments, for example the one or more barrier members 104 provide contact points, support points, or attachment points for supporting a load 90 or attaching a load 90, like lights and tools, such as warning lights, LED beam lights, traffic signal lights, strapping systems, SUP boards, shovels, rakes, drills, saws, cargo cases, tool boxes, and the like, using belts, straps, ropes, cables, chains, brackets, clamps, and the like.

In some embodiments, for example, the rack 10 and the connecting system 130, made with plastic, such as a thermoplastic, weigh approximately 25 pounds, compared to metal racks that may weigh approximately 75 pounds. In some embodiments, for example, the rack 10 and the connecting system 130 weigh approximately 25 pounds. In some embodiments, for example, the rack 10 and the connecting system 130 weigh less than 25 pounds. In some embodiments, for example, the rack 10 and the connecting system 130 weigh more than half the weight of a rack made with steel, and is approximately 60% of the weight of a rack made with aluminum. In some embodiments, for example, the rack 10 and the connecting system 130 weigh less than 20 pounds. In some embodiments, for example, the rack 10 and the connecting system 130 weigh approximately 20 pounds. The relatively light weight of the rack 10 and the connecting system 130 may present ease of shipping, handling, and releasably coupling the rack 10 and the connecting system 130. The relatively light weight of the rack 10 and the connecting system 130 may allow for one person to releasably couple the rack 10 and the connecting system 130 to the cab 52 or release the rack 10 and the connecting system 130 from the cab 52 without assistance from others. In some embodiments, for example, the relatively light weight of the rack 10 and the connecting system 130 may allow for one person to releasably couple the barrier 100 and the connecting system 130, or release the barrier 100 from the connecting system 130, without assistance from others. In such embodiments, for example, the relative ease of releasably coupling, or release of the releasable coupling, of the barrier 100 and the connecting system 130 provides a user with the choice of releasably coupling the barrier 100 to the cab 52 or removing the releasable coupling of the barrier 100 from the cab 52 as desired. The relatively light weight of the rack 10 and the connecting system 130 may improve the fuel efficiency of the vehicle 50 on which the rack 10 and the connecting system 130 is releasably coupled, compared to the fuel efficiency of the vehicle 50 on which a heavier metal rack is coupled. In addition, the rack 10 and the connecting system 130, made with plastic, may not be susceptible to rust, which may reduce wear and tear on the rack 10 and the connecting system 130 and may reduce or prevent such rust damage to the vehicle 50 on which the rack 10 and the connecting system 130 is releasably coupled.

In some embodiments, for example, at least one of the barrier members 104 of the barrier 100 is configured for supporting a load 90. In some embodiments, for example, at least one of the barrier members 104 of the barrier 100 is configured for attaching a load 90. For example, a tool box can be supported by and attached to one or more barrier members 104 of the barrier 100. The tool box can be supported by and attached to one or more barrier members 104 of a middle portion of the barrier 100. In some embodiments, for example, the tool box has one lockable gull wing door on each end of the tool box. The tool box may have an example height of 20″, an example length of 72″ measured along the base of the tool box, 16″ depth at the top of the tool box and 20″ depth at the bottom of the tool box. As another example, a ladder can be supported by and attached to one or more barrier members 104 of the barrier 100. As another example, a light assembly can be supported by and attached to one or more barrier members 104 of the barrier 100. For example, a warning light can be supported by and attached to one or more barrier members 104 of the barrier 100. The load, for example, the ladder, the light assembly, or the warning light, may be supported by and attached to one or more barrier members 104 of an upper portion of the barrier 100. As another example, one or more bicycle frames can be supported by and attached to one or more barrier members 104 of the barrier 100. For example, one or more bicycle frames can be supported by and attached to one or more barrier members 104 of the barrier 100. The bicycle frame may be supported by and attached to one or more barrier members 104 of a lower portion of the barrier 100. In some embodiments, for example, the one or more barrier members 104 that supports the bicycle frame is a 2″×2″ tube. In some embodiments, for example, the one or more ports are defined in the one or more barrier members 104 that are configured to receive a fork of a bicycle. Once the fork of the bicycle is received in said ports, the axle may be installed on the fork to secure the bicycle to the rack 10.

In some embodiments, where the rack 10 and the connecting system 130 are made with plastic, the rack 10 and the connecting system 130 may be used outdoors, or may be used to protect the rear window 58 of the truck 50 when the truck 50 is outdoors. In addition, a load made with metal or have metal components, or a load that may be wet, may be supported by or attached to the rack 10 and the connecting system 130 without rust damage or reduced wear and tear damage to the rack 10 and the connecting system 130, such as bicycles, bicycle forks, all terrain vehicles, fishing rods, canoes, kayaks, stand-up paddle boards, skis, snowboards, weapons, guns, and the like.

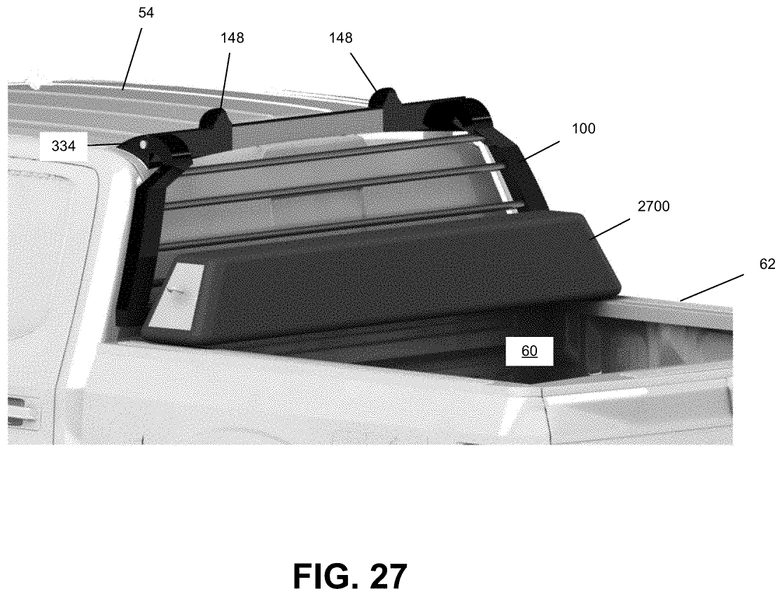

In some embodiments, while the rack 10 and the connecting system 130 are releasably coupled to a vehicle 50, the rack 10 and the connecting system 130 are configured to accommodate accessories of the vehicle 50, such as tool boxes and tonneau covers. In such embodiments, for example, the rack 10 and the connecting system 130 are configured such that the rack 10 and the connecting system 130 do not interfere with installation of tonneau covers or tool box accessories while the rack 10 and the connecting system 130 are releasably coupled to the vehicle 50. For example, the rack 10 or 30 and the connecting system 130 may be releasably coupled to the cab 52 of a truck 50 with a truck bed 60 that is covered with a truck bed cover. For example, the rack 10 or 30 and the connecting system 130 may be releasably coupled to a cab 52 of a truck 50 with a truck bed 60 that has a tool box 2700, as depicted in FIG. 27. In some embodiments, for example, the tool box 2700 is configured to hold relatively long loads, such as guns, fishing rods, and the like. In some embodiments, for example, the tool box 2700 is connected to the rack 10 or 30 to be supported by the cab 52 via the releasable coupling of the rack 10 or 30 and the cab 52. In some embodiments, for example, the tool box 2700 is connected directly to the cab 52 to be supported by the cab 52, and is not connected to the rack 10 or 30. In some embodiments, for example, the tool box 2700 is supported by the rail 62 of the truck bed 60. In some embodiments, for example, the tool box 2700 is supportable by the cab 52 or the rack 10 or 30, and while the tool box 2700 is supported by the cab 52 or the rack 10 or 30, the tool box 2700 is offset from the rail 62 of the truck bed 60. In some embodiments, for example, the tool box 2700 is received in the truck bed 60 and a portion of the lid of the tool box 2700 rests on the rail 62 of the truck bed 60.

In some embodiments, for example, where the rack 10 and the connecting system 130 are made with plastic, the rack 10 and the connecting system 130 may contact the metal components of the vehicle 50 on which the rack 10 and the connecting system 130 are releasably coupled, and may prevent or reduce corrosion of the metal components of the vehicle 50, where such corrosion of the metal components of the vehicle 50 may be due to dissimilar metal corrosion or galvanic corrosion, which may occur if the rack 10 and the connecting system 130 were manufactured with metal.

In some embodiments, for example, where the rack 10 and the connecting system 130 are made with plastic, the rack 10 and the connecting system 130 may be recycled at end of life using, for example, plastic recycling methods.

In some embodiments, the rack 10 and the connecting system 130 may be releasably coupled to the cab 52 using a fastener, such as an adhesive. Similarly, the rack 10 and the connecting system 130 may be released from the vehicle by disengaging or loosening the fastener. Accordingly, the rack 10 and the connecting system 130 may be releasably coupled to or released from the vehicle 50 using a fastener, without additional parts, such as additional brackets or clamps, and the like, or without additional tools, such as drills. This may provide relative ease of releasably coupling or ease of releasing of the rack 10 and the connecting system 130, such that the rack 10 and the connecting system 130 may be releasably coupled to or released from the vehicle as desired. As such, a user may releasably couple the rack 10 to the cab 52 using the connecting system 130 when the user needs the rack 10, and the user may release the rack 10 from the cab 52 when the user does not need the rack 10, as desired. In some embodiments, for example, the rack 10 and the connecting system 130 may be coupled to the cab 52 if desired, such that the rack 10 and the connecting system 130 may effectively be permanently coupled to the vehicle. In some embodiments, for example, the rack 10 and the connecting system 130 may be releasably coupled to the cab 52, and then the rack 10 may be released from the cab 52, while the connecting system 130 is releasably coupled to the cab 52. The rack 10 may provide flexibility for when a user wants to have the rack 10 releasably coupled to the cab 52 and when the user does not want to have the rack 10 releasably coupled to the cab 52.

In some embodiments, for example, by being blow moulded or injection moulded, the cost to manufacture the rack 10 and the connecting system 130 may be lower than racks made of metal, such as steel or aluminum.

In some embodiments, for example, the rack 10 and the connecting system 130 are separate components, such that they may be separately manufactured. In such embodiments, this may provide relative ease of shipping and handling of the components. In some embodiments, for example, the connecting system 130 be used for another purpose, such as for releasably coupling with another embodiment of the rack 10, or for releasably coupling with a load 90 other than the rack 10.

In some embodiments, for example, where the rack 10 and the connecting system 130 are manufactured by blow moulding or injection moulding, the rack 10 and the connecting system 130 are manufactured to supply high volume production.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1.-59. (canceled)

60. A method of producing a rack of unitary one-piece construction that is configured for releasable coupling to a cab of a vehicle, the cab having a rear window, the rack comprising a barrier defined by a plurality of barrier members, wherein the rack is configured to co-operate with the cab, such that while the rack is releasably coupled to the cab, the barrier is disposed in opposition to the rear window, line of sight is provided from the cab, through the barrier, the barrier prevents oversized objects from contacting the rear window, wherein the method comprises:
injection moulding the rack.

61. The method of claim 60, wherein the rack further comprises a connecting system, for effecting the releasably coupling of the rack to the cab, wherein the connecting system includes a cab roof connecting system for releasably coupling to a roof of the cab, the cab roof connecting system includes at least one cab roof connector, each one of the at least one cab roof connectors, independently, is releasably couplable to the roof of the cab.

62. The method of claim 61, wherein the cab roof connector includes a leading surface that has an aerodynamic cross-sectional profile.

63. The method of claim 61, wherein a pair of protrusions extends from the cab roof connector, such that while the cab roof connector is releasably coupled to the roof of the cab, the protrusions extends in an upward direction, and are configured to resist lateral movement of a load that is supported by the cab roof connector.

64. The method of claim 63, wherein each of the pair of protrusions includes a leading surface that has an aerodynamic cross-sectional profile.

65. The method of claim 61, wherein the cab roof connector has an extended portion, wherein the cab roof connector and the cab are co-operatively configured such that, while the cab roof connector is releasably coupled to the roof of the cab, the extended portion extends beyond the roof of the cab and over the rear window.

66. The method of claim 65, wherein the extended portion of the cab roof connector has an arcuate portion, wherein the cab roof connector and the cab are co-operatively configured such that, while the cab roof connector is releasably coupled to the roof of the cab, the arcuate portion is disposed in opposition to the rear window.

67. The method of claim 65, wherein the extended portion of the cab roof connector has an aerodynamic cross-sectional profile.

68. The method of claim 61, wherein the cab roof connecting system includes a first cab roof connector and a second cab roof connector, each one of the first cab roof connector and the second cab roof connector, independently, is releasably couplable to the roof of the cab.

69. The method of claim 61, wherein the connecting system includes a cab side connecting system for releasably coupling to a side of the cab, wherein the cab side connecting system includes at least one cab side connector, each one of the at least one cab side connectors, independently, is releasably couplable to the side of the cab.

70. The method of claim 69, wherein the rack is configured such that the cab roof connector is releasably couplable to the roof of the cab, and the cab side connector is releasably couplable to the cab below the roof.

71. The method of claim 69, wherein the cab side connecting system comprises a first cab side connector and a second cab side connector, wherein each one of the first cab side connector and the second cab side connector, independently, is releasably couplable to the side of the cab.

72. The method of claim 69, wherein the side of the cab is a rear side of the cab.

73. The method of claim 66, the cab roof connector and the cab are co-operatively configured such that, while the barrier is disposed in opposition of the rear window while the rack is releasably coupled to the cab, a space is defined between the cab and the arcuate portion, the space configured to receive a portion of the cab that extends beyond the rear window of the cab.

74. The method of claim 60, wherein a material of construction of the rack is plastic.

75. The method of claim 60, wherein the rack is releasably couplable exclusively to the cab.

76. The method of claim 60, wherein the vehicle is a truck.

77. The method of claim 76, wherein, while the rack is releasably coupled to the cab and the barrier is disposed in opposition to the rear window, the rack is disposed above a truck bed of the truck.

78. A method of producing a rack of unitary one-piece construction that is configured to be supportable by a cab of a vehicle, the cab having a rear window, the rack comprising:
a barrier defined by a plurality of barrier members;
wherein the rack is configured to co-operate with the cab, such that, while the rack is releasably coupled to the cab:
the barrier is disposed in opposition to the rear window;
line of sight is provided from the cab, through the barrier; and
the barrier prevents oversized objects from contacting the rear window;
wherein the method comprises:
injection moulding the rack.

79. A method of producing a rack of unitary one-piece construction that is configured for releasably coupling to a cab of a vehicle, the cab having a rear window, the rack comprising:
a barrier defined by a plurality of barrier members;
wherein the rack is configured to co-operative with the cab, such that, while the rack is releasably coupled to the cab:
the barrier is disposed in opposition to the rear window;
line of sight is provided from the cab, through the barrier; and
the barrier prevents oversized objects from contacting the rear window.
a connecting system that comprises:
a cab roof connecting system for releasably coupling to a roof of the cab;
a cab side connecting system for releasably coupling to a side of the cab;
wherein the barrier and the connecting system are co-operatively configured such that:
while the cab roof connecting system is releasably coupled to the cab, the barrier is releasably coupled to the roof of the cab;
while the cab side connecting system is releasably coupled to the cab, the barrier is releasably coupled to the side of the cab; and
the barrier is disposed in opposition to the rear window;
wherein the method comprises:
injection moulding the rack.

80. The method of claim 79, wherein:
the cab roof connecting system comprises a cab roof connector that is releasably couplable to the roof of the cab; and
the cab side connecting system comprise a first cab side connector and a second cab side connector that each, independently, is releasably couplable to the side of the cab.

81. A method of producing a kit for assembling a rack system that is configured for releasably coupling to a cab of a vehicle, the cab having a rear window, the kit comprising:
a rack of unitary one-piece construction that is configured for releasably coupling to the cab, the rack comprising:
a barrier defined by a plurality of barrier members;
wherein the rack is configured to co-operate with the cab, such that, while the rack is releasably coupled to the cab:
the barrier is disposed in opposition to the rear window;
line of sight is provided from the cab, through the barrier; and
the barrier prevents oversized objects from contacting the rear window;
a connecting system, releasably couplable to the rack and releasably couplable to the cab, for effecting the releasably coupling of the rack to the cab;
wherein the rack and the connecting system are co-operatively configured such that, while: (i) the connecting system is releasably coupled to the cab, and (ii) the rack is releasably coupled to the connecting system, the barrier is releasably coupled to the cab and disposed in opposition to the rear window;
wherein the method comprises:
injection moulding the kit.

82. The method of claim 81, wherein the connecting system comprises a cab roof connecting system for releasably coupling to a roof of the cab, the cab roof connecting system includes at least one cab roof connector, each one of the at least one cab roof connectors, independently, is releasably couplable to the cab.

83. The method of claim 82, wherein the rack is releasably couplable to the cab roof connector by a cab roof connecting structure, wherein:
the rack includes a first counterpart of the cab roof connecting structure;
the cab roof connector includes a second counterpart of the cab roof connecting structure;
wherein one of the first counterpart of the cab roof connecting structure and the second counterpart of the cab roof connecting structure is a prong, and the other of the first counterpart of the cab roof connecting structure and the second counterpart of the cab roof connecting structure is a slot; and
the releasable coupling of the rack and the cab roof connector is effected by an interaction between the first counterpart of the cab roof connecting structure and the second counterpart of the cab roof connecting structure.

84. The method of claim 83, wherein the cab roof connecting structure includes a retainer, and the rack, the cab roof connector, the cab roof connecting structure, and the retainer are co-operatively configured such that the releasable coupling of the rack and the cab roof connector is releasably retainable by the retainer.

85. The method of claim 82, wherein the rack is releasably couplable to the cab roof connector by a first cab roof connecting structure and a second cab roof connecting structure, wherein:
the rack includes:
a first counterpart of the first cab roof connecting structure;
a first counterpart of the second cab roof connecting structure;
the cab roof connector includes:
a second counterpart of the first cab roof connecting structure;
a second counterpart of the second cab roof connecting structure; and
wherein:
one of the first counterpart of the first cab roof connecting structure and the second counterpart of the first cab roof connecting structure is a prong, and the other of the first counterpart of the first cab roof connecting structure and the second counterpart of the first cab roof connecting structure is a slot;
one of the first counterpart of the second cab roof connecting structure and the second counterpart of the second cab roof connecting structure is a prong, and the other of the first counterpart of the second cab roof connecting structure and the second counterpart of the second cab roof connecting structure is a slot; and
the releasable coupling of the rack and the cab roof connector is effected by:
an interaction between the first counterpart of the first cab roof connecting structure and the second counterpart of the first cab roof connecting structure; and
an interaction between the first counterpart of the second cab roof connecting structure and the second counterpart of the second cab roof connecting structure.

86. The method of claim 85, wherein the first cab roof connecting structure includes a first retainer, and the second cab roof connecting structure includes a second retainer, and the rack, the cab roof connector, the first retainer, and the second retainer are co-operatively configured such that the releasable coupling of the rack and the cab roof connector is releasably retainable by the first retainer and the second retainer.

87. The method of claim 82, wherein the connecting system comprises a cab side connecting system for releasably coupling to a side of the cab, the cab side connecting system includes at least one cab side connector, each one of the at least one cab side connectors, independently, is releasably couplable to the side of the cab.

88. The method of claim 87, wherein the rack is releasably couplable to the cab side connector by a cab side connecting structure, wherein:
the rack includes a first counterpart of the cab side connecting structure;
the cab side connector includes a second counterpart of the cab side connecting structure;
wherein one of the first counterpart of the cab side connecting structure and the second counterpart of the cab side connecting structure is a prong, and the other of the first counterpart of the cab side connecting structure and the second counterpart of the cab side connecting structure is a slot; and
the releasable coupling of the rack and the cab side connector is effected by an interaction between the first counterpart of the cab side connecting structure and the second counterpart of the cab side connecting structure.

89. The method of claim 88, wherein the cab side connecting structure includes a retainer, and the rack, the cab side connector, the cab side connecting structure, and the retainer are co-operatively configured such that the releasable coupling of the rack and the cab side connector is releasably retainable by the retainer.

90. The method of claim 87, wherein the cab side connecting system includes a first cab side connector and a second cab side connector for releasably coupling to the side of the cab, wherein the rack is releasably couplable to the first cab side connector by a first cab side connecting structure, and to the second cab side connector by a second cab side connecting structure, wherein:
the rack includes:
a first counterpart of the first cab side connecting structure;
a first counterpart of the second cab side connecting structure;
the first cab side connector includes a second counterpart of the first cab side connecting structure;
the second cab side connector includes a second counterpart of the second cab side connecting structure; and
wherein:
one of the first counterpart of the first cab side connecting structure and the second counterpart of the first cab side connecting structure is a prong, and the other of the first counterpart of the first cab side connecting structure and the second counterpart of the first cab side connecting structure is a slot;
one of the first counterpart of the second cab side connecting structure and the second counterpart of the second cab side connecting structure is a prong, and the other of the first counterpart of the second cab side connecting structure and the second counterpart of the second cab side connecting structure is a slot; and
the releasable coupling of the rack and the first cab side connector and the second cab side connector is effected by:
an interaction between the first counterpart of the first cab side connecting structure and the second counterpart of the first cab side connecting structure; and
an interaction between the first counterpart of the second cab side connecting structure and the second counterpart of the second cab side connecting structure.
